(19) United States
(12) Patent Application Publication
(10) Pub. No.: US 2026/0239114 A1
(43) Pub. Date: Aug. 13, 2026

(54) TRIGGERING A FAST SERVING CELL CHANGE

(71) Applicant: GOOGLE LLC, Mountain View, CA (US)

(72) Inventor: Chih-Hsiang Wu, Taoyuan (TW)

(21) Appl. No.: 19/156,882

(22) PCT Filed: Feb. 14, 2024
(86) PCT No.: PCT/US2024/015874

§ 371 Date: Aug. 14, 2025

Related U.S. Application Data
(60) Provisional application No. 63/445,696, filed on Feb. 14, 2023.

(51) Int. Cl. H04W 36/00

(52) U.S. Cl. CPC H04W 36/0055

(57) ABSTRACT

A central unit (CU) of a distributed base station transmits, to a distributed unit (DU) of the distributed base station, a CU-to-DU message related to a lower layer triggered mobility (LTM) of a user equipment (UE) connected to the distributed base station, the CU-to-DU message including a cell identifier (ID) of a candidate cell. The CU receives, from the DU in response to the CU-to-DU message, a DU-to-CU message including (i) an LTM configuration for the candidate cell and (ii) the cell ID. The CU transmits, to the UE via the DU, the LTM configuration.

### CROSS-REFERENCE TO RELATED APPLICATION

This application claims priority to and the benefit of the filing date of provisional U.S. Patent Application No. 63/445,696, titled “Triggering a Fast Serving Cell Change,” filed on Feb. 14, 2024. The entire contents of the provisional application are hereby expressly incorporated herein by reference.

### FIELD OF THE DISCLOSURE

This disclosure relates to wireless communications and, more particularly, to triggering a fast serving cell change for a user equipment (UE).

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides signaling radio bearers (SRBs) and data radio bearers (DRBs) to the Radio Resource Control (RRC) sublayer. Generally speaking, the UE and a base station can use SRBs to exchange RRC messages as well as non-access stratum (NAS) messages, and can use DRBs to transport data on a user plane.

UEs can use several types of SRBs and DRBs. When operating in dual connectivity (DC), the cells associated with the base station operating the master node (MN) define a master cell group (MCG), and the cells associated with the base station operating as the secondary node (SN) define the secondary cell group (SCG). So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs using the lower-layer resources of only the MN can be referred as MCG DRBs, DRBs using the lower-layer resources of only the SN can be referred as SCG DRBs, and DRBs using the lower-layer resources of both the MCG and the SCG can be referred to as split DRBs.

The UE in some scenarios can concurrently utilize resources of multiple radio access network (RAN) nodes (e.g., base stations or components of a distributed base station), interconnected by a backhaul. When these network nodes support different radio access technologies (RATs), this type of connectivity is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN (via the PCell) and the SN (via the PSCell). In other scenarios, the UE utilizes resources of one base station at a time. One base station and/or the UE determines that the UE should establish a radio connection with another base station. For example, one base station can determine to hand the UE over to the second base station, and initiate a handover procedure.

When the UE moves from coverage area of one cell to another cell in a RAN, the UE and the network must at some point perform a serving cell change. To perform the serving cell change, the RAN configures the UE to transmit Layer 3 (L3) measurement results. Based on the L3 measurement results from the UE, the RAN transmits a RRC reconfiguration message for a reconfiguration with synchronization (e.g., the RRC reconfiguration message includes a ReconfigurationWithSync IE) for change of the serving cell (e.g., PCell or PSCell). When the UE operates in carrier aggregation (CA) of at least one secondary cell (SCell) with the PCell or PSCell, the RAN has to release the at least one SCell due to the change of the PCell or PSCell. The serving cell change involves complete L2 (and L1) resets, leading to longer latency, larger overhead and longer interruption time.

To address these concerns, 3GPP recently proposed to develop mobility procedures to reduce latency and overhead for fast serving cell change, described in the technical document RP-221799. These procedures provide fast serving cell changes and can be referred to as lower layer triggered mobility (LTM).

The RAN can transmit one or multiple LTM configurations for fast serving cell changes to a UE. However, it is not yet clear how a RAN node or a UE should trigger a fast serving cell change.

### SUMMARY

An example embodiment of the techniques of this disclosure is a method implemented in a central unit (CU) of a distributed base station. The method comprises: transmitting, to a distributed unit (DU) of the distributed base station, a CU-to-DU message related to a lower layer triggered mobility (LTM) of a user equipment (UE) connected to the distributed base station, the CU-to-DU message including a cell identifier (ID) of a candidate cell; receiving, from the DU in response to the CU-to-DU message, a DU-to-CU message including (i) an LTM configuration for the candidate cell and (ii) the cell ID; and transmitting, to the UE via the DU, the LTM configuration.

Another example embodiment of these techniques is a method implemented in a distributed unit (DU) of a distributed base station. The method comprises: receiving, from a central unit (CU) of the distributed base station, a CU-to-DU message related to a lower layer triggered mobility (LTM) of a user equipment (UE) connected to the distributed base station, the CU-to-DU message including a cell identifier (ID) of a candidate cell associated with the DU; transmitting, from the DU in response to the CU-to-DU message, a DU-to-CU message including (i) an LTM configuration for the candidate cell and (ii) the cell ID; receiving, from the CU, the LTM configuration for the UE; and transmitting the LTM configuration to the UE.

Another example embodiment of these techniques is a radio access network (RAN) node comprising processing hardware and configured to implement one of the methods above.

### BRIEF DESCRIPTION OF THE DRAWINGS

FIG. 1A is a block diagram of an example system in which a radio access network (RAN) and a user device can implement the techniques of this disclosure for managing conditional procedures related to a secondary node (SN);

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3 is a messaging diagram of an example scenario in which a UE performs an LTM switch from a serving cell of a DU to a candidate cell of the same DU;

FIG. 4 is a messaging diagram of an example scenario in which a UE performs an LTM switch from a serving cell of a source DU to a candidate cell of a target DU;

FIGS. 5A-B are messaging diagrams of example scenarios in which a UE operates in dual connectivity with an MN and an SN, and performs an LTM switch from a serving cell of a DU of the SN to a candidate cell of the same DU of the SN;

FIGS. 6A-B are messaging diagrams of example scenarios in which a UE operates in dual connectivity with an MN and an SN, and performs an LTM switch from a serving cell of a source DU of the SN to a candidate cell of the target DU of the SN;

FIG. 7A-B are messaging diagrams of scenarios similar to those of FIGS. 5A-B, but where the MN and the SN are implemented in different DUs of the same distributed base station;

FIG. 8A-B are messaging diagrams of scenarios similar to those of FIGS. 6A-B, but where the MN and the SN are implemented in different DUs of the same distributed base station;

FIG. 9A is a flow diagram of an example method for configuring and triggering LTM for a UE, using cell IDs and cell indexes, which can be implemented in a DU of this disclosure;

FIG. 9B is a flow diagram of an example method for configuring and triggering LTM for a UE, using an LTM group ID, which can be implemented in a DU of this disclosure;

FIG. 9C is a flow diagram of an example method for configuring and triggering LTM for a UE, using an LTM group ID and cell indexes, which can be implemented in a DU of this disclosure;

FIG. 9D is a flow diagram of an example method for configuring and triggering LTM for a UE, using a group ID, cell IDs, and cell indexes, which can be implemented in a DU of this disclosure;

FIG. 10A is a flow diagram of an example method for configuring LTM for a UE, using cell IDs and cell indexes, which can be implemented in a CU of this disclosure;

FIG. 10B is a flow diagram of an example method for configuring LTM for a UE, using an LTM group ID, which can be implemented in a CU of this disclosure;

FIG. 10C is a flow diagram of an example method for configuring LTM for a UE, using an LTM group ID and cell indexes, which can be implemented in a CU of this disclosure;

FIG. 10D is a flow diagram of an example method for configuring LTM for a UE, using a group ID, cell IDs, and cell indexes, which can be implemented in a CU of this disclosure;

FIG. 11A-D are flow diagrams of further methods for configuring LTM for a UE, which can be implemented in a CU of this disclosure;

FIG. 12 is a flow diagram of an example method for triggering LTM at a UE using a cell index, which can be implemented in a DU of this disclosure; and

FIG. 13 is a flow diagram of an example method for triggering LTM at a UE using a cell index and LTM group ID, which can be implemented in a DU of this disclosure

### DETAILED DESCRIPTION OF THE DRAWINGS

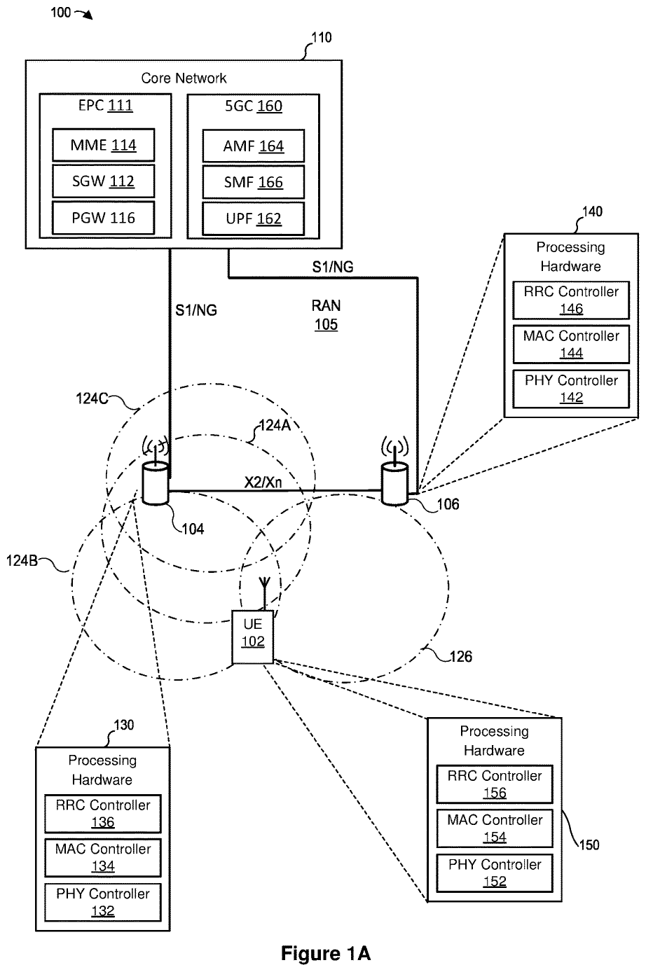

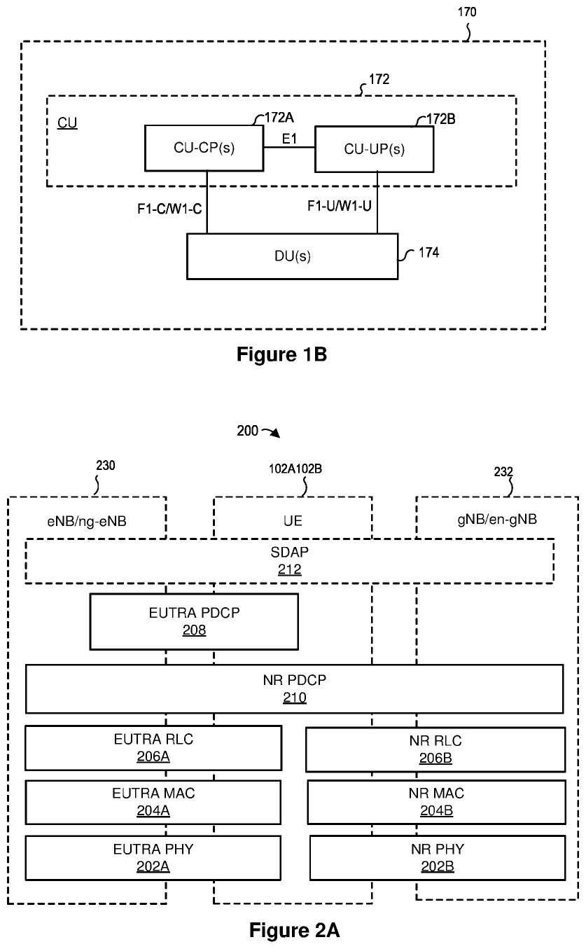

FIG. 1A depicts an example wireless communication system 100 in which communication devices can implement these techniques. The wireless communication system 100 includes a UE 102, a RAN 105 including a base station (BS) 104 and a base station 106, and a core network (CN) 110. The UE 102 initially connects to the base station 104. In some scenarios, the base station 104 can perform an SN addition to configure the UE 102 to operate in dual connectivity (DC) with the base station 104 and the base station 106. The base stations 104 and 106 operate as an MN and an SN for the UE 102, respectively.

In various configurations of the wireless communication system 100, the base station 104 can be implemented as a master eNB (MeNB) or a master gNB (MgNB), and the base station 106 can be implemented as a secondary gNB (SgNB). The UE 102 can communicate with the base station 104 and the base station 106 via the same RAT such as EUTRA or NR, or different RATs. When the base station 104 is an MeNB and the base station 106 is a SgNB, the UE 102 can be in EUTRA-NR DC (EN-DC) with the MeNB and the SgNB.

In some cases, an MeNB or an SeNB is implemented as an ng-eNB rather than an eNB. When the base station 104 is a Master ng-eNB (Mng-eNB) and the base station 106 is a SgNB, the UE 102 can be in next generation (NG) EUTRA-NR DC (NGEN-DC) with the Mng-eNB and the SgNB. When the base station 104 is an MgNB and the base station 106 is an SgNB, the UE 102 may be in NR-NR DC (NR-DC) with the MgNB and the SgNB. When the base station 104 is an MgNB and the base station 106 is a Secondary ng-eNB (Sng-eNB), the UE 102 may be in NR-EUTRA DC (NE-DC) with the MgNB and the Sng-eNB.

In the scenarios where the UE 102 hands over from the base station 104 to the base station 106, the base stations 104 and 106 operate as the source base station (S-BS) and a target base station (T-BS), respectively. The UE 102 can operate in DC with the base station 104 and an additional base station (not shown in FIG. 1A) for example prior to the handover. The UE 102 can continue to operate in DC with the base station 106 and the additional base station or operate in single connectivity (SC) with the base station 106, after completing the handover. The base stations 104 and 106 in this case operate as a source MN (S-MN) and a target MN (T-MN), respectively.

A core network (CN) 110 can be an evolved packet core (EPC) 111 or a fifth-generation core (5GC) 160, both of which are depicted in FIG. 1A. The base station 104 can be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. To directly exchange messages with each other during the scenarios discussed below, the base stations 104 and 106 can support an X2 or Xn interface. Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports cell 124A, and the base station 106 supports a cell 126. The cells 124A and 126 can partially overlap, so that the UE 102 can communicate in DC with the base station 104 and the base station 106, where one of the base stations 104 and 106 is an MN and the other is an SN. The base station 104 can support additional cell(s) such as cells 124B and 124C, and the base station 106 can support additional cell(s) (not shown in FIG. 1A). The cells 124A, 124B and 124C can partially overlap, so that the UE 102 can communicate in carrier aggregation (CA) with the base station 104. The base station 104 can operate the cells 124A, 124B and 124C via one or more transmit and receive points (TRPs). More particularly, when the UE 102 is in DC with the base station 104 and the base station 106, one of the base stations 104 and 106 operates as an MeNB, an Mng-eNB or an MgNB, and the other operates as an SgNB or an Sng-eNB.126

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

With continued reference to FIG. 1A, the base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 can include a PHY controller 132 configured to transmit data and control signal on physical downlink (DL) channels and DL reference signals with one or more user devices (e.g. UE 102) via one or more cells (e.g., the cell(s) 124A, 124B and/or 124C) and/or one or more TRPs. The PHY controller 132 is also configured to receive data and control signal on physical uplink (UL) channels and/or UL reference signals with the one or more user devices via one or more cells (e.g., the cell(s) 124A, 124B and/or 124C) and/or one or more TRPs. The processing hardware 130 in an example implementation includes a MAC controller 134 configured to perform MAC functions with one or more user devices. The MAC functions includes a random access (RA) procedure, managing UL timing advance for the one or more user devices, and/or communicating UL/DL MAC PDUs with the one or more user devices. The processing hardware 130 can further include an RRC controller 136 to implement procedures and messaging at the RRC sublayer of the protocol communication stack. For example, the RRC controller 132 may be configured to support RRC messaging associated with handover procedures, and/or to support the necessary operations when the base station 104 operates as an MN relative to an SN or as an SN relative to an MN. The base station 106 can include processing hardware 140 that is similar to processing hardware 130. In particular, components 142, 144, and 146 can be similar to the components 132, 134, and 136, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The PHY controller 152 is also configured to receive data and control signal on physical DL channels and/or DL reference signals with the base station 104 or 106 via one or more cells (e.g., the cell(s) 124A, 124B, 124C and/or 126) and/or one or more TRPs. The PHY controller 152 is also configured to transmit data and control signal on physical UL channels and/or UL reference signals with the base station 104 or 106 via one or more cells (e.g., the cell(s) 124A, 124B, 124C and/or 126) and/or one or more TRPs. The processing hardware 150 in an example implementation includes a MAC controller 154 configured to perform MAC functions with base station 104 or 106. For example, the MAC functions includes a random access procedure, managing UL timing advance for the one or more user devices, and communicating UL/DL MAC PDUs with the base station 104 or 106. The processing hardware 150 can further include an RRC controller 156 to implement procedures and messaging at the RRC sublayer of the protocol communication stack.

In operation, the UE 102 in DC can use a radio bearer (e.g., a DRB or an SRB) that at different times terminates at the MN 104 or the SN 106. The UE 102 can apply one or more security keys when communicating on the radio bearer, in the uplink (UL) (from the UE 102 to a base station) and/or downlink (from a base station to the UE 102) direction.

FIG. 1B depicts an example distributed implementation of a base station such as the base station 104 or 106. The base station in this implementation can include a central unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. For example, the CU 172 can include a PDCP controller, an RRC controller and/or an RRC inactive controller. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an IAB-node, and the CU 172 operates as an IAB-donor. In some embodiments, the RAN 105 supports Non-Terrestrial Network (NTN) functionality.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

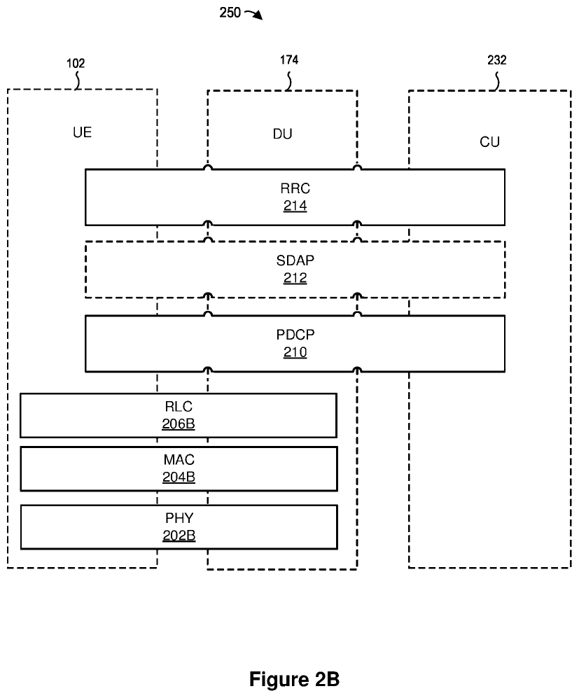

FIG. 2A illustrates, in a simplified manner, an example protocol stack 200 according to which the UE 102 can communicate with an eNB/ng-eNB 230 or a gNB 232 (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

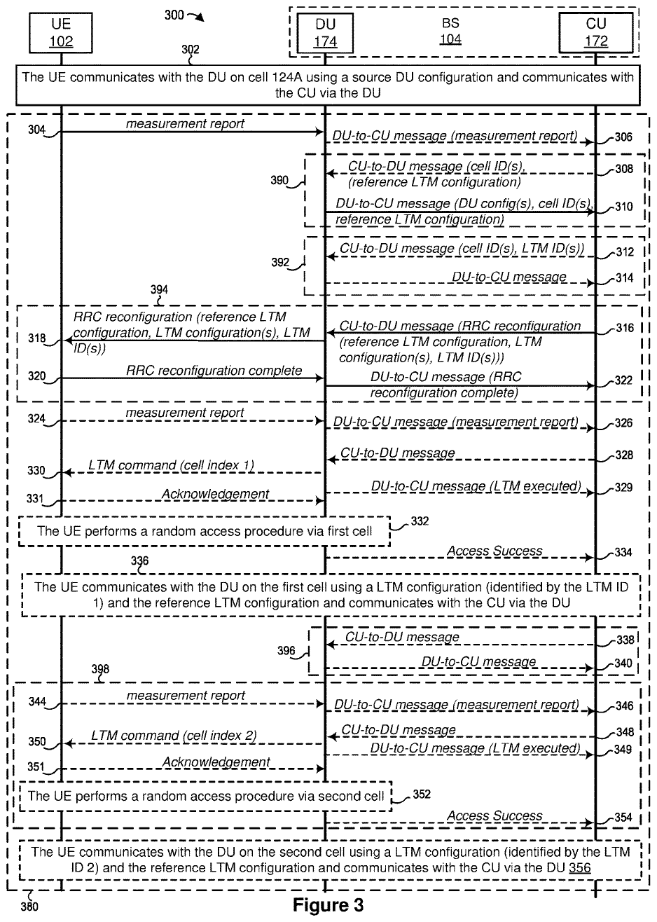

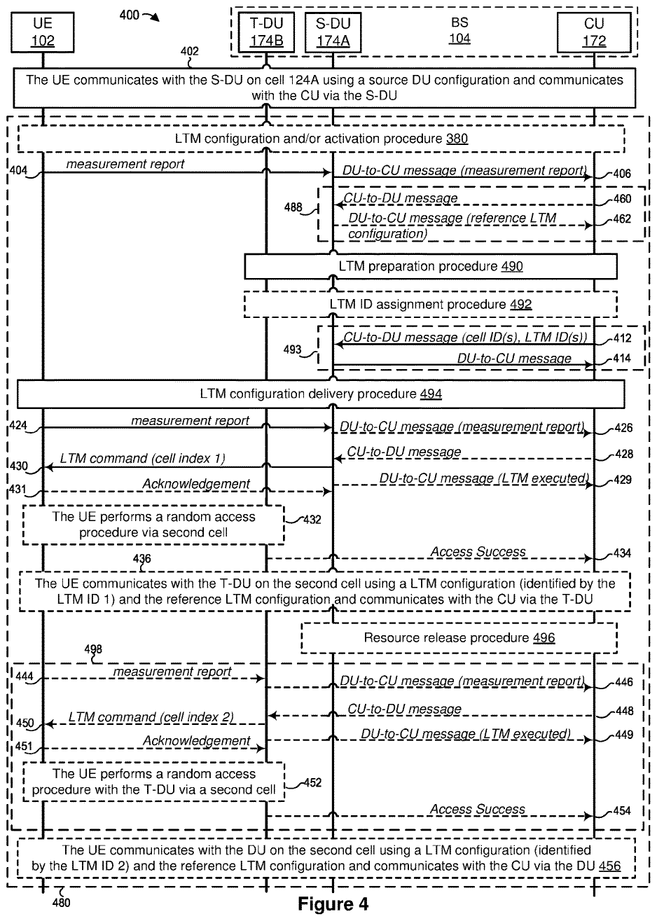

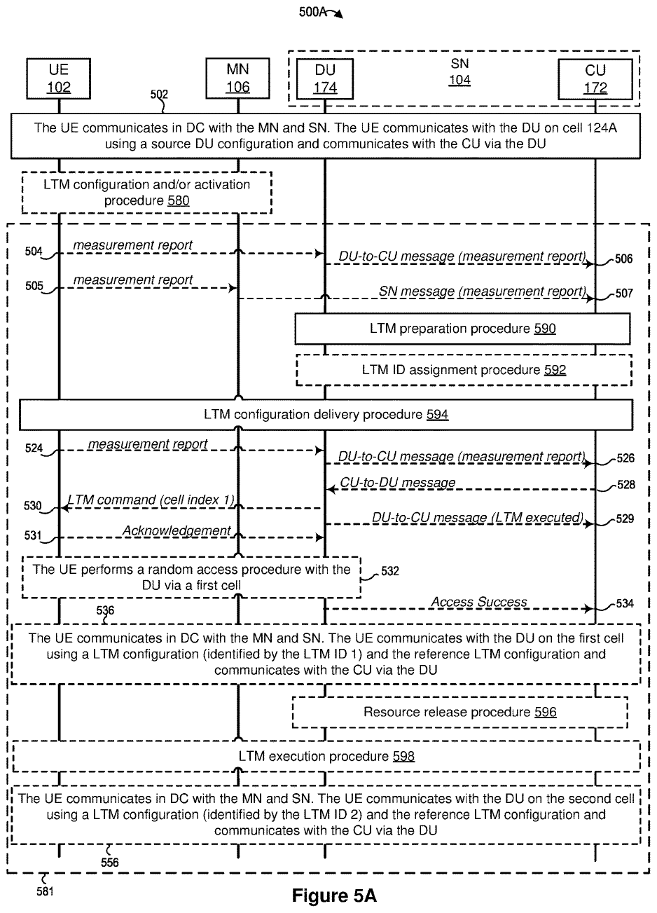

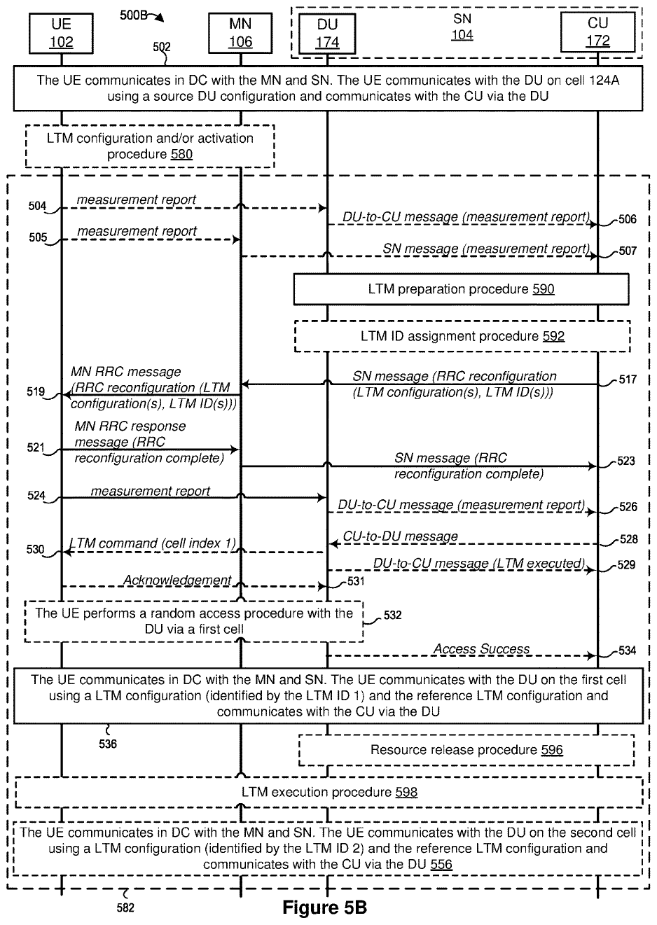

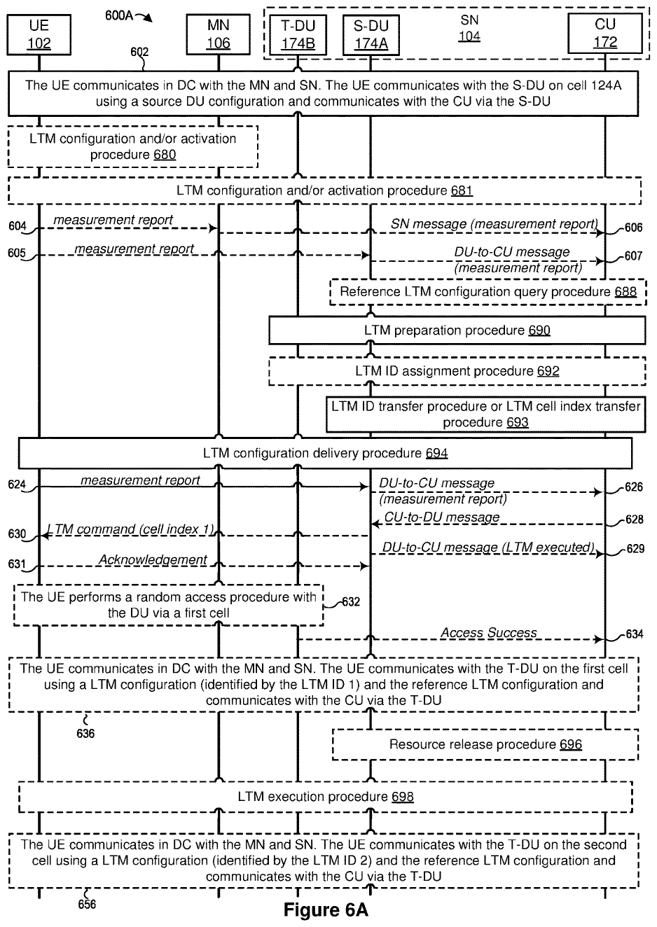

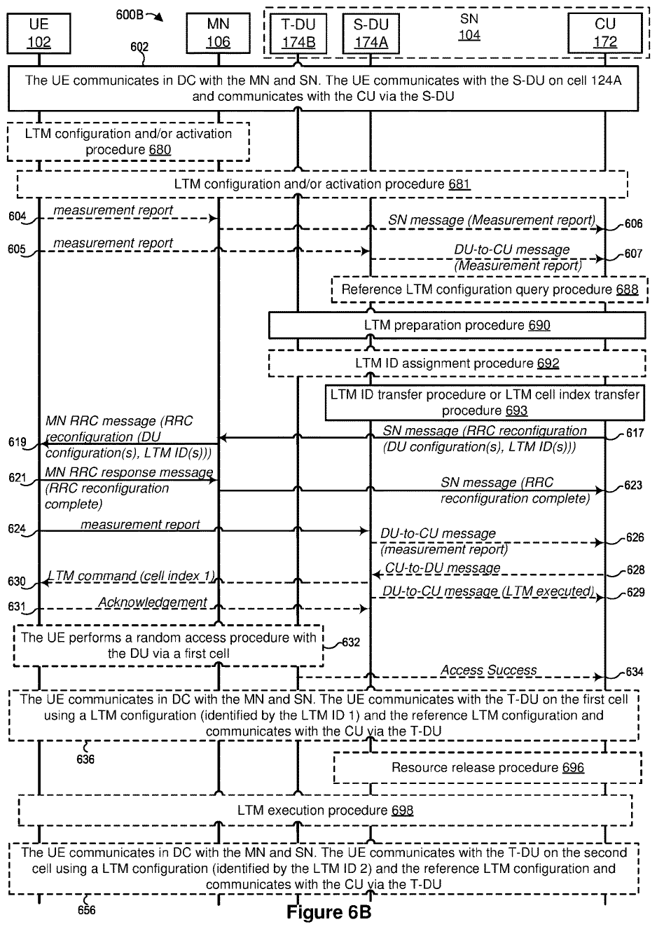

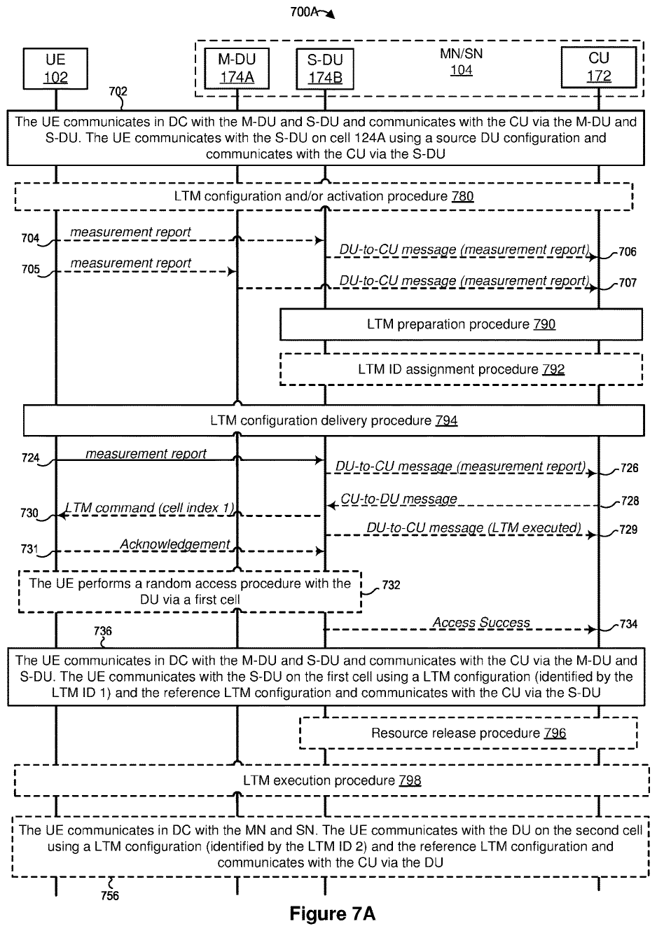

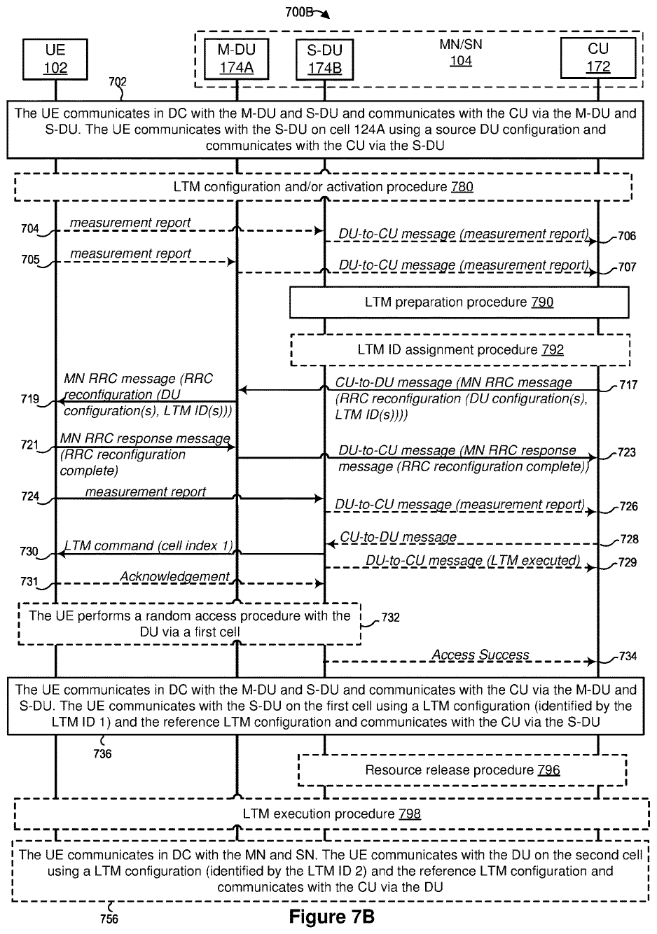

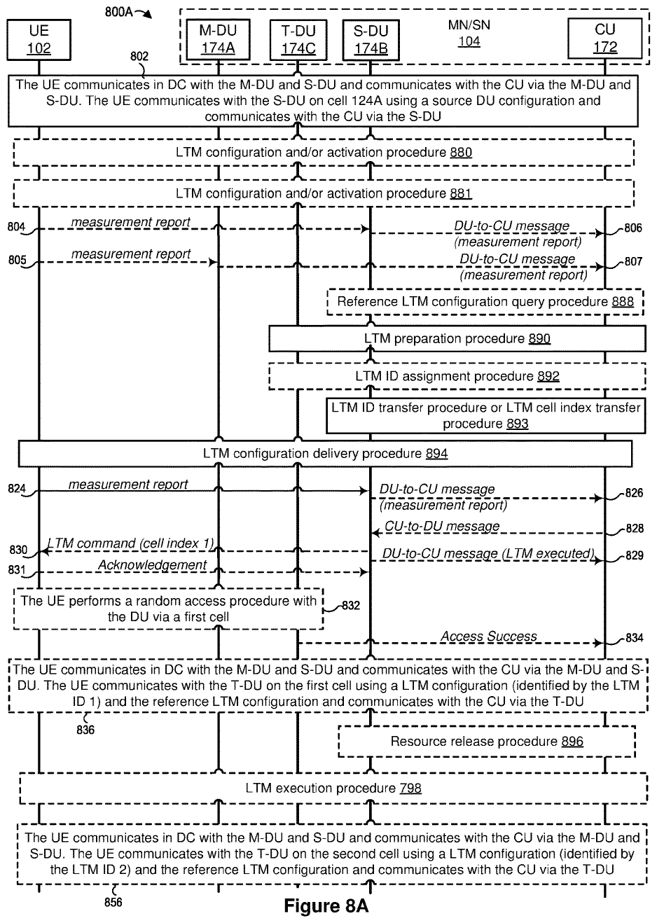

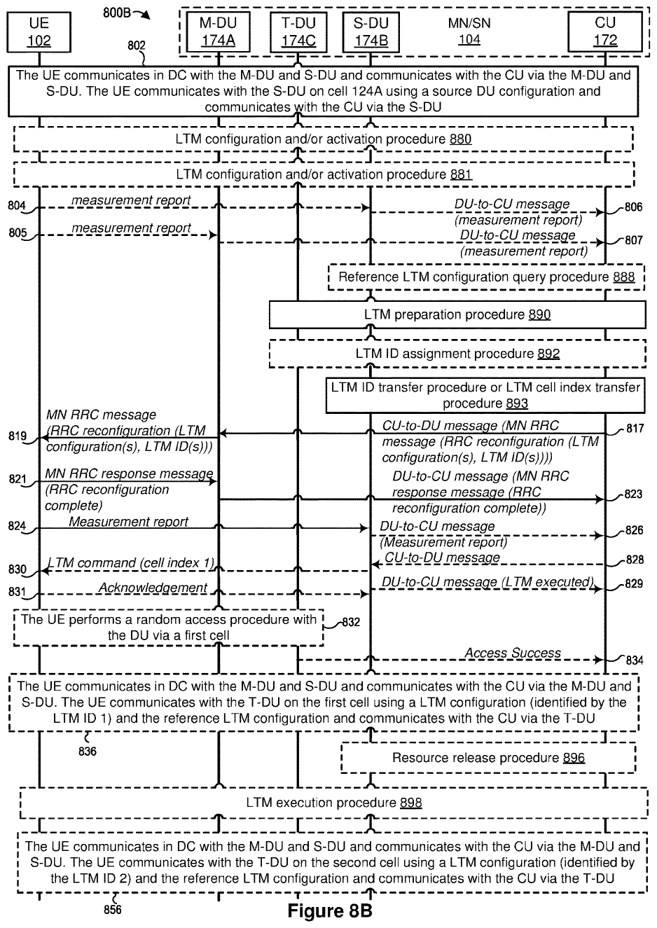

Next, several example scenarios in which the base station operating in the system of FIG. 1A transmits a configuration to the UE 102 and later activates a configuration for communication between the UE 102 and base station. Generally speaking, events in FIGS. 3-8B that are similar are labeled with similar reference numbers that share the tens and ones digits (e.g., event 306 is similar to event 406 of FIG. 4, event 506 of FIGS. 5A and 5B, event 806 of FIGS. 8A and 8B; event 328 of FIG. 3 is similar to event 428 of FIG. 4, event 528 of FIGS. 5A and 5B, event 628 of FIGS. 6A and 6B, event 728 of FIGS. 7A and 7B, event 828 of FIGS. 8A and 8B; etc.), with the differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3, in a scenario 300, the base station 104 includes a CU 172 and a DU 174 and the DU 174 operates the cell 124A. The UE 102 initially communicates 302 with the DU 174 on the cell 124A using a serving DU configuration, and communicates with the CU 172 via the DU 174, e.g., using a serving CU configuration. In some implementations, the UE 102 in carrier aggregation (CA) communicates with the DU 174 on the cell 124A and other cell(s) (e.g., cell 124D not shown in FIG. 1A) using the serving DU configuration. The DU 174 operates the other cell(s). In other implementations, the UE 102 in communicates with the DU 174 on the cell 124A only. In some implementations, the UE 102 communicates with the DU 174 on the cell 124A and/or other cell(s) via one or multiple TRPs. In some implementations, the cell 124A is a PCell. In such cases, the other cell(s) include SCell(s) and/or additional cell(s) associated with the PCell or an SCell. In other implementations, the cell 124A is an SCell, and one of the other cell(s) is a PCell. In such cases, the remaining cells can include SCell(s) and/or additional cell(s) associated with the PCell or a SCell. In the scenarios below, the base station 104 can be the DU 174, the CU 172 or the DU 174 and CU 172.

During the procedure 302, the UE 102 can transmit UL PDUs and/or UL control signals to the base station 104 on the cell 124A and/or other cell(s) via one or multiple TRPs. In some implementations, the UE 102 communicates UL PDUs and/or DL PDUs with the base station 104 via radio bearers which can include SRBs and/or DRB(s). The base station 104 can configure the radio bearers to the UE 102. In some implementations, UL control signals include UL control information, channel state information, hybrid automatic repeat request (HARQ) acknowledgements (ACKs), HARQ negative ACKs, scheduling request(s) and/or sounding reference signal(s). Similarly, the UE 102 can receive DL PDUs and/or DL control signals from the base station 104 on the cell 124A and/or other cell(s) via one or multiple TRPs. In some implementations, the DL control signals include downlink control information (DCIs) and reference signals (e.g., synchronization signal block, channel state information reference signal(s) (CSI-RS(s)), and/or tracking reference signal(s)). The base station 104 can transmit the DCIs on physical downlink control channel(s) (PDCCH(s)) monitored by the UE 102, on the cell 124A and/or other cell(s) via one or multiple TRPs.

In some implementations, the serving DU configuration includes physical layer configuration parameters, MAC configuration parameters, and/or RLC configuration parameters. In some implementations, the DU 174 can transmit these configuration parameters to the CU 172. The CU 172 generates one or more messages (e.g., RRC reconfiguration message(s)) including the configuration parameters and transmits the one or more messages to the UE 102 via the DU 174. In other implementations, the DU 174 transmits the configuration parameters to the UE 102 directly. In some implementations, the serving DU configuration is CellGroupConfig IE defined in 3GPP specification 38.331. In other implementations, the serving DU configuration includes configuration parameters in the CellGroupConfig IE. In some implementations, the serving CU configuration includes PDCP configuration parameters, measurement configuration parameters, and/or radio bearer configuration parameters. In some implementations, the serving CU configuration includes a MeasConfig IE and/or a RadioBearerConfig IE defined in 3GPP specification 38.331 or includes configuration parameters in the MeasConfig IE and/or RadioBearerConfig IE. In some implementations, the serving DU configuration includes a CSI-MeasConfig IE or configuration parameters for channel state information (CSI) measurement and reporting. In other implementations, the serving CU configuration includes a CSI-MeasConfig IE or configuration parameters for channel state information (CSI) measurement and reporting. In some implementations, the UE 102 receives the serving CU configuration or the configuration parameters in the serving CU configuration from the CU 172 via the DU 174. In other implementations, the UE 102 receives a portion of the serving CU configuration and/or a portion of the serving DU configuration from a base station other than the base station 104 and the remaining portion of these configuration parameters from the base station 104.

While communicating with the base station 104, the UE 102 transmits 304 at least one measurement report to the DU 174. In some implementations, the at least one measurement report includes Layer 1 (L1) measurement report(s) and/or Layer 3 (L3) measurement report(s) for at least one serving cell of the UE 102 and/or at least one non-serving cell. For each of the L3 measurement report(s), the DU 174 transmits 306 a DU-to-CU message including the L3 measurement report to the CU 172. In some implementations, the DU-to-CU message(s) of the event 306 is/are F1 application protocol (F1AP) message(s) (e.g., UL RRC Message Transfer message(s)). In some implementations, the DU 174 does not transmit or refrains from transmitting the L1 measurement report(s) to the CU 172. The at least one serving cell includes the cell 124A and/or other cell(s), and the at least one non-serving cell includes the cell 124B and/or cell 124C. In some implementations, the serving DU configuration or the serving CU configuration includes at least one measurement configuration. In some implementations, the UE 102 receives one or more RRC messages (e.g., RRCReconfiguration message(s)) including the at least one measurement configuration from the CU 172 via the DU 174 in the event 302. In accordance with the at least one measurement configuration, the UE 102 performs measurements and transmits 304 the at least one measurement report to the DU 174. In some implementations, the at least one measurement configuration includes L3 measurement configuration(s) (e.g., MeasConfig IE(s)) and/or L1 measurement configuration(s). The L1 measurement configuration(s) (e.g., CSI-MeasConfig IE(s)) can include L1 measurement resource configuration(s) and/or L1 measurement reporting configuration(s). The L1 measurement resource configuration(s) can configure resources of reference signal(s) (e.g., CSI-RS(s)) for the UE 102 to measure and obtain L1 measurement results. For example, the L1 measurement resource configuration(s) is/are CSI-ResourceConfig IE(s). In another example, the L1 measurement reporting configuration(s) configures way(s) the UE 102 uses to transmit L1 measurement results/reports. For example, the L1 measurement report configuration(s) is/are CSI-ReportConfig IE(s). For example, The UE 102 transmits the L3 measurement report(s) to the CU 172 via the DU 174 in accordance with the L3 measurement configuration(s). The UE 102 transmits the L1 measurement report(s) to the DU 174 in accordance with the L1 measurement configuration(s) or L1 measurement reporting configuration(s). In one implementations, the DU 174 does not transmit the L1 measurement report(s) to the CU 172.

In some implementations, the L1 measurement configuration(s) are-dedicated RRC IE(s) specifically defined for, and dedicated to (e.g., in a relevant 3GPP specification such as TS 38.331), lower layer triggered mobility (LTM). In some implementations, the L1 measurement resource configuration(s) are RRC IE(s) specifically defined for, and dedicated to LTM (e.g., in a relevant 3GPP specification such as TS 38.331). In some implementations, the L1 measurement reporting configuration(s) are RRC IE(s) specifically defined for, and dedicated to LTM (e.g., in a relevant 3GPP specification such as TS 38.331). In some implementations, each of the L1 measurement reporting configuration(s) can include a trigger event configuration configuring a trigger event to trigger the UE 102 to transmit a L1 measurement report. If the UE 102 detects the trigger event, the UE 102 transmits a L1 measurement report to the DU 174.

In some implementations, (each of) the L1 measurement report(s) can include at least one L1 measurement result. In some implementations, the at least LI measurement result includes at least one L1-reference signal received power (L1-RSRP) value, L1-reference signal received quality (L1-RSRQ) and/or at least one L1-Signal to Interference Noise Ratio (L1-SINR) value. For each of the L1 measurement report(s), the UE 102 transmits a PUCCH transmission including the L1 measurement report to the DU 174, in some implementations. That is, the UE 102 transmits the each of the L1 measurement report(s) on a PUCCH to the DU 174. In other implementations, for each of the L1 measurement report(s), the UE 102 transmits a PUSCH transmission including the L1 measurement report to the DU 174. That is, the UE 102 transmits the each of the L1 measurement report(s) on a PUSCH to the DU 174. In yet other implementations, the UE 102 transmits a portion of the L1 measurement report(s) on PUCCH(s) and the rest of the L1 measurement report(s) on physical UL shared channel(s) (PUSCH(s)) to the DU 174. That is, for each of the portion of the LI measurement report(s), the UE 102 transmits a PUCCH transmission including the L1 measurement report to the DU 174, and for each of the rest of the L1 measurement report(s), the UE 102 transmits a PUSCH transmission including the L1 measurement report to the DU 174. In some implementations, each of the L1 measurement report(s) is a part of channel state information (CSI) (i.e., a CSI component) or CSI. In some implementations, the UE 102 can include other CSI component(s) in (each of) the PUCCH transmission(s) and/or PUSCH transmission(s) described above. In one implementation, the other CSI component(s) include such as a channel quality indicator (CQI), a Precoding Matrix Indicator (PMI), a CSI-RS Resource Indicator (CRI), a Synchronization Signal (SS)/ Physical Broadcast Channel (PBCH) Resource Block Indicator (SSBRI), a Layer Indicator (LI), and/or a Rank Indicator (RI). In some implementations, the UE 102 does not transmit the L1 measurement report(s) in format of RRC message(s) to the DU 174. In some implementations, each of the L1 measurement report(s) includes a L1 event ID to identify or indicate the trigger L1 event. Alternatively, each of the L1 measurement report(s) does not include a L1 event ID to identify or indicate the trigger L1 event.

In some implementations, each of the L3 measurement report(s) can include at least one L3 measurement result. In some implementations, the at least one L3 measurement result includes at least one RSRP (value) and/or at least one SINR (value). In one implementation, the UE 102 transmits each of the L3 measurement report(s) on a PUSCH to the CU 172 via the DU 174. In some implementations, each of the L3 measurement report(s) can be a RRC message (e.g., MeasurementReport message). In some implementations, each of the L3 measurement configuration(s) includes a particular measurement identity (e.g., measId) and each of the L3 measurement report(s) includes a particular measurement identity in a particular L3 measurement configuration. When the CU 172 receives a L3 measurement report including a measurement identity and a L3 measurement result from the UE 102 via the DU 174, the CU 172 can determine that the L3 measurement report is associated to a L3 measurement configuration identified by the measurement identity.

In some alternative implementations, for each of the at least one measurement report (e.g., L1 measurement report(s)), the UE 102 transmits a MAC control element (CE) including the measurement report to the DU 174 in the event 304. To transmit the MAC CE(s), the UE 102 generate one or more MAC PDUs each including one or more of the MAC CE(s) to the DU 174 in the event 304.

In some implementations, the UE 102 performs measurements on one or more reference signals in accordance with the at least one measurement configuration. The one or more reference signals can include one or more Synchronization Signal (SS)/ Physical Broadcast Channel (PBCH) Resource Blocks (SSBs) and/or one or more CSI-RSs. The UE 102 obtains the at least one L1 measurement result and/or at least one L3 measurement result from the measurements. The DU 174 transmits the one or more reference signals on the cell 124A and other cell(s) (e.g., the cell 124B, the cell 124C and/or cell(s) not shown in FIG. 1A).

After (e.g., in response to) receiving one or more of the at least one measurement report from the UE 102, the base station 104 (i.e., the CU 172 or DU 174) determines to prepare a first cell (e.g., the cell 124B) for LTM for the UE 102. In some implementations, the base station 104 determines to prepare the first cell for the UE 102 because the at least one measurement report indicates that the first cell could be used by the base station 104 to communicate with the UE 102. In some implementations, the base station 104 determines to prepare the first cell for the UE 102 because the at least one measurement report indicates that the first cell qualifies to be a candidate cell that could be used for communication with the UE 102. In some implementations, if the L3 measurement report(s) indicates that the signal strength and/or quality of the first cell is above a first predetermined threshold, is better than the strength and/or quality of the cell 124A, and/or is better than the strength and/or quality of the cell 124A by a first predetermined threshold, the CU 172 determines to prepare the first cell for the UE 102. In other implementations, if the L1 measurement report(s) indicates that signal strength and/or quality of the first cell is above a first predetermined threshold, is better than signal strength and/or quality of the cell 124A, and/or is better than signal strength and/or quality of the cell 124A by a first predetermined threshold, the DU 174 determines to prepare the first cell for the UE 102. Alternatively, the base station 104 determines to prepare the first cell for the UE 102 regardless of whether a measure report is received from the UE 102.

When the CU 172 determines to prepare the first cell for LTM, the CU 172 transmits 308 a first CU-to-DU message to the DU 174 to prepare the first cell for the UE 102. In some implementations, the CU 172 includes a cell identity (ID) of the first cell (i.e., cell ID 1) in the first CU-to-DU message to request the DU 174 to prepare the first cell for LTM for the UE 102. For example, the cell ID is cell global identity (CGI). In another example, the cell ID is a portion of the CGI. In yet another example, the cell ID is a physical cell ID (PCI). In response to the first CU-to-DU message, the DU 174 generates a first LTM configuration (referred to herein after as LTM configuration 1) for the UE 102, which configures the first cell for LTM. The DU 174 then transmits 310 a first DU-to-CU message including the LTM configuration 1 to the CU 172 in response to the first CU-to-DU message. In some implementations, the DU 174 can include the cell ID 1 together with the LTM configuration 1 in an IE of the first DU-to-CU message to indicate that the LTM configuration 1 is associated with the first cell (i.e., the cell ID 1). In the case that the DU 174 determines to prepare the first cell, the DU 174 initiates transmission of the first DU-to-CU message to the CU 172 instead of in response to a CU-to-DU message received from the CU 172.

In some implementations, the DU 174 includes, in the first DU-to-CU message, the cell ID of the first cell associated with the LTM configuration 1 to indicate that the LTM configuration 1 is configured for or associated with the first cell. The CU 172 identifies the LTM configuration 1 is configured for or associated with the first cell. In some scenarios and implementations, the CU 172 can include additional cell ID(s) (e.g., cell ID(s) 2, . . . , N) in the first CU-to-DU message to prepare additional cell(s) (e.g., cell(s) 2, . . . , N) for LTM for the UE 102, and the DU 174 includes additional LTM configuration(s) (e.g., LTM configuration(s) 2, . . . , N) each configuring a particular cell of the additional cell(s), as described below. In such cases, the DU 174 includes, in the first DU-to-CU message, the additional cell ID(s) respectively associated with the additional LTM configuration(s) to indicate that which LTM configuration is associated to which cell (ID). The cell(s) 1 and/or 2, . . . , N are candidate cell(s).

In some implementations, the CU 172 does not include a (reference) LTM configuration in the first CU-to-DU message. In such cases, the DU 174 generates a reference LTM configuration, generates the LTM configuration(s) 1 and/or 2, . . . , N (i.e., non-reference LTM configuration(s)) based on the reference LTM configuration, and includes the reference LTM configuration in the first DU-to-CU message. In other implementations, the CU 172 includes a reference LTM configuration in the first CU-to-DU message. In such cases, the DU 174 generates the LTM configuration(s) 1, and/or 2, . . . , N which are delta configuration(s) to augment the reference LTM configuration. In yet other implementations, the CU 172 includes a reference LTM configuration (e.g., a first reference LTM configuration) in the first CU-to-DU message. In such cases, the DU 174 generates a reference LTM configuration (e.g., a second reference LTM configuration) replacing the first reference LTM configuration, generates the LTM configuration(s) 1 and/or 2, . . . , N based on the second reference LTM configuration, and includes the second reference LTM configuration in the first DU-to-CU message.

In some implementations, the reference LTM configuration includes physical layer configuration parameters, MAC configuration parameters, and/or RLC configuration parameters. In some implementations, the reference LTM configuration is CellGroupConfig IE defined in 3GPP specification 38.331. In other implementations, the reference LTM configuration includes configuration parameters in the CellGroupConfig IE. In some implementations, the reference LTM configuration includes a CSI-MeasConfig IE or configuration parameters for channel state information (CSI) measurement and/or reporting.

In some implementations, the reference LTM configuration is different from the serving DU configuration. In some implementations, a portion of the reference LTM configuration is the same as a portion of the serving DU configuration and the rest of the reference LTM configuration is different from the rest of the serving DU configuration. In other implementations, the reference LTM configuration is the same as the serving DU configuration.

After receiving the first DU-to-CU message, the CU 172 generates a RRC reconfiguration message (e.g., an RRCReconfiguration message) including the LTM configuration 1 and transmits 316 a second CU-to-DU message including the RRC reconfiguration message to the DU 174. In some implementations, the CU 172 includes the reference LTM configuration in the RRC reconfiguration message 316. In other implementations, the CU 172 does not include a/the reference LTM configuration in the RRC reconfiguration message 316. In some implementations, if the CU 172 transmits the reference LTM configuration to the UE 102 during the event 302, the CU 172does not include the reference LTM configuration in the RRC reconfiguration message 316. In other implementations, if the CU 172 receives the reference LTM configuration from the DU 174, the CU 172 includes the LTM configuration in the RRC reconfiguration message 316. Otherwise, if the CU 172 does not receive a reference LTM configuration from the DU 174, the CU 172 does not include the reference LTM configuration in the RRC reconfiguration message 316.

After receiving the RRC reconfiguration message 316, the DU 174 transmits 318 the RRC reconfiguration message to the UE 102. In response, the UE 102 transmits 320 an RRC reconfiguration complete message (e.g., an RRCReconfigurationComplete message) to the DU 174, which in turn transmits 322 a second DU-to-CU message including the RRC reconfiguration complete message to the CU 172. In some implementations, the CU 172 performs a security protection (e.g., integrity protection and/or encryption) on the RRC reconfiguration message. For example, the CU 172 generates a message authentication code for integrity (MAC-I) for the RRC reconfiguration message, encrypts the RRC reconfiguration message and the MAC-I to obtain an encrypted RRC reconfiguration message and an encrypted MAC-I, and transmits a PDCP PDU including the encrypted RRC reconfiguration message and encrypted MAC-I to the UE 102 via the DU 174 in the events 316 and 318. When the UE 102 receives the PDCP PDU from the CU 172 via the DU 174 (i.e., events 316 and 318), the UE 102 decrypts the encrypted RRC reconfiguration and encrypted MAC-I to obtain the RRC reconfiguration message and MAC-I and verifies whether the MAC-I is valid. If the UE 102 verifies the MAC-I is invalid, the UE 102 discards or ignores the RRC reconfiguration message. In some implementations, the UE 102 can perform a RRC connection reestablishment procedure in response to the invalid MAC-I. Otherwise, if the UE 102 verifies the MAC-I is valid, the UE 102 can process the RRC reconfiguration. The UE 102 refrains from applying (i.e., executing) the LTM configuration 1 until receiving a configuration activation command activating the LTM configuration 1 (e.g., the event 330).

The events 308 (optional) and 310 are collectively referred to in FIG. 3 as a LTM preparation procedure 390. The events 316, 318, 320, 322 are collectively referred to in FIG. 3 as a LTM configuration delivery procedure 394.

In some implementations, the DU 174 transmits the reference LTM configuration to the UE 102 in procedures similar to the procedures 390 and 392, before receiving the first CU-to-DU message. In such cases, the DU 174 does not include the reference LTM configuration in the first DU-to-CU message.

In some implementations, in the case that the CU 172 performs the multiple LTM preparation procedures 390, the DU 174 includes the reference LTM configuration in the first DU-to-CU message in the first LTM preparation procedure of the LTM preparation procedures 390. In such cases, the DU 174 may not include the reference LTM configuration in DU-to-CU messages in the rest of the LTM preparation procedures 390.

In some implementations, the first CU-to-DU message is a UE Context Modification Request message, and the first DU-to-CU message is a UE Context Modification Response message or UE Context Modification Required message. In the case of the UE Context Modification Required message, the CU 172 can transmit a UE Context Modification Confirm message to the DU 174 in response to UE Context Modification Required message. In some implementations, the second CU-to-DU message is a DL RRC Message Transfer message. In other implementations, the second CU-to-DU message is a UE Context Modification Request message and the DU 174 can transmit a second DU-to-CU message (e.g., UE Context Modification Response message) to the CU 172 in response to the second CU-to-DU message.

In some implementations, the CU 172 includes the LTM configuration 1 in a first container (e.g., a field/IE) and includes the first container in the RRC reconfiguration message of the events 316 and 318. In such cases, the CU 172 generates the first container. The first container is to indicate the UE 102 not to apply the LTM configuration 1 immediately. In some scenarios or implementations, the UE 102 receives a RRC reconfiguration message (e.g., the RRC reconfiguration message of the event 318) including a configuration (e.g., the LTM configuration 1). If the configuration is included in the first container, the UE 102 refrains from immediately applying the configuration. Otherwise, if the configuration is not included in the first container, the UE 102 can apply the configuration immediately. In some implementations, the first container can be a first addition or modification list (e.g., ltm-ConfigToAddModList field, LTM-ConfigToAddModList IE, Itm-CandidateConfigToAddModList field, or LTM-CandidateConfigToAddModList IE). The CU 172 includes the LTM configuration 1 in a first element (referred to herein after as element 1) of the first addition or modification list. For example, the element 1 can be an addition or modification IE (Itm-ConfigToAddMod field, LTM-ConfigToAddMod IE, Itm-CandidateConfigToAddMod field, or LTM-CandidateConfigToAddMod IE). When the UE 102 receives the first addition or modification list, the UE 102 can store the first addition or modification list, e.g., in a variable in its random access memory (RAM). In other alternative implementations, the DU 174 generates the first container and includes the first container in the first DU-to-CU message. In yet other alternative implementations, the DU 174 generates the element 1 and includes the element 1 in the first DU-to-CU message.

In some implementations, the CU 172 includes, in the RRC reconfiguration message, a first LTM ID (referred to herein after as ID 1) for identifying the LTM configuration 1 or the element 1. In some implementations, the CU 172 includes the ID 1 in the first container or element 1. In some implementations, the CU 172 assigns the ID 1. In other implementations, the CU 172 receives the ID 1 from the DU 174 in the first DU-to-CU message, as described below.

In the case that the CU 172 assigns or generates the ID 1, the CU 172 can transmit the ID 1 to the DU 174, and the DU 174 associates the ID 1 with the LTM configuration 1. In some implementations, in the first CU-to-DU message, the CU 172 includes the ID 1 and indicates the ID 1 is associated with the LTM configuration 1. In other implementations, after receiving the first DU-to-CU message, the CU 172 transmits 312 a third CU-to-DU message including the ID 1 to the DU 174 instead of including the ID 1 in the first CU-to-DU message. In some implementations, in the third CU-to-DU message, the CU 172 can include the LTM configuration 1 and the ID 1 and indicate the association between the ID 1 and LTM configuration 1. Thus, the DU 174 can directly associate the ID 1 with the LTM configuration 1. In other implementations, in the third CU-to-DU message, the CU 172 can include the cell ID 1 and the ID 1 (i.e., the first LTM ID) and indicate the association between the cell ID 1 and the ID 1. Thus, the DU 174 can associate the ID 1 with the LTM configuration 1, based on the association between the cell ID 1 and the ID 1 and the association between the cell ID 1 and the LTM configuration 1. In yet other implementations, in the third CU-to-DU message, the CU 172 can include the LTM configuration 1, the cell ID 1 and the ID 1 and indicate the association between the ID 1, LTM configuration 1 and the cell ID 1. In some implementations, the DU 174 can transmit 314 a third DU-to-CU message to the CU 172 in response to the third CU-to-DU message. In some implementations, the third CU-to-DU message and third DU-to-CU message are UE Context Modification Request message and UE Context Modification Response message. The events 312 (optional) and 314 (optional) are collectively referred to in FIG. 3 as a LTM ID assignment procedure 392. In other implementations, the CU 172 can include the ID 1, the cell ID 1 and/or the LTM configuration 1 in the second CU-to-DU message as described above. Thus, the third CU-to-DU message can be omitted.

In the case that the CU 172 includes the ID 1 in the first CU-to-DU message, the DU 174 can include the ID 1 in the LTM configuration 1, first container or element 1. Alternatively, the DU 174 does not include the ID 1 in the LTM configuration 1, first container and/or element 1.

In some alternative implementations, the DU 174 assigns the ID 1 identifying the LTM configuration 1. In some implementations, the DU 174 includes the ID 1 in the first DU-to-CU message. The CU 172 can include the ID 1 in the RRC reconfiguration message as described above. In other implementations, the DU 174 includes the ID 1 in the LTM configuration 1, first container or element 1. Thus, the CU 172 does not include an ID identifying the LTM configuration 1 in the RRC reconfiguration message, first container and/or element 1.

In some implementations, the CU 172 includes the reference LTM configuration in the first container. For example, the CU 172 includes the reference LTM configuration in a field of the first container, different from a field of the first container including the LTM configuration 1. In other implementations, the CU 172 includes the reference LTM configuration in the RRC reconfiguration message 316 and outside the first container. For example, the CU 172 generates a third container (e.g., a field/IE) to include the first container and the reference LTM configuration and includes the third container in the RRC reconfiguration message 316. In yet other implementations, the DU 174 includes the reference LTM configuration in the first container. For example, the DU 174 includes the reference LTM configuration in a field of the first container, different from a field of the first container including the LTM configuration 1. In yet other implementations, the DU 174 generates a fourth container (e.g., a field/IE) to include the first container and the reference LTM configuration and includes the fourth container in the first DU-to-CU message 310. In such cases, the CU 172 includes the fourth container in the RRC reconfiguration message 316. Alternatively, the CU 172 retrieves the reference LTM configuration and the LTM configuration 1 from the fourth container and includes the reference LTM DU configuration and the LTM DU configuration 1 as described above.

In some implementations, neither the CU 172 nor the DU 174 assign an ID to identify the reference LTM configuration. In such cases, there is no ID for the reference LTM configuration.

In some implementations, the LTM configuration 1 includes a plurality of configuration parameters for the UE 102 to communicate with the DU 174 on the first cell. In some implementations, the plurality of configuration parameters include physical layer configuration parameters (e.g., PhysicalCellGroupConfig IE), MAC layer configuration parameters (e.g., MAC-CellGroupConfig IE) and/or RLC configuration parameters (e.g., RLC-BearerConfig IE(s)). In some further implementations, the plurality of configuration parameters include a special cell configuration (e.g., SpCellConfig IE) and/or one or more SCell configurations (e.g., SCellConfig IE(s)). In some implementations, the LTM configuration 1 is CellGroupConfig IE defined in 3GPP specification 38.331. In other implementations, the LTM configuration 1 includes configuration parameters in the CellGroupConfig IE.

In some implementations, the DU 174 includes a random access configuration in the LTM configuration 1. In other implementations, the DU 174 does not include a random access configuration in the LTM configuration 1. In some implementations, if the cell 124A and first cell are not synchronized, the DU 174 determines to include the random access configuration in the LTM configuration 1. Otherwise, if the cell 124A and first cell are synchronized, the DU 174 determines to not include the random access configuration in the LTM configuration 1. In other implementations, if the DU 174 determines that the UE 102 has not synchronized in UL with the first cell, the DU 174 determines to include the random access configuration in the LTM configuration 1. Otherwise, if the DU 174 determines that the UE 102 has synchronized in UL with the first cell, the DU 174 determines to not include the random access configuration in the LTM configuration 1. If the LTM configuration 1 includes the random access configuration, the UE 102 performs the random access procedure in the event 332 in accordance with the random access configuration, as described below. Otherwise, if the LTM configuration 1 does not include the random access configuration, the UE 102 skips or refrains from performing the random access procedure of the event 332 in response to the LTM configuration 1 excluding the random access configuration.

In some implementations, the DU 174 includes random access configuration parameters in the LTM configuration 1 and/or the reference LTM configuration regardless of whether the cell 124A and first cell are synchronized or not. The UE 102 performs the random access procedure in the event 332 in accordance with the random access configuration parameters, as described below.

In some implementations, if the cell 124A and first cell are synchronized, the DU 174 determines to include, in the LTM configuration 1, a first indication configuring the UE 102 not to perform a random access procedure on the first cell. Otherwise, if the cell 124A and first cell are not synchronized, the DU 174 determines to not include the first indication in the LTM configuration 1. In other implementations, if the DU 174 determines that the UE 102 has synchronized in UL with the first cell, the DU 174 determines to include the first indication in the LTM configuration 1. Otherwise, if the DU 174 determines that the UE 102 has not synchronized in UL with the first cell, the DU 174 determines to not include the first indication in the LTM configuration 1. If the LTM configuration 1 includes the first indication, the UE 102 skips or refrains from performing the random access procedure of the event 332 in accordance with or in response to the first indication. Otherwise, if the LTM configuration 1 does not include the first indication, the UE 102 performs the random access procedure in accordance with the random access configuration in the event 332, in response to the LTM configuration 1 excluding the first indication, as described below.

In some implementations, the DU 174 includes a reconfiguration with sync configuration (e.g., ReconfigurationWithSync IE) in the LTM configuration 1 or special cell configuration. In other implementations, the DU 174 does not include a reconfiguration with sync configuration (e.g., ReconfigurationWithSync IE) in the LTM configuration 1 or special cell configuration. In some implementations, if the cell 124A and first cell are not synchronized, the DU 174 determines to include the reconfiguration with sync configuration in the LTM configuration 1. Otherwise, if the cell 124A and first cell are synchronized, the DU 174 determines to not include the reconfiguration with sync configuration in the LTM configuration 1. In other implementations, if the DU 174 determines that the UE 102 has not synchronized in UL with the first cell, the DU 174 determines to include the reconfiguration with sync configuration in the LTM configuration 1. Otherwise, if the DU 174 determines that the UE 102 has synchronized in UL with the first cell, the DU 174 determines to not include the reconfiguration with sync configuration in the LTM configuration 1. In some implementations, if the LTM configuration 1 includes the reconfiguration with sync configuration, the UE 102 performs the random access procedure in the event 332 as described below, in response to or in accordance with the reconfiguration with sync configuration. Otherwise, if the LTM configuration 1 does not include the reconfiguration with sync configuration, the UE 102 skips or refrains from performing the random access procedure of the event 332. In some implementations, the DU 174 includes a cell ID (i.e., cell ID 1) of cell 1 (i.e., the first cell) in the LTM configuration 1. In one implementation, the cell ID 1 can be a PCI. In another implementation, the cell ID 1 is a CGI. In some implementations, the cell ID 1 included in the LTM configuration 1 is a PCI, while the cell ID 1 included in the first CU-to-DU message is a CGI. In some further implementations, the LTM configuration 1 includes a cell index 1 indexing the cell ID 1 or the first cell. The cell index 1 is not a cell ID. The cell index takes fewer bits than the cell ID. In some implementations, the CU 172 sets the cell index 1 to a value and includes the cell index 1 in the first CU-to-DU message of the event 308.

In some implementations, after (e.g., in response to) receiving one or some of the at least one measurement report of the event 304, the base station 104 (i.e., the CU 172 or DU 174) determines to prepare additional cell(s) (i.e., cell(s) 2, . . . , N) of the base station 104 for LTM for the UE 102. In one implementation, the base station 104 determines to prepare the additional cell(s) for LTM for the UE 102 because the at least one measurement report indicates that the additional cell(s) could be used by the base station 104 to communicate with the UE 102. The additional cell(s) can include the cell 124C and/or cell(s) other than the cells 124A, 124B and 124C. In some implementations, if the L3 measurement report(s) indicates that signal strength and/or quality of a particular cell of the additional cell(s) is above a respective predetermined threshold and/or is better than the cell 124A, the CU 172 determines to prepare the particular cell for LTM for the UE 102. In other implementations, if the L1 measurement report(s) indicates that signal strength and/or quality of a particular cell of the additional cell(s) is above a first predetermined threshold and/or is better than the cell 124A, the DU 174 determines to prepare the particular cell for LTM for the UE 102. In one implementation, the respective predetermined threshold(s) for the additional cells can be different from the first predetermined threshold. In another implementation, the respective predetermined threshold(s) for the additional cell(s) can be the same as the first predetermined threshold. In some implementations, the respective predetermined thresholds for the additional cells can be the same or different. Alternatively, the base station 104 determines to prepare the additional cell(s) for the UE 102 regardless of whether a measurement report is received from the UE 102 or not.

In the case that the CU 172 determines to prepare the additional cell(s), the CU 172 initiates and performs at least one additional LTM preparation procedure (LTM preparation procedure(s)) with the DU 174 to prepare the additional cell(s) for LTM, where each of the LTM preparation procedure(s) is similar to the procedure 390. In the case that the DU 174 determines to prepare the additional cell(s), the DU 174 initiates and performs at least one additional LTM preparation procedure (LTM preparation procedure(s)) with the CU 172 to prepare the additional cell(s) for LTM, where each of the LTM preparation procedure(s) is similar to the procedure 390.

In some implementations, the CU 172 and DU 174 perform LTM preparation procedure(s) 2, . . . , N to prepare the cell(s) 2, . . . , N, respectively, similar to the procedure 390. The CU 172 can include the cell ID(s) 2, . . . , N in CU-to-DU message(s) 2, . . . , N in the LTM preparation procedure(s) 2, . . . , N, respectively, similar to the first CU-to-DU message. In the LTM preparation procedure(s) 2, . . . , N, the DU 174 generates LTM configuration(s) 2, . . . , N configuring the cell(s) 2, . . . , N and includes the LTM configuration(s) 2, . . . , N in DU-to-CU message(s) 2, . . . , N, respectively, as described for the LTM configuration 1. In the case that the DU 174 receives the CU-to-DU message(s) 2, . . . , N, the DU-to-CU message(s) 2, . . . , N responds to the CU-to-DU message(s) 2, . . . , N, respectively. “N” is an integer and larger than one. For example, “N” is 2, 3, 4, 5, 6, 7, 8, 9, 10, 11, 12, 13 14, 15 or 16. In another example, the maximum number of “N” is 4, 8, 16 or 32. Examples and implementations of the LTM configuration 1 can apply to the LTM configuration(s) 2, . . . , N.

In other implementations, the CU 172 and DU 174 performs a single LTM preparation procedure (i.e., the LTM preparation procedure 390) to prepare the cell(s) 1, 2, . . . , N. In such cases, the DU 174 includes the LTM configuration(s) 1, 2, . . . , N for the cell(s) 1, 2, . . . , N, respectively in the first DU-to-CU message. In the first DU-to-CU message, the DU 174 can include the cell ID(s) 1, 2, . . . , N respectively associated with the LTM configuration(s) 1, 2, . . . , N to indicate that the LTM configuration(s) 1, 2, . . . , N are configured for the cell ID(s) 1, 2, . . . , N, respectively. In the case that the CU 172 determines to perform the LTM preparation procedure 390, the CU 172 includes the cell ID(s) 1, 2, . . . , N in the first CU-to-DU message to request the DU 174 to prepare the cell(s) 1, 2, . . . , N, respectively, for LTM.

After receiving the LTM configuration(s) 2, . . . , N from the DU 174, the CU 172 can include the LTM configuration(s) 2, . . . , N in the first container. In some implementations, the CU 172 can include the LTM configuration(s) 2, . . . , Nin element(s) 2, . . . , N, respectively, and includes the element(s) 2, . . . , N in the first container. In some implementations, the CU 172 includes, in the RRC reconfiguration message, LTM ID(s) (i.e., ID(s) 2, . . . , N) for identifying the LTM configuration(s) 2, . . . , N, respectively. In some implementations, the CU 172 includes the ID(s) 2, . . . , N in the first container. For example, the CU 172 can include the ID(s) 2, . . . , N and LTM configuration(s) 2, . . . , N in the element(s) 2, . . . , N in the first addition or modification list.

In some implementations, the CU 172 assigns the ID(s) 2, . . . , N for the LTM configuration(s) 2, . . . , N, respectively. In other implementations, the CU 172 receives the ID(s) 2, . . . , N from the DU 174 in the first DU-to-CU message of the procedure 390. In yet other implementations, the CU 172 receives from the DU 174 the ID(s) 2, . . . , N in the DU-to-CU message(s) 2, . . . , N of the LTM preparation procedure(s) 2, . . . , N, respectively.

In some implementations, the CU 172 can perform a LTM ID assignment procedure with the DU 174 for each of the LTM configuration(s) 2, . . . , N, similar to the procedure 392. In other implementations, the CU 172 can include the ID(s) 2, . . . , N and the LTM configuration(s) 2, . . . , N in the third CU-to-DU message and indicate the association between the ID(s) 2, . . . , N and the LTM configuration(s) 2, . . . , N, respectively. Thus, the DU 174 can associate the LTM configuration(s) 2, . . . , N with the ID(s) 2, . . . , N, respectively. In yet other implementations, the CU 172 can include the cell ID(s) 2, . . . , N and the ID(s) 2, . . . , N in the third CU-to-DU message and indicate the association between the cell ID(s) 2, . . . , N and the ID(s) 2, . . . , N, respectively. Thus, the DU 174 can associate the LTM configuration(s) 2, . . . , N with the ID(s) 2, . . . , N, respectively, based on the association between the cell ID(s) 2, . . . , N and the ID(s) 2, . . . , N and the association between the cell ID(s) 2, . . . , N and the LTM configuration(s) 2, . . . , N, respectively. In other implementations, the CU 172 can include the ID(s) 2, . . . , N, the cell ID(s) 2, . . . , N and/or the LTM configuration(s) 2, . . . , N in the second CU-to-DU message as described above. Thus, the third CU-to-DU message can be omitted. In yet other implementations, the CU 172 can include the ID(s) 2, . . . , N in the first CU-to-DU message and indicate the ID(s) 2, . . . , N is/are respectively associated with the cell ID(s) 2, . . . , N. In one implementation, the DU 174 includes the ID(s) 2, . . . , N in the LTM configuration(s) 2, . . . , N. Thus, the CU 172 does not include the ID(s) 2, . . . , N in the RRC reconfiguration message, first container and/or element(s) 2, . . . , N.

In some alternative implementations, the DU 174 assigns the ID(s) 2, . . . , N. In some implementations, the DU 174 includes the ID(s) 2, . . . , N in the first DU-to-CU message of the procedure 390. In yet other implementations, the DU 174 includes the ID(s) 2, . . . , Nin the DU-to-CU message(s) 2, . . . , N of the LTM preparation procedure(s) 2, . . . , N. The CU 172 can include the ID(s) 2, . . . , N in the RRC reconfiguration message. In other implementations, the DU 174 includes the ID(s) 2, . . . , N in the LTM configuration(s) 2, . . . , N. Thus, the CU 172 does not include an ID (e.g., LTM ID) identifying each of the LTM configuration(s) 2, . . . , N in the RRC reconfiguration message, first container and/or element 1.

In some alternative implementations, the CU 172 can generate a second container including the LTM configuration(s) 2, . . . , N or element(s) 2, . . . , N instead of using the first container. The CU 172 then transmits an additional RRC reconfiguration message including the second container to the UE 102 via the DU 174, similar to the events 316 and 318. In response, the UE 102 transmits an additional RRC reconfiguration complete message to the CU 172 via the DU 174, similar to the events 320 and 322. In some implementations, the second container can be a second addition or modification list (e.g., ltm-ConfigToAddModList field, LTM-ConfigToAddModList IE, Itm-CandidateConfigToAddModList field, or LTM-CandidateConfigToAddModList IE), and each of the element(s) 2, . . . , N can be an addition or modification IE (e.g., Itm-ConfigToAddMod field, LTM-ConfigToAddMod IE, Itm-CandidateConfigToAddMod field, or LTM-CandidateConfigToAddMod IE). When the UE 102 receives the second addition or modification list, the UE 102 can store the second addition or modification list together with the first addition or modification list, e.g., in a variable in its random access memory (RAM).

In some implementations, the DU 174 includes cell ID(s) 2, . . . , N in the LTM configuration(s) 2, . . . , N to identify the cell(s) 2, . . . , N, respectively. In one implementation, each of the cell ID(s) 2, . . . , Nis a PCI. In some further implementations, the LTM configuration(s) 2, . . . , N includes cell index(es) 2, . . . , N indexing the cell ID(s) 2, . . . , Nor the cell(s) 2, . . . , N, respectively. In the case that the CU 172 prepares the cell(s) 2, . . . , N for LTM in the procedure 390, the CU 172 can set the cell index(es) 2, . . . , N to different value(s) and include the cell index(es) 2, . . . , N in the first CU-to CU-to-DU message of the event 308. In the case that the CU 172 prepares the cell(s) 2, . . . , N in the additional LTM preparation procedure(s), the CU 172 can set the cell index(es) 2, . . . , N to different values and include the cell index(es) 2, . . . , N in CU-to-DU message(s) of the additional LTM preparation procedure(s). The CU 172 sets cell index(es) 1, . . . , N to different values. In some implementations, the cell ID(s) 1, . . . , N in the LTM configuration(s) 1, . . . , N are different from the cell ID(s) 1, . . . , N in the CU-to-DU message(s) described above.

In some implementations, each of the LTM configuration(s) 1, . . . , N includes physical configuration parameters, MAC configuration parameters, RLC configuration parameters and/or L1 measurement configuration(s). In some implementations, each of the LTM configuration(s) 1, . . . , N can be a CellGroupConfig IE as defined in 3GPP specification 38.331. In other implementations, each of the LTM configuration(s) 1, . . . , N include configuration parameters included in a CellGroupConfig IE as defined in 3GPP specification 38.331. In some further implementations, the plurality of configuration parameters in each of the LTM configuration(s) include a particular special cell configuration (e.g., SpCellConfig IE) and/or one or more SCell configurations (e.g., SCellConfig IE(s)). In some implementations, the LTM configuration(s) 1, . . . , N are CellGroupConfig IE(s) defined in 3GPP specification 38.331. In other implementations, the LTM configuration(s) 1, . . . , N include configuration parameters in the CellGroupConfig IE.

In some implementations, the CU 172 determines to release the LTM configuration M of the LTM configuration(s) 1, . . . , N (or the element M of the element(s) 1, . . . , M). 1≤M≤N. In response to the determination, the CU 172 transmits a RRC reconfiguration message to the UE 102 via the DU 174 to indicate the UE 102 to release the LTM configuration M or element M. In one implementation, the CU 172 generates a release list including the ID (i.e., LTM ID) M for releasing the LTM configuration M or element M and includes the release list in the RRC reconfiguration message. In response to the RRC reconfiguration message, the UE 102 releases the LTM configuration M or element M and transmits a RRC reconfiguration complete message to the CU 172 via the DU 174. In response to the determination, the CU 172 transmits a CU-to-DU message to the DU 174 to indicate the DU 174 to release the LTM configuration M. To indicate the DU 174 to release the LTM configuration M, the CU 172 can include the cell ID M or the ID (i.e., LTM ID) M in a release indication (e.g., a field or IE) in the CU-to-DU message. In response, the DU 174 releases the LTM configuration M and transmits a DU-to-CU message to the CU 172. In some implementations, the CU-to-DU message and DU-to-CU message are a UE Context Modification Request message and a UE Context Modification Response message, respectively.

In other implementations, the DU 174 determines to release the LTM configuration K. In response to the determination, the DU 174 transmits a DU-to-CU message to the CU 172 to release the LTM configuration K. To indicate the LTM configuration K is released, the DU 174 can include the cell ID K or the ID (i.e., LTM ID) K in a release indication (e.g., a field or IE) in the DU-to-CU message. 1≤K≤N. After (e.g., in response to) receiving the DU-to-CU message, the CU 172 generates a release list including the ID (i.e., LTM ID) K to release the LTM configuration K or element K and transmits a RRC reconfiguration message including the release list to the UE 102 via the DU 174. In response, the UE 102 releases the LTM configuration K or element K and transmits a RRC reconfiguration complete message to the UE 102 via the DU 174. The CU 172 can transmit a CU-to-DU message to the DU 174 in response to the DU-to-CU message. In some implementations, the DU-to-CU message and CU-to-DU message are a UE Context Modification Required message and a UE Context Modification Confirm message, respectively.

After receiving the RRC reconfiguration in the event 318 or transmitting the RRC reconfiguration complete message in the event 320, the UE 102 transmits 324 at least one measurement report to the DU 174, similar to the event 304. In some implementations, the DU 174 may transmit 326 a DU-to-CU message including the at least one measurement report to the CU 172, similar to the event 306. In other implementations, the DU 174 does not transmit the at least one measurement report to the CU 172. In some implementations, the at least one measurement report of the event 324 include L1 measurement report(s) or L3 measurement repot(s), as described for the event 304. In some implementations, the UE 102 transmits 324 the at least one measurement report on PUCCH(s) and/or PUSCH(s) to the DU 174, similar to the event 304. In other implementations, the UE 102 transmits 324 at least one MAC CE including the at least one measurement report to the DU 174, similar to the event 304. In some implementations, the UE 102 does not transmit the L1 measurement report(s) in format of RRC message(s) to the DU 174.

In some implementations, the UE 102 transmits 324 the at least one measurement report to the DU 174 in accordance with at least one measurement configuration. The at least one measurement configuration configures the UE 102 to perform measurements and report measurement results. The CU 172 transmits the at least one measurement configuration to the UE 102 via the DU 174. For example, the CU 172 can transmit one or more RRC messages (e.g., RRCReconfiguration message(s)) including the at least one measurement configuration to the UE 102 via the DU 174 in the event 302 and/or 316 and/or after the event 306 or 316. The one or more RRC messages may or may not include the RRC reconfiguration message of the event 316. In accordance with the at least one measurement configuration, the UE 102 performs measurements on one or more reference signals. The one or more reference signals can include one or more SSBs and/or one or more CSI-RSs. The UE 102 obtains the at least one L1 measurement result and/or at least one L3 measurement result from the measurements and includes the at least one L1 measurement result and/or at least one L3 measurement result in the at least measurement report of the event 324. The DU 174 transmits the one or more reference signals on the cell 124A, the cell 1 and/or the cell(s) 2, . . . , N. The one or more reference signals can be CSI-RS(s) or SSB(s).

In some implementations, the at least one measurement configuration includes L3 measurement configuration(s) (e.g., MeasConfig IE(s)), as described for the event 304. In other implementations, the at least one measurement configuration includes L1 measurement configuration(s), as described for the event 304. For example, the L1 measurement configuration(s) can be CSI-MeasConfig IE(s) defined in 3GPP specification 38.331 v 18.0.0 and/or later versions. The L1 measurement configuration(s) can include measurement report configuration(s). The UE 102 transmits the L1 measurement report(s) on PUCCH(s) or MAC CE(s) to the DU 174 in accordance with the measurement report configuration(s). The DU 174 receives the L1 measurement report(s) on PUCCH(s) or MAC CE(s) in accordance with the measurement report configuration(s). In some implementations, the measurement report configuration(s) are CSI-ReportConfig IE(s). In other implementations, each of the measurement report configuration(s) is an RRC IE dedicated to and specifically defined for LTM. In some implementations, (each of) the measurement report configuration(s) configures periodically reporting and/or event-triggered reporting of the L1 measurement result(s).

In yet other implementations, the at least one measurement configuration includes a “LTM-dedicated-type” measurement configuration(s) specifically defined for and dedicated to LTM (e.g., LTM measurement configuration(s)). The LTM-dedicated-type of a measurement configuration can be defined in a relevant 3GPP specification. In some implementations, the LTM-dedicated-type measurement configuration(s) includes reference signal resource configuration(s) configuring resources where the DU 174 transmits reference signal(s). For example, the reference signal resource configuration(s) include CSI-RS(s) and/or SSB(s). In one implementation, the reference signal resource configuration(s) is/are CSI-ResourceConfig IE(s). In another implementation, the LTM-dedicated-type measurement configuration(s) include measurement report configuration(s), as described above. The UE 102 transmits the measurement report(s) on PUCCH(s) or MAC CE(s) to the DU 174 in accordance with the measurement report configuration(s). The DU 174 receives the measurement report(s) on PUCCH(s) or MAC CE(s) in accordance with the measurement report configuration(s). In such cases, the measurement report(s) can be L1 measurement report(s) or LTM-dedicated-type measurement report(s) (e.g., LTM measurement report(s)). In some implementations, the LTM-dedicated-type measurement configuration includes configuration parameters defined specifically in connection with LTM procedures in a relevant 3GPP specification.

After (e.g., in response to) receiving the at least one measurement report in the event 324, the DU 174 generates a first LTM command to activate the LTM configuration 1 (i.e., the first LTM command commands the UE 102 to apply the LTM configuration 1 or to perform a serving cell change to the cell 1). The DU 174 then transmits 330 the first LTM command to the UE 102. In some implementations, the DU 174 transmits the first LTM command on the cell 124A to the UE 102. In other implementations, the DU 174 transmits the first LTM command on the cell 124D to the UE 102. In some implementations, the DU 174 can include the ID 1 in the first LTM command to indicate the LTM configuration 1, and the UE 102 determines (e.g., identifies) the LTM configuration 1 or element 1 in accordance with the ID 1. In other implementations, the DU 174 can include the cell index 1 indexing the cell ID 1 in the first LTM command. The UE 102 determines (e.g., identifies) the LTM configuration 1 or element 1 based on the cell index 1. After determining the LTM configuration 1 or element 1, the UE 102 then applies the LTM configuration 1, in response to receiving the first LTM command.

In yet other implementations, the DU 174 can include a bit map in the first LTM command to activate the LTM configuration 1, instead of the ID 1 or cell index 1. The number of bits in the bit map is larger than or equal to “N”. In one implementation, bit 1, . . . , N corresponds to the cell index(es) 1, . . . , N, the ID(s) 1, . . . , N, the LTM configuration(s) 1, . . . , N or the element(s) 1, . . . , N, respectively, and the DU 174 sets a corresponding bit (e.g., bit 1) in the bit map to a first value to indicate the cell index 1, the ID 1, the LTM configuration 1 or the element 1. Thus, the UE 102 can determine the cell index 1, the ID 1, LTM configuration 1, or element 1 in accordance with the bit 1 set to the first value in the bit map. In another implementation, bit 0, . . . , N−1 corresponds to the index(es) 1, . . . , N, the ID(s) 1, . . . , N, the LTM configuration(s) 1, . . . , N or the element(s) 1, . . . , N, respectively, and the DU 174 sets a corresponding bit (e.g., bit 0) in the bit map to a first value to indicate the cell index 1, the ID 1, the LTM configuration 1 or the element 1. Thus, the UE 102 can determine the cell index 1, the ID 1, LTM configuration 1 or the element 1 in accordance with the bit 0 set to the first value in the bit map. In such implementations, the DU 174 sets the remaining bits in the bit map to a second value to indicate that the rest of the LTM configuration(s) 1, . . . , N is/are not activated. In some implementations, the first value is one and the second value is zero. In other implementations, the first value is zero and the second value is one. Generally, if the DU 174 determines to activate the LTM configuration L or change a serving cell to the cell L, the DU 174 can set the corresponding bit (e.g., bit L or bit L−1) in the bit map to the first value and set the remaining bits to the second value, where 1≤L≤N. In some implementations, the DU 174 sets at most one bit in the bit map to the first value.

In some implementations, the at least one measurement report (e.g., L1 measurement report(s) or dedicated-type measurement report(s)) of the event 324 includes at least one measurement result for the first cell, TRP(s) of the first cell or reference signal(s) transmitted on the first cell. The reference signal(s) can be CSI-RS(s) or SSB(s). The DU 174 determines to activate the LTM configuration 1 or transmit the first LTM command, based on the at least one measurement result. In some implementations, the DU 174 determines to activate the LTM configuration 1 because, when or if the at least one measurement result is above a second predetermined threshold. In some implementations, the at least one measurement result includes L1-RSRP value(s), L1-RSRQ value(s) and/or L1-SINR value(s). In other implementations, the at least one measurement result includes RSRP value(s), RSRQ value(s) and/or SINR value(s) for the dedicated-type measurement report(s). In some implementations, the second predetermined threshold is different from the first predetermined threshold. In one implementation, the second predetermined threshold is larger than the first predetermined threshold. In this case, the at least one measurement result indicates that the first cell is suitable for communication with the UE 102. In another implementation, the second predetermined threshold is equal to the first predetermined threshold. In this case, the at least one measurement result indicates that the first cell has been continuously above the second predetermined threshold or the first predetermined threshold. This indicates that the first cell is suitable for communication with the UE 102. Thus, the DU 174 determines to activate the LTM configuration 1 in response to that signal strength or quality of the first cell is above the second predetermined threshold for the UE 102.

In some implementations, the at least one measurement report (e.g., L3 measurement report(s)) of the events 324 and 326 includes at least one measurement result for the first cell. The CU 172 determines to activate the LTM configuration 1 or transmit the first LTM command, because the at least one measurement result indicates that signal strength or quality of the first cell is above a second predetermined threshold. The second predetermined threshold is different from the first predetermined threshold. In one implementation, the second predetermined threshold is larger than the first predetermined threshold. In such an implementation, the at least one measurement report of the event 326 indicates that signal strength or quality of the first cell is suitable for communication with the UE 102. In another implementation, the second predetermined threshold is equal to the first predetermined threshold. In such an implementation, the at least one measurement report of the event 326 indicates that signal strength or quality of the first cell has been continuously above the second predetermined threshold or the first predetermined threshold. This also indicates that the first cell is suitable for communication with the UE 102. Thus, the CU 172 determines to activate the LTM configuration 1 in response to that signal strength or quality of the first cell is above the second predetermined threshold. In response to the determination, the CU 172 transmits 328 a fourth CU-to-DU message to the DU 174 to activate the LTM configuration 1 or trigger a serving change to the cell 1 for the UE 102. In some implementations, the CU 172 includes the ID 1 in the fourth CU-to-DU message. In other implementations, the CU 172 includes the cell index 1 in the fourth CU-to-DU message. In response to the fourth CU-to-DU message, the DU 174 transmits 330 the first LTM command to the UE 102 and optionally transmits a fourth DU-to-CU message to the CU 172. In some implementations, the CU 172 includes the cell index 1 in the fourth CU-to-DU message. Thus, the DU 174 can determine to activate the LTM configuration 1 in accordance with the cell index 1. In other implementations, the CU 172 can include the cell ID 1 in the fourth CU-to-DU message. Thus, the DU 174 determines to activate the LTM configuration 1 in accordance with the cell ID 1. In yet other implementations, the CU 172 can include the ID 1 in the fourth CU-to-DU message. Thus, the DU 174 can determine to activate the LTM configuration 1 in accordance with the ID 1. In some implementations, the fourth CU-to-DU message and fourth DU-to-CU message are a UE Context Modification Request message and a UE Context Modification Response message, respectively. In other implementations, the fourth CU-to-DU message and/or fourth DU-to-CU message are dedicated interface messages, e.g., F1 application protocol (F1AP) messages, defined specifically in connection with LTM procedures in a relevant 3GPP specification such as TS 38.473.

When or in response to determining to activate the LTM configuration 1 or transmit the first LTM command, the DU 174 may transmit 329 to the CU 172 a DU-to-CU message indicating LTM (being) executed. In some implementations, the DU 174 includes the cell ID 1 or the ID 1 (i.e., LTM ID) in the DU-to-CU message 329 to indicate that the DU 174 is to activate the LTM configuration 1. The DU can transmit the DU-to-CU message 329 to the CU 172 before or after transmitting the LTM command 330.

In some implementations, the first LTM command is a MAC CE included in a MAC PDU that the UE 102 receives from the DU 174 in the event 330. The MAC CE can be a dedicated MAC CE specifically defined for, and dedicated to, LTM (e.g., in a relevant 3GPP specification such as TS 38.321). In one implementation, the DU 174 includes a subheader identifying the dedicated MAC CE in the MAC PDU and the UE 102 identifies the new MAC CE in the MAC PDU in accordance with the subheader. The subheader can include a logical channel ID or extended logical channel ID defined in a 3GPP specification to identify the dedicated MAC CE. For example, the logical channel ID or extended logical channel ID can be defined specifically for these procedures in a relevant 3GPP specification such as TS 38.321. In other implementations, the first LTM command is a DCI that the UE 102 receives on a PDCCH from the DU 174 in the event 330. The DU 174 generates a CRC for the DCI, scrambles the CRC with a first C-RNTI of the UE 102, and transmits the DCI and scrambled CRC on the PDCCH in the event 330. In one implementation, a format of the DCI can be the DCI format defined in a 3GPP specification (e.g., 38.212) prior to the introduction of LTM features. In another implementation, the format of the DCI is a dedicated DCI format defined specifically for LTM in a relevant 3GPP specification such as TS 38.212.

In some implementations, the DU 174 does not perform security protection (e.g., integrity protection and/or encryption) on the first LTM command. This speeds up processing the first LTM command in the UE 102 because the UE 102 does not perform security check (e.g., decryption and/or integrity check) on the first LTM command.

In some implementations, after receiving the first LTM command, the UE 102 may transmit 331 an acknowledgement to the DU 174 on the cell 124A or cell 124D to indicate that the UE 102 receives the first LTM command. In some implementations, the acknowledgement is a HARQ ACK. In other implementations, the acknowledgement is a MAC CE. For example, the MAC CE is an existing MAC CE defined in 3GPP specification 38.321 v 17.2.0 and/or later versions. In another example, the MAC CE is an LTM-dedicated MAC CE defined specifically for LTM in a relevant 3GPP specification such as TS 38.321. In yet other implementations, the acknowledgement is a PUCCH transmission.

In some implementations, the CU 172 transmits 316 the RRC reconfiguration message in response to the L3 measurement report 306 for the first cell. To configure the UE 102 to transmit the L3 measurement report 306, the CU 172 can transmit a first RRC reconfiguration message including the L3 measurement configuration (e.g., a MeasConfig IE) to the UE 102 before the event 306. In some implementations, the DU 174 transmits 330 the first LTM command in response to the LI measurement report(s) 324 for the first cell. To configure the UE 102 to transmit the L1 or LTM-dedicated-type measurement report(s) 324, the CU 172 can transmit a second RRC reconfiguration message including the L1 or LTM-dedicated-type measurement configuration(s) to the UE 102. In some implementations, the first and second RRC reconfiguration messages can be the same message (i.e., the same instance). In other implementations, the first and second RRC reconfiguration messages are different messages. In some implementations, the second RRC reconfiguration message is the RRC reconfiguration message of the event 316. In other implementations, the second RRC reconfiguration message is different from the RRC reconfiguration message of the event 316.

After (e.g., in response to) receiving the first LTM command, the UE 102 identifies the LTM configuration 1 in accordance with the ID 1 and applies the LTM configuration 1. In some implementations, the UE 102 can perform 332 a random access procedure on the first cell with the DU 174 in response to applying the LTM configuration 1 or receiving the first LTM command. In some implementations, the UE 102 disconnects from the cell 124A after (e.g., in response to) receiving the first LTM command or after transmitting the acknowledgement. In other words, the UE 102 stops communicating on the cell 124A after (e.g., in response to) receiving 330 the first LTM command or transmitting 331 the acknowledgement. In such cases, the UE 102 performs 332 the random access procedure after disconnecting from the cell 124A. The UE 102 can determine whether to perform the random access procedure in accordance with the LTM configuration 1. In one implementation, if the LTM configuration 1 configures the UE 102 to perform a random access procedure, the UE 102 performs the random access procedure in the event 332. For example, the LTM configuration 1 includes a reconfiguration with sync configuration (e.g., ReconfigurationWithSync IE) to configure the UE 102 to perform a random access procedure. Otherwise, if the LTM configuration 1 does not configure the UE 102 to perform a random access procedure or configures the UE 102 to skip a random access procedure, the UE 102 refrains from performing a random access procedure with the DU 174 upon receiving the first LTM command. In such a cases, the UE 102 skips the event 316. For example, if the LTM configuration 1 excludes a reconfiguration with sync configuration, the LTM configuration 1 configures the UE 102 not to perform a random access procedure. In some implementations, the random access procedure is a four-step random access procedure. In other implementations, the random access procedure is a two-step random access procedure. In some implementations, the random access procedure is a contention-free random access procedure. In other implementations, the random access procedure is a contention-based random access procedure.

In the case that the UE 102 performs 332 the random access procedure, the UE 102 communicates 336 with the DU 174 on the first cell using the LTM configuration 1 and/or reference LTM configuration and communicates with the CU 172 via the DU 174, after successfully completing the random access procedure. In such cases, the DU 174 communicates with the UE 102 on the first cell using the LTM configuration 1 in the event 332 and/or event 336. In some scenarios or implementations, the UE 102 communicates UL PDUs, DL PDUs, and/or physical layer signals (e.g., PUCCH transmissions and PDCCH transmissions) with the base station 104 in the event 336. In some implementations, the UE 102 determines that the UE 102 successfully completes the random access procedure when the UE 102 receives a contention resolution from the DU 174. In cases where the random access procedure is a four-step random access procedure, the UE 102 transmits a Message 3 including a UE identity to the DU 174 via the first cell in the random access procedure. In cases where the random access procedure is a two-step random access procedure, the UE 102 transmits a Message A including the UE identity to the DU 174 via the first cell in the random access procedure. In some implementations, if the LTM configuration 1 includes a second C-RNTI, the UE identity is the second C-RNTI of the UE 102. Otherwise, if the LTM configuration 1 does not include a C-RNTI, the UE identity is the first C-RNTI. In cases where the random access procedure is a contention free random access procedure, the UE 102 transmits the dedicated random access preamble to the DU 174 via the first cell. In such cases, the LTM configuration 1 includes the dedicated random access preamble.

The DU 174 identifies or determines that the UE 102 connects to the first cell upon receiving the UE identity or the dedicated preamble from the UE 102 in the random access procedure 332.

In the case that the UE 102 skips the random access procedure, the UE 102 directly communicates 336 with the DU 174 on the first cell in accordance with the LTM configuration 1 and communicates with the CU 172 via the DU 174, after (e.g., in response to) receiving the first LTM command. For example, the UE 102 directly communicates UL PDUs, DL PDUs, and/or physical layer signals (e.g., PUCCH transmissions and PDCCH transmissions) with the base station 104 in the event 336. In some implementations, the DU 174 can include, in the LTM configuration 1, configuration parameters configuring resources for the UE 102 to transmit the at least one PUCCH or PUSCH transmission, and the UE 102 transmits the at least one PUCCH or PUSCH transmission on the resources, using the configuration parameters, to indicate that the UE 102 connects to the first cell. In other implementations, the DU 174 can transmit to the UE 102 at least one DCI on a PDCCH on the first cell to command the UE 102 to transmit the at least one PUCCH or PUSCH transmission, after transmitting the first LTM command. The at least one DCI configures resources for the UE 102 to transmit the at least one PUCCH or PUSCH transmission, and the UE 102 transmits the at least one PUCCH or PUSCH transmission on the resources. The DU 174 identifies or determines that the UE 102 connects to the first cell upon receiving the PUCCH or PUSCH transmission. The DU 174 identifies or determines that the UE 102 connects to the first cell upon receiving the PUCCH or PUSCH transmission on the resources configured in the LTM configuration 1 or the at least one DCI.

In the case that the UE 102 receives the reference LTM configuration as described above, the UE 102 communicates 336 with and the DU 174 on the first cell in accordance with the LTM configuration 1 and at least a portion of the reference LTM configuration. In other words, the UE 102 communicates 336 with the DU 174 in accordance with configuration parameters in the LTM configuration 1 and the reference LTM configuration. Similarly, the DU 174 communicates 336 with the UE 102 on the first cell in accordance with the LTM configuration 1 and at least a portion of the reference LTM configuration. In other words, the DU 174 communicates 336 with the UE 102 in accordance with configuration parameters in the LTM configuration 1 and the reference LTM configuration.

In some implementations, the UE 102 transmits a RRC message (e.g., RRC reconfiguration complete message) to the CU 172 via the DU 174 and the first cell to indicate that the UE 102 applies the LTM configuration 1. In the case that the UE 102 performs the random access procedure 332, the UE 102 can include the RRC message in the Message 3 or Message A. Alternatively, the UE 102 transmits the RRC message after completing the random access procedure. In the case that the UE 102 skip the random access procedure 332, the UE 102 includes the RRC message in a PUSCH transmission of the at least one PUSCH transmission. In some implementations, if the UE 102 maintains communication on the cell 124A with the base station 104 (i.e., the UE 102 does not disconnect from the cell 124A), the UE 102 can transmit the RRC message to the base station 104 via the cell 124A. When the DU 174 receives the RRC message, the DU 174 transmits the RRC message to the CU 172.

In other implementations, the UE 102 refrains from transmitting the RRC message to the base station 104 in response to applying the LTM configuration 1 or receiving the first LTM command. In such cases, the UE 102 can include or transmit data in the Message 3, Message A or PUSCH transmission as described above. The UE 102 can generate a MAC PDU and/or a RLC PDU including the data and transmits or includes the MAC PDU and/or RLC PDU in the PUSCH transmission. For example, the data can be a PDCP PDU, a SDAP PDU, a LTE Positioning Protocol (LPP) PDU, a RRC PDU and/or a NAS PDU. The RRC PDU includes a UL-DCCH-Message excluding a RRC reconfiguration complete message. The NAS PDU includes a Mobility Management (MM) message or a Session Management (SM) message. The MM message can be a 5G MM message or a 6G MM message, and the SM message can be a 5G SM message or a 6G SM message. When the DU 174 receives the data, the DU 174 transmits the data to the CU 172.

When the DU 174 determines that the UE 102 successfully connects to the first cell in the event 332 or 336, the DU 174 can transmit 334 a DU-to-CU message (e.g., Access Success message) to the CU 172 (e.g., a CP of the CU 172). In some implementations, the DU 174 can include the cell ID 1 of the first cell in the DU-to-CU message of the event 334. The cell ID can be a PCI or a CGI. Thus, the CU 172 determines that the UE 102 connects to the first cell upon receiving the DU-to-CU message of the event 334. When the DU 174 determines that the UE 102 successfully connect to the first cell in the event 332 or 336, the DU 174 can transmit a DL Data Delivery Status message or frame to the CU 172 (e.g., a UP of the CU 172).

In some implementations, when determining that the UE 102 connects to the first cell, transmitting 330 the first LTM command, or receiving 331 the acknowledgement, the DU 174 can stop communicating with the UE 102 on the cell 124A and/or release resources of the cell 124A configured for the UE 102.

In some implementations, the DU 174 can generate some or all of the LTM configuration 1 and/or LTM configuration(s) 2, . . . , N as full configuration(s) to replace the serving DU configuration. If the LTM configuration 1 is a full configuration, the UE 102 and DU 174 communicate 336 with each other in accordance with the LTM configuration 1 instead of the serving DU configuration. In some implementations, the DU 174 includes an indication indicating that the LTM configuration 1 is a full configuration in the LTM configuration 1. In each of the LTM configuration(s) 2, . . . , N, the DU 174 can include an indication to indicate that the corresponding DU configuration is a full configuration. Each of the indication(s) in the LTM configuration(s) 1, . . . , N can be a field or IE (i.e., the same field or IE). In other implementations, the CU 172 can include, in the RRC reconfiguration message of the events 316, 318, a single indication indicating that the LTM configuration(s) 1 and/or 2, . . . , N is/are full configuration(s). In the case of the second container, the CU 172 can include, in the additional RRC reconfiguration message, a single indication indicating that the LTM configuration(s) 2, . . . , N is/are full configuration(s). In yet other implementations, the CU 172 can include, in the first container, a single indication indicating that the LTM configuration(s) 1 and/or 2, . . . , N is/are full configuration(s). In yet other implementations, for each of the LTM configuration(s) 2, . . . , N, the CU 172 can include, in the first container, a particular indication indicating the corresponding LTM configuration is a full configuration. In the case of the second container, the CU 172 can include, in the second container, a single indication indicating that the LTM configuration(s) 2, . . . , N is/are full configuration(s). In yet other implementations, the CU 172 can include, in the element 1, includes an indication indicating that the LTM configuration 1 is a full configuration. In each of the element(s) 2, . . . , N, the CU 172 can include an indication indicating that the corresponding LTM configuration is a full configuration. The UE 102 can determine that the LTM configuration 1 and/or LTM configuration(s) 2, . . . , N is/are full configuration(s) based on the indication(s) above. In some implementations, each of the indication(s) above is different from a fullConfig field defined in the current 3GPP specification. In some implementations, each of the indication(s) above is a fullConfig field defined in the current 3GPP specification. In the case that the LTM configuration 1 is a full configuration, the UE 102 in the event 336 does not apply the reference LTM configuration if received from the base station 104, e.g., in the RRC reconfiguration message 318. In such cases, the DU 174 may not include a/the reference LTM configuration in the first DU-to-CU message 310.

In other implementations, the DU 174 can generate the LTM configuration 1 and/or LTM configuration(s) 2, . . . , N as delta configuration(s) that augment (a portion of) the reference LTM configuration. In other words, the DU 174 generates the LTM configuration(s) 1, . . . N based on the reference LTM configuration. For example, if the LTM configuration 1 is a delta configuration, the UE 102 and DU 174 augment (the portion of) the reference LTM configuration with the LTM configuration 1. Thus, the UE 102 and DU 174 communicate 336 with each other in accordance with the LTM configuration 1 and unaugment portion of the reference LTM configuration. In some implementations, the LTM configuration(s) 1, and/or 2 . . . , N, first container, second container or element(s) 1, . . . , N exclude indication(s) indicating that the LTM configuration(s) 1, and/or 2 . . . , N is/are full configuration(s) to indicate that the LTM configuration(s) 1 and/or 2, . . . , N is/are delta configuration(s). The UE 102 can determine that each of the LTM configuration(s) 1 and/or 2, . . . , Nis a delta configuration based on that the indication is excluded in the LTM configuration(s) 1 and/or 2, . . . , N, first container, second container or element(s) 1 and/or 2, . . . , N.

In some implementations, if the UE 102 does not receive a reference LTM configuration for the LTM configuration 1 and/or the LTM configuration(s) 2, . . . , N, the UE 102 determines that the LTM configuration 1, and/or the LTM configuration(s) 2, . . . , N are full configuration(s). Correspondingly, if the DU 174 does not obtain a reference LTM configuration for the UE 102 (i.e., the DU 174 does not generate a reference LTM configuration for the UE 102 and/or receive a reference LTM configuration for the UE 102 from the CU 172), the DU 174 generates the LTM configuration 1, and/or the LTM configuration(s) 2, . . . , N as full configuration(s).

In other implementations, if the UE 102 does not receive a reference LTM configuration for the LTM configuration 1 and/or the LTM configuration(s) 2, . . . , N, the UE 102 determines that the LTM configuration 1, and/or the LTM configuration(s) 2, . . . , N are delta configuration(s) to augment the serving DU configuration. In such cases, the UE 102 communicates 336 with the DU 174 in accordance with the LTM configuration 1 and at least a portion of the serving DU configuration not augmented by LTM configuration 1. Correspondingly, if the DU 174 does not obtain a reference LTM configuration for the UE 102 (i.e., the DU 174 does not generate a reference LTM configuration for the UE 102 and/or receive a reference LTM configuration for the UE 102 from the CU 172), the DU 174 generates the LTM configuration 1, and/or the LTM configuration(s) 2, . . . , N as delta configuration(s) to augment the serving DU configuration. In such cases, the DU 174 communicates 336 with the UE 102 in accordance with the LTM configuration 1 and the at least a portion of the serving DU configuration.

In some implementations, the UE 102 uses a UE MAC entity (e.g., MAC 204B) to communicate with a DU MAC entity (e.g., MAC 204B) of the DU 174 (e.g., the events 302, 304, 318, 320, 324, 330 and/or 331). In some implementations, the UE 102 resets the UE MAC entity, after or in response to receiving the first LTM command and before performing 332 the random access procedure or communicating 336 with the DU 174 via the first cell. In some implementations, the DU 174 resets the DU MAC entity after (e.g., in response to) transmitting the first LTM command, receiving the acknowledgement 331 or determining that the UE 102 connects to the first cell.

In some implementations, when the UE 102 resets the UE MAC entity, the UE 102 performs at least one of the following actions for the UE MAC entity (i.e., UE MAC reset or full UE MAC reset):
initialize Bj for configured logical channel(s) to zero;
stop one or more timers;
consider timeAlignmentTimer(s) as expired, if the UE 102 is configured to perform the random access procedure (e.g., the event 332) in the configuration (e.g., the configuration 1);
set new data indicator(s) (NDI(s)) for UL HARQ process(es) to value 0;
set NDI(s) for HARQ process ID(s) to value 0 for monitoring PDCCH in Sidelink resource allocation mode 1;
flush Msg3 buffer;
flush MSGA buffer;
cancel, if any, triggered Scheduling Request procedure;
cancel, if any, triggered Buffer Status Reporting procedure;
cancel, if any, triggered Power Headroom Reporting procedure;
cancel, if any, triggered consistent LBT failure;
cancel, if any, triggered BFR;
cancel, if any, triggered Sidelink Buffer Status Reporting procedure;
cancel, if any, triggered Pre-emptive Buffer Status Reporting procedure;
cancel, if any, triggered Timing Advance Reporting procedure;
cancel, if any, triggered Recommended bit rate query procedure;
cancel, if any, triggered configured uplink grant confirmation;
cancel, if any, triggered configured sidelink grant confirmation;
cancel, if any, triggered Desired Guard Symbol query;
cancel, if any, triggered Positioning Measurement Gap Activation/Deactivation Request procedure;
flush soft buffers for DL HARQ process(es);
for each of the DL HARQ process(es), consider the next received transmission for a TB as the very first transmission;
release, if any, Temporary C-RNTI;
reset one or more counters (e.g., BFI_COUNTERs and/or LBT_COUNTERs).

In some implementations, when the DU 174 resets the DU MAC entity, the DU 174 performs at least one of the following actions for the DU MAC entity (i.e., DU MAC reset or full DU MAC reset):
stop one or more timers;
consider timeAlignmentTimer(s), that the DU 174 starts and/or maintains for the UE 102, as expired, if the UE 102 is configured to perform the random access procedure (e.g., the event 332) in the configuration (e.g., the configuration 1);
set NDI(s) for DL HARQ process(es) to value 0;
flush soft buffers for UL HARQ process(es);
for each of the UL HARQ process(es), consider the next received transmission for a TB as the very first transmission;
reset one or more counters (e.g., BFI_COUNTERs and/or LBT_COUNTERs)

Depending on implementations, the UE 102 can determine to partially or fully reset the UE MAC entity. In some implementations, when the UE 102 resets the UE MAC entity as described above, the UE 102 fully resets the UE MAC entity (i.e., a full UE MAC reset). In the full UE MAC reset, the UE 102 performs some or all of the actions described above. In other implementations, when the UE 102 resets the UE MAC entity as described above, the UE 102 partially resets the UE MAC entity (i.e., a partial UE MAC reset). In the partial UE MAC reset, the UE 102 performs a subset or portion of the some or all of the actions in the full UE MAC reset.

In some implementations, the partial UE MAC reset includes at least one of the following actions:
consider timeAlignmentTimer(s) of the UE 102 as expired, if the UE 102 is configured to perform the random access procedure (e.g., the event 332) in the configuration (e.g., the configuration 1);
flush Msg3 buffer;
flush MSGA buffer;
release, if any, Temporary C-RNTI;
reset one or more counters (e.g., BFI_COUNTERs and/or LBT_COUNTERs).

In some implementations, the partial UE MAC reset further includes at least one of the following actions:
cancel, if any, triggered Scheduling Request procedure;
cancel, if any, triggered Buffer Status Reporting procedure;
cancel, if any, triggered Power Headroom Reporting procedure;
cancel, if any, triggered consistent LBT failure;
cancel, if any, triggered BFR;
cancel, if any, triggered Sidelink Buffer Status Reporting procedure;
cancel, if any, triggered Pre-emptive Buffer Status Reporting procedure;
cancel, if any, triggered Timing Advance Reporting procedure;
cancel, if any, triggered Recommended bit rate query procedure;
cancel, if any, triggered configured uplink grant confirmation;
cancel, if any, triggered configured sidelink grant confirmation;
cancel, if any, triggered Desired Guard Symbol query;
cancel, if any, triggered Positioning Measurement Gap Activation/Deactivation Request procedure;

In some implementations, the partial UE MAC reset further includes at least one of the following actions:
stop a first portion of the one or more timers and retain the rest of the one or more timers;
set new data indicator(s) (NDI(s)) for UL HARQ process(es) to value 0;
set NDI(s) for HARQ process ID(s) to value 0 for monitoring PDCCH in Sidelink resource allocation mode 1;
flush soft buffers for DL HARQ Process(es);
for each of the DL HARQ process(es), consider the next received transmission for a TB as the very first transmission;

Depending on implementations, the DU 174 can determine to partially or fully reset the DU MAC entity. In some implementations, when the DU 174 resets the DU MAC entity as described above, the DU 174 fully resets the DU MAC entity (i.e., a full DU MAC reset). In the full DU MAC reset, the DU 174 performs some or all of the actions described above. In other implementations, when the DU 174 resets the DU MAC entity as described above, the DU 174 partially resets the DU MAC entity (i.e., a partial DU MAC reset). In the partial DU MAC reset, the DU 174 performs a subset or portion of the some or all of the actions in the full DU MAC reset.

In some implementations, the partial DU MAC reset includes at least one of the following actions in the partial MAC reset:
consider timeAlignmentTimer(s), that the DU 174 starts and/or maintains for the UE 102, as expired, if the UE 102 is configured to perform the random access procedure (e.g., the event 332) in the configuration (e.g., the configuration 1);
reset one or more counters (e.g., BFI_COUNTERs and/or LBT_COUNTERs)

In some implementations, when the partial DU MAC reset includes at least one of the following actions for the MAC entity (i.e., DU MAC reset):
stop a first portion of the one or more timers and retain the rest of the one or more timers;
set NDI(s) for DL HARQ process(es) to value 0;
flush soft buffers for UL HARQ process(es);
for each of the UL HARQ process(es), consider the next received transmission for a TB as the very first transmission;
reset one or more counters (e.g., BFI_COUNTERs and/or LBT_COUNTERs)

In other implementations, the UE 102 refrains from resetting the UE MAC entity in response to receiving the first LTM command. Similarly, the DU 174 refrains from resetting the DU MAC entity after (e.g., in response to) transmitting the first LTM command, receiving the acknowledgement 331 or determining that the UE 102 connects to the first cell. In other words, the UE 102 communicates with the DU 174 on the first cell using the UE MAC entity (not reset). Similarly, the DU 174 communicates with the UE 102 using the DU MAC entity (not reset) on the first cell during or after the random access procedure 332 or after determining that the UE 102 connects to the first cell.

In some implementations, the UE 102 uses at least one UE RLC entity (e.g., RLC 206B) to communicate RLC PDUs with at least one DU RLC entity (e.g., RLC 206B) of the DU 174 (e.g., the events 302, 304, 318, 320, 324, 330 and/or 331). In some implementations, the UE 102 reestablishes some or all of the at least one UE RLC entity, after or in response to receiving the first LTM command and before performing 332 the random access procedure or communicating 336 with the DU 174 via the first cell. In some implementations, the DU 174 reestablishes some or all of the at least one DU RLC entity after (e.g., in response to) transmitting the first LTM command, receiving the acknowledgement 331 or determining that the UE 102 connects to the first cell.

In some implementations, the LTM configuration 1 may or may not include one or more RLC reestablishment indications (e.g., reestablishRLC field(s)) configuring the UE 102 to reestablish some or all of the at least one UE RLC entity. If the LTM configuration 1 includes the a RLC reestablishment indication configuring the UE 102 to reestablish a first UE RLC entity, of the at least one UE RLC entity, that the UE 102 uses to communicate RLC PDU(s) with the DU 174, the UE 102 reestablishes the first UE RLC entity in response to the RLC reestablishment indication and the first LTM command. In some implementations, the UE 102 can reestablish the first UE RLC entity before performing 332 the random access procedure or communicating 336 with the DU 174 via the first cell. In other implementations, the UE 102 can reestablish the first UE RLC entity while or after performing 332 the random access procedure. Otherwise if the LTM configuration 1 does not include the RLC reestablishment indication, the UE 102 refrains from reestablishing the first UE RLC entity in response to the first LTM command.

In some implementations, when the UE 102 reestablishes the first UE RLC entity, the UE 102 performs at least one of the following actions for the first UE RLC entity:
discard RLC SDU(s), RLC SDU segment(s), and RLC PDU(s), if any;
stop and reset timer(s), if running;
reset state variables to initial values.
   In some implementations, the state variables and timer(s) are defined in 3GPP specification 38.322.

Otherwise, if the LTM configuration 1 does not include the RLC reestablishment indication for the first UE RLC entity, the UE 102 refrains from reestablishing the first UE RLC entity upon or when receiving the first LTM command. In other words, the UE 102 refrains from preforming the actions for reestablishing the first UE RLC entity of the UE 102 upon or when receiving the first LTM command. In some implementations, if the LTM configuration 1 or element 1 does not include the RLC reestablishment indication and includes an indication indicating that the configuration 1 is a full configuration, the UE 102 can reestablish the first UE RLC entity of the UE 102 upon or when receiving the first LTM command. Otherwise, if the LTM configuration 1 or element 1 does not include the RLC reestablishment indication and the indication indicating that the configuration 1 is a full configuration, the UE 102 refrains from reestablishing the first UE RLC entity upon or when receiving the first LTM command.

Similarly, the DU 174 reestablishes some or all of at least one DU RLC entity (e.g., NR RLC 206B) that the DU 174 uses to communicate with the at least one UE RLC entity of the UE 102 (e.g., the events 302, 304, 318, 320, 324, 330 and/or 331) in response to the RLC reestablishment indication. In some implementations, the DU 174 reestablishes a first DU RLC entity of the at least one DU RLC entity after transmitting the first LTM command, receiving an acknowledgement for the first LTM command from the UE 102, or determining that the UE 102 connects to the first cell. In some implementations, the acknowledgement is a HARQ ACK. In other implementations, the acknowledgement is a MAC CE. In yet other implementations, the acknowledgement is a PUCCH transmission. In some implementations, when the base station 104 reestablishes the first DU RLC entity, the DU 174 performs at least one of the following actions for the first DU RLC entity:
discard RLC SDU(s), RLC SDU segment(s), and RLC PDU(s), if any;
stop and reset timer(s), if running;
reset state variables to initial values.
   In some implementations, the state variables and timer(s) are defined in 3GPP specification 38.322.

In other implementations, the UE 102 refrains from reestablishing some or all of the at least one UE RLC entity in response to receiving the first LTM command. Similarly, the DU 174 refrains from reestablishing some or more of the at least one DU RLC entity after (e.g., in response to) transmitting the first LTM command, receiving the acknowledgement 331 or determining that the UE 102 connects to the first cell. In other words, the UE 102 communicates with the DU 174 on the first cell using the some or all of the at least one UE RLC entity (not reestablished). For example, the some or all of the at least one UE RLC entity includes the first UE RLC entity and/or a second UE RLC entity. Similarly, the DU 174 communicates with the UE 102 using the some or all of the at least one DU RLC entity (not reestablished) on the first cell during or after the random access procedure 332 or after determining that the UE 102 connects to the first cell. For example, the some or all of the at least one DU RLC entity includes the first DU RLC entity and/or a second DU RLC entity.

In some implementations, the UE 102 uses at least one UE PDCP entity (e.g., PDCP 210) to communicate UL PDCP PDUs and/or DL PDCP PDUs with at least one CU PDCP entity (e.g., PDCP 210) of the CU 172 in the event 302. In some implementations, the UE 102 performs a PDCP recovery procedure for some or all of the at least one UE PDCP entity, after or in response to receiving the first LTM command. For example, the UE 102 performs a PDCP recovery procedure for a first UE PDCP entity of the at least one UE PDCP entity, after or in response to receiving the first LTM command. In the PDCP recovery procedure, the UE 102 may or may not reestablish the first UE PDCP entity. After or in response to performing the PDCP recovery procedure, the UE 102 can retransmit at least a portion of the UL PDCP PDUs to the CU 172 via the DU 174 and the first cell in the event 336. Similarly, the CU 172 performs a PDCP recovery procedure for some or all of the at least one CU PDCP entity after or in response to transmitting the first LTM command. For example, the CU 172 performs a PDCP recovery procedure for a first CU PDCP entity of the at least one CU PDCP entity, after or in response to transmitting the first LTM command. In some implementations, the CU 172 performs the PDCP recovery procedure for the first CU PDCP entity in response to receiving the DU-to-CU message 329 or 334. In other implementations, the CU 172 performs the PDCP recovery procedure for the first CU PDCP entity in response to receiving the DL Data Delivery Status message. In the PDCP recovery procedure, the CU 172 may or may not reestablish the first CU PDCP entity. After or in response to performing the PDCP recovery procedure, the CU 172 can retransmit at least a portion of the DL PDCP PDUs to the UE 102 via the DU 174 and the first cell in the event 336.

In other implementations, the UE 102 refrains from reestablishing some or all of the at least one UE PDCP entity in response to receiving the first LTM command. For example, the some or all of the at least one UE PDCP entity includes the first UE PDCP entity and/or a second UE PDCP entity. Similarly, the CU 172 refrains from reestablishing some or more of the at least one CU PDCP entity, after (e.g., in response to) receiving the DU-to-CU message 329 or 340 or after (e.g., in response to) receiving the DL Data Delivery Status message. In other words, the UE 102 communicates with the CU 172 via the DU 174 and the first cell using the some or all of the at least one UE PDCP entity (not reestablished). For example, the some or all of the at least one UE PDCP entity includes the first UE PDCP entity and/or a second UE PDCP entity. Similarly, the CU 172 communicates with the UE 102 using the some or all of the at least one CU PDCP entity (not reestablished) via the DU 174 and the first cell. For example, the some or all of the at least one CU PDCP entity includes the first CU PDCP entity and/or a second CU PDCP entity.

In some implementations, after determining that the UE 102 connects to the first cell, the CU 172 can transmit 338 a CU-to-DU message (e.g., a UE Context Modification Request message) to the DU 174 to indicate the DU 174 to stop communicating with the UE 102 and/or to release or suspend resources, of the cell 124A, configured for the UE 102. In response, the DU 174 can stop communicating on the cell 124A with the UE 102 and/or release or suspend resources, of the cell 124A, configured for the UE 102, and transmit 340 a DU-to-CU message (e.g., a UE Context Modification Response message) to the CU-172. The events 338 (optional) and 340 (optional) are collectively referred to in FIG. 3 as a resource release procedure 396.

After or while communicating with the DU 174 on the first cell, events 344, 346, 348, 350, 351, 352, 354 and/or 356 can occur, similar to the events 324, 326, 328, 330, 331, 332, 334 and/or 336, respectively. The UE 102 transmits 344 at least one measurement report to the DU 174. The at least one measurement report includes at least one measurement result for a second cell (i.e., the cell 2). The at least one measurement result indicates that the second cell is suitable for communication with UE 102 and/or the first cell is not suitable for communication with the UE 102. After (e.g., in response to) receiving the at least one measurement report, the DU 174 determines to activate the LTM configuration 2 and generates a second LTM command to activate the LTM configuration 2 (i.e., the second LTM command commands the UE 102 to apply the LTM configuration 2). The DU 174 then transmits 350 the second LTM command to the UE on the first cell to the UE 102.

When or in response to determining to activate the LTM configuration 2 or transmit the second LTM command, the DU 174 can transmit 349 to the CU 172 a DU-to-CU message indicating LTM (being) executed. In some implementations, the DU 174 includes the cell ID 2 or the ID 2 (i.e., LTM ID) in the DU-to-CU message 349 to indicate that the DU 174 is to activate the LTM configuration 2. The DU can transmit the DU-to-CU message 349 to the CU 172 before or after transmitting the LTM command 350.

The descriptions for the events 324, 326, 328, 330, 331, 332, 334 and/or 336 can be applied to the events 344, 346, 348, 350, 351, 352, 354 and/or 356 with simple changes. For example, “cell 124A”, “first LTM command”, “first cell”, “ID 1”, and/or “LTM configuration 1” are replaced with “first cell”, “second LTM command”, “second cell”, “ID 2”, and/or “LTM configuration 2”, respectively.

The events 344, 346, 348, 350, 351, 352, 354 are collectively referred to in FIG. 3 as a LTM execution procedure 398. The events 304, 306, 390, 392, 394, 324, 326, 328, 329, 330, 331, 332, 334, 336, 396, 398, 356 are collectively referred to in FIG. 3 as a LTM configuration and/or activation procedure 380.

Referring next to FIG. 4, in a scenario 400, the base station 104 includes a CU 172, a source DU (S-DU) 174A and a target DU (T-DU) 174B. The S-DU 174A operates the cell 124A and optionally additional cell(s), while the T-DU 174B operates a first cell (e.g., cell 124C). The scenario 400 is similar to the scenario 300. Thus, the descriptions for the scenario 300 can generally apply to the scenario 400. The differences between the scenarios 300 and 400 are described below.

Initially, the UE 102 communicates 402 with the S-DU 174A on cell 124A using a serving DU configuration and communicates with the CU 172 via the S-DU 174A. During the communication 402, the UE 102 transmits 404, 406 at least one measurement report (e.g., L3 measurement report(s)) to the CU 172 via the S-DU 174A. Based on the at least one measurement report, the CU 172 determines to prepare cell(s) 1, . . . , N (operated by the T-DU 174B) for LTM for the UE 102, where N is a positive integer larger than 0 or 1. The cell(s) 1, . . . , N are identified by cell ID(s) 1, . . . , N, respectively. In response to the determination, the CU 172 performs 490 a LTM preparation procedure with the T-DU 174B to (request the T-DU 174B to) prepare cell(s) 1, . . . , N for LTM for the UE 102. N can be a positive integer larger than zero or 1. In the LTM preparation procedure 490, the CU 172 transmits a CU-to-DU message including the cell ID(s) 1, . . . , N to the T-DU 174B to request the T-DU 174B to prepare the cell(s) 1, . . . , N for LTM for the UE 102, similar to the event 308. In response, the T-DU 174B transmits a DU-to-DU message including the LTM configuration(s) 1, . . . , N to the CU 172, similar to the event 310. The LTM configuration(s) 1, . . . , N configures the cell(s) 1, . . . , N for LTM, respectively. In details, the LTM configuration(s) 1, . . . , N include configuration parameters for communication on the cell(s) 1, . . . , N, respectively. In some implementations, the CU-to-DU message and DU-to-CU message in the procedure 490 are UE Context Setup Request message and UE Context Setup Response message, respectively. The CU 172 then transmits the LTM configuration(s) 1, . . . , N in a RRC reconfiguration message in a LTM configuration delivery procedure 494, similar to the LTM configuration delivery procedure 394. In some implementations, the T-DU 174B can include cell index(es) 1, . . . , N in the LTM configuration(s) 1, . . . , N, respectively. In some implementations, the CU 172 can set the cell index(es) 1, . . . , N to different values and include the cell index(es) 1, . . . , N in the CU-to-DU message of the procedure 490.

After performing the LTM preparation procedure 490, the CU 172 can perform an additional LTM preparation procedure(s) with the T-DU 174B to prepare cell(s) N+1, . . . , N+M for LTM for the UE 102. M is a positive integer larger than zero. The CU 172 can determine to do so based on one or more measurement reports received from the UE 102 via the S-DU 174A, similar to the events 404, 406. In the additional LTM preparation procedure, the CU 172 transmits a CU-to-DU message including cell ID(s) N+1, . . . , N+M to the T-DU 174B to request the T-DU 174B to prepare the cell(s) N+1, . . . , N+M for LTM for the UE 102. The cell ID(s) N+1, . . . , N+M identifies the cell ID(s) N+1, . . . , N+M, respectively. In response to the CU-to-DU message, the T-DU 174B transmits a DU-to-DU message including the LTM configuration(s) N+1, . . . , N+M to the CU 172. The LTM configuration(s) N+1, . . . , N+M configures the cell(s) N+1, . . . , N+M for LTM, respectively. In details, the LTM configuration(s) N+1, . . . , N+M include configuration parameters for communication on the cell(s) N+1, . . . , N+M, respectively. The CU 172 then transmits the LTM configuration(s) N+1, . . . , N+M in a RRC reconfiguration message in an additional LTM configuration delivery procedure, similar to the LTM configuration delivery procedure 394 or 494.

In some implementations, the LTM preparation procedure 490 is a UE Context Setup procedure and the additional LTM preparation procedure is a UE Context Modification procedure.

In some implementations, the CU 172 and S-DU 174A can perform the procedure 380 with the UE 102, as described for FIG. 3. In the procedure 380, the CU 172 and S-DU 174A performs the procedure(s) 390 and/or 392 to prepare cell(s) of the S-DU 174A for LTM for the UE 102. Note, the value N in the procedure 380 or described for FIG. 3 can be the same as or different from the value N described for FIG. 4. In the procedure 390, the CU 172 can receive the first DU-to-CU message including the reference LTM configuration from the S-DU 174A in the event 310. In other implementations, the CU 172 and S-DU 174A does not perform the procedure 380 with the UE 102. In such cases, the CU 172 can perform 488 a reference LTM configuration query procedure with the S-DU 174A to obtain a reference LTM configuration. In the procedure 488, the CU 172 transmits 460 a CU-to-DU message to the S-DU 174A to request or query a reference LTM configuration. In some implementations, the CU 172 can include an indication in the CU-to-DU message to request or query a reference LTM configuration. In response to the indication or CU-to-DU message 460, the S-DU 174A transmits 462 a DU-to-CU message including a reference LTM configuration to the CU 172. In some implementations, the indication is a reference LTM configuration query indication. In other implementations, the indication is a LTM indication, and the CU 172 can include a query indication (e.g., GNB-DU Configuration Query IE) in the CU-to-DU message. After receiving the reference LTM configuration (i.e., either in the procedure 390 or in the procedure 488), the CU 172 includes the reference LTM configuration (received from the S-DU 174A) in the CU-to-DU message in the LTM preparation procedure 490. The T-DU 174B generates the LTM configuration(s) 1, . . . , N based on the reference LTM configuration received from the CU 172. In such cases, the T-DU 174B does not include a reference LTM configuration in the DU-to-CU message in the procedure 490. In the case of the additional LTM preparation procedure, the T-DU 174B does not include a reference LTM configuration in the DU-to-CU message in the additional LTM preparation procedure. The CU 172 may not include the reference LTM configuration in CU-to-DU message in the additional LTM preparation procedure with the T-DU 174B. In the case of the additional LTM preparation procedure, the T-DU 174B generates the LTM configuration(s) N+1, . . . , N+M based on the reference LTM configuration received from the CU 172.

In some implementations, the CU 172 does not provide a reference LTM configuration to the T-DU 174B in the LTM preparation procedure 490. In such cases, the T-DU 174B generates a reference LTM configuration and generates the LTM configuration(s) 1, . . . , N based on the reference LTM configuration. In such cases, the T-DU 174B includes the reference LTM configuration in the DU-to-CU message in the procedure 490. The CU 172 transmits the reference LTM configuration in the RRC reconfiguration message in the procedure 490. In the case of the additional LTM preparation procedure, the T-DU 174B generates the LTM configuration(s) N+1, . . . , N+M based on the reference LTM configuration. In this case, the T-DU 174B may not include the reference LTM configuration in the DU-to-CU message in the additional LTM preparation procedure. In some implementations, the reference LTM configuration generated by the T-DU 174B is different from the reference LTM configuration generated by the S-DU 174A. In other implementations, the reference LTM configuration generated by the T-DU 174B is the same as the reference LTM configuration generated by the S-DU 174A.

In some implementations, the CU 172 assigns ID(s) 1, . . . , N identifying the LTM configuration(s) 1, . . . , N (received from the T-DU 174B), respectively, and performs the procedure 492 with the T-DU 174B to provide the ID(s) 1, . . . , N and/or cell ID(s) 1, . . . , N to the T-DU 174B, similar to the procedure 392. Thus, the T-DU 174B associates the ID(s) 1, . . . , N with the LTM configuration(s) 1, . . . , N and/or the cell ID(s) 1, . . . , N, respectively. In other implementations, the T-DU 174B assigns ID(s) 1, . . . , N identifying the LTM configuration(s) 1, . . . , N (generated by the T-DU 174B), respectively and includes the ID(s) 1, . . . , N in the DU-to-CU message of the procedure 490, similar to the event 310. In some implementations, the CU 172 assigns ID(s) N+1, . . . , N+M identifying the LTM configuration(s) N+1, . . . , N+M, respectively, and performs a procedure (similar to the procedure 492) with the T-DU 174B to provide the ID(s) N+1, . . . , N+M and/or cell ID(s) N+1, . . . , N+M to the T-DU 174B, similar to the procedure 392. Thus, the T-DU 174B associates the ID(s) N+1, . . . , N+M with the LTM configuration(s) N+1, . . . , N+M and/or the cell ID(s) N+1, . . . , N+M, respectively. In other implementations, the T-DU 174B assigns ID(s) N+1, . . . , N+M identifying the LTM configuration(s) N+1, . . . , N+M, respectively and includes the ID(s) 1, . . . , N in the DU-to-CU message of the additional LTM preparation procedure, similar to the event 310.

In some implementations, the CU 172 transmits 412 a CU-to-DU message including the ID(s) 1, . . . , N to the S-DU 174A and receives 414 a DU-to-CU message from the S-DU 174A in response. The CU-to-DU message 412 and DU-to-CU message 414 are collectively referred to in FIG. 4 as a LTM ID transfer procedure 493 or a LTM cell index transfer procedure 493. In some implementations, the message 412 and message 414 can be UE Context Modification Request message and UE Context Modification Response message, respectively. In some implementations, the CU 172 includes the LTM configuration(s) 1, . . . , N and/or cell ID(s) 1, . . . , N in the CU-to-DU message 412. In one implementation, the CU 172 includes the ID(s) 1, . . . , N in the CU-to-DU message 412. In another implementation, the CU 172 includes the cell index(es) 1, . . . , N in the CU-to-DU message 412. In some alternative implementations, the CU 172 can perform multiple LTM ID transfer procedures to transmit the ID(s) 1, . . . , N, cell ID(s) 1, . . . , N and/or LTM configuration(s) 1, . . . , N to the S-DU 174A. In each of the procedures, the CU 172 includes particular portion of the ID(s) 1, . . . , N, cell ID(s) 1, . . . , N and/or LTM configuration(s) 1, . . . , N in a CU-to-DU message similar to the message 412. Thus, the S-DU 174A associates the ID(s) 1, . . . , N with the LTM configuration(s) 1, . . . , N and/or the cell ID(s) 1, . . . , N, respectively. In other alternative implementations, the CU 172 can perform multiple LTM cell index transfer procedures to transmit the cell index(es) 1, . . . , N, cell ID(s) 1, . . . , N and/or LTM configuration(s) 1, . . . , N to the S-DU 174A. In each of the procedures, the CU 172 includes particular portion of the cell index(es) 1, . . . , N, cell ID(s) 1, . . . , N and/or LTM configuration(s) 1, . . . , Nin a CU-to-DU message similar to the message 412. Thus, the S-DU 174A associates the cell index(es) 1, . . . , N with the LTM configuration(s) 1, . . . , N and/or the cell ID(s) 1, . . . , N, respectively.

In some implementations, the CU 172 transmits a CU-to-DU message including the ID(s) N+1, . . . , N+M to the S-DU 174A and receives a DU-to-CU message from the S-DU 174A in response, similar to the CU-to-DU message 412 and the DU-to-CU message 414, respectively. In some implementations, the CU 172 includes the LTM configuration(s) N+1, . . . , N+M and/or cell ID(s) N+1, . . . , N+M in the CU-to-DU message. In some alternative implementations, the CU 172 can perform multiple LTM ID transfer procedures to transmit the ID(s) N+1, . . . , N+M, cell ID(s) N+1, . . . , N+M and/or LTM configuration(s) N+1, . . . , N+M to the S-DU 174A. In each of the procedures, the CU 172 includes particular portion of the ID(s) N+1, . . . , N+M, cell ID(s) N+1, . . . , N+M and/or LTM configuration(s) 1, . . . , N in a CU-to-DU message similar to the message 412. Thus, the S-DU 174A associates the ID(s) N+1, . . . , N+M with the LTM configuration(s) N+1, . . . , N+M and/or the cell ID(s) N+1, . . . , N+M, respectively.

In some implementations, in the case that the CU 172 and S-DU 174A perform the procedure 380 with the UE 102, value(s) of the ID(s) 1, . . . , N of the procedure 380 are different from value(s) of the ID(s) 1, . . . , N, and the ID(s) N+1, . . . , N+M described for the scenario 400. In some implementations, in the case that the CU 172 and S-DU 174A perform the procedure 380 with the UE 102, value(s) of the cell ID(s) 1, . . . , N of the procedure 380 are different from value(s) of the cell ID(s) 1, . . . , N, and the cell ID(s) N+1, . . . , N+M described for the scenario 400. In some implementations, in the case that the CU 172 and S-DU 174A perform the procedure 380 with the UE 102, value(s) of the cell index(es) 1, . . . , N of the procedure 380 are different from value(s) of the cell index(es) 1, . . . , N, and the cell index(es) N+1, . . . , N+M described for the scenario 400.

At a later time, the UE 102 can transmit 424 at least one measurement report to the S-DU 174A, similar to the event 324. The at least one measurement report (e.g., L1 measurement report(s)) includes an event ID, first measurement result(s) for the cell 1 of the T-DU 174B, and/or includes second measurement result(s) for the cell 124A. In some implementations, the first measurement result(s) can be or include RSRP, RSRQ and/or SINR that the UE 102 obtains from reference signal(s) transmitted on the cell 1. Likewise, the second measurement result(s) can be or include RSRP, RSRQ and/or SINR that the UE 102 obtains from reference signal(s) transmitted on the cell 124A. In some implementations, the event ID, RSRP, RSRQ and/or SINR are L1-event ID, L1-RSRP, L1-RSRQ and/or L1-SINR, respectively. Based on the first measurement result(s) and/or second measurement result(s), the S-DU 174A can transmit 430 a first LTM command (i.e., LTM command 1) to the UE 102 to order the UE 102 to perform a serving cell change to the cell 1 of the T-DU 174B . . . In some implementations, the first LTM command includes the ID 1. In other implementations, the first LTM command includes the cell index 1. When the UE 102 receives the first LTM command, the UE 102 performs a serving cell change to the cell 1 from a serving cell in accordance with the LTM configuration 1. If a serving cell change occurs in the procedure 380, the serving cell can be the cell 1 or cell 2 of the S-DU 174A. Otherwise, if no serving cell change occurs in the procedure 380 or the procedure 380 is not performed, the serving cell is the cell 124A. If the first LTM command includes the ID 1, the UE 102 identifies the LTM configuration 1 and/or cell ID 1 (i.e., the cell 1), based the ID 1, as described for FIG. 3. If the first LTM command includes the cell index 1, the UE 102 identifies the LTM configuration 1, cell ID 1 (i.e., the cell 1) and/or LTM ID 1, based the cell index 1, as described for FIG. 3. The UE 102 applies the LTM configuration 1 to communicate with the T-DU 174B, after (e.g., in response to) receiving the first LTM command or successfully accessing the cell 1.

After (e.g., in response to) receiving the first LTM command, the UE 102 may perform 432 a random access procedure with the T-DU 174B, similar to the event 332. After (e.g., in response to) receiving the first LTM command or completing the random access procedure 432, the UE 102 communicates 436 with the T-DU 174B on the first cell using the LTM configuration 1 and/or reference LTM configuration and communicates with the CU 172 via the T-DU 174B, similar to the event 336.

The resource release procedure 496 can be similar to the procedure 396. Alternatively, in the resource release procedure 496, the CU 172 can transmit a CU-to-DU message (e.g., a UE Context Release Command message) to the S-DU 174A to release a UE context of the UE 102. In response, the S-DU 174A releases a UE context of the UE 102 and transmits 440 a DU-to-CU message (e.g., a UE Context Release Complete message) to the CU-172.

The events 380, 404, 406, 490, 492, 494, 494, 424, 426, 428, 429, 430, 431, 432, 434, 436, 496, 498, 456 are collectively referred to in FIG. 4 as a LTM configuration and/or activation procedure 480.

Referring next to FIG. 5A, in a scenario 500A, the base station 106 operates as an MN, and the base station 104 operates as an SN. The SN 104 includes a CU 172 and a DU 174. The scenario 500A is similar to the scenario 300, except that the scenario 500A is a DC scenario and the scenario 300 is a single connectivity (SC) scenario. The MN 106 can include a CU and a DU similar to the base station 104 of FIG. 3.

Initially, the UE 102 in DC communicates with the MN 106 and with SN 104. In the event 502, the UE 102 communicates with the DU 174 on cell 124A using a serving DU configuration and communicates with the CU 172 via the DU 174 using a serving CU configuration, similar to the event 302. In some alternative implementations, the UE 102 does not communicate with the CU 172 via the DU 174 in the event 302. In some implementations, the UE 102 in DC can communicate 502 UL PDUs and/or DL PDUs with the MN 106 and/or SN 104 via radio bearers which can include SRBs and/or DRB(s). The MN 106 and/or the SN 104 can configure the radio bearers to the UE 102. The UE 102 in DC communicates 502 UL PDUs and/or DL PDUs with the SN 104 on an SCG (i.e., SCG radio resources) that the SN 104 configures for communication with the UE 102. The UE 102 in DC communicates UL PDUs and/or DL PDUs with the MN 106 on an MCG (i.e., MCG radio resources) in accordance with a MN configuration (i.e., MCG configuration). In some implementations, the serving DU configuration is a SN configuration (i.e., SCG configuration). In the MN configuration, the MN 106 configures the MCG which includes at least one serving cell (e.g., the cell 126 and/or other cell(s)) operated by the MN 106. In the serving DU configuration, the SN 106A configures the SCG which includes at least one serving cell (e.g., the cell 124A and/or other cell(s)) operated by the SN 104. In some implementations, the MN configuration includes multiple configuration parameters and the UE 102 receives the configuration parameters in one or more RRC messages from the MN 106. As described for FIG. 3, the serving DU configuration includes multiple configuration parameters. In some implementations, the UE 102 receives these configuration parameters in one or more RRC messages from the SN 104, e.g., via the MN 106 and/or on an SRB (e.g., SRB3) that the MN 106 or SN 104 configures to exchange RRC messages between the UE 102 and the SN 104.

While the UE 102 communicates in DC with the MN 106 and SN 104, the MN 106 can perform 580 a LTM configuration and/or activation procedure with the UE 102, similar to the procedures 380 and/or 480. In some implementations, while communicating in DC with the MN 106 and SN 104, the UE 102 can transmit the at least one measurement report to the CU 172 via the DU 174 and cell 124A in the events 504 and 506, similar to the events 304 and 306, respectively. In other implementations, while communicating in DC with the MN 106 and SN 104, the UE 102 can transmit 505 at least one measurement report to the MN 106 via the cell 126. The MN 106 in turn transmits 507 the at least one measurement report to the CU 172. In some implementations, the MN 106 generates at least one SN message including the at least one measurement report and transmits the at least one SN message to the CU 172 in the event 507. In one implementation, the at least one SN message include RRC Transfer message(s) and/or SN Modification Request message(s).

After (e.g., in response to) receiving the at least one measurement report or while the SN 104 communicates with the UE 102, the SN 104 determines to prepare the first cell for the UE 102, as described for FIG. 3. The events 590, 592, 594, 524, 526, 528, 529, 530, 531, 532, 534, 536, 596, 598, and 556 are similar to the events 390, 392, 394, 324, 326, 328, 329, 330, 331, 332, 334, 336, 396, 398, and 356, respectively. After receiving the first LTM command 530, transmitting the acknowledgement 531, or determining that the UE 102 successfully connects to the first cell 532 or 536, the UE 102 operating in DC with the MN 106 and SN 104 communicates 536 with the DU 174 on the first cell in accordance with the LTM configuration 1 and communicates 536 with the CU 172 via the DU 174, similar to the event 336. At a later time, the DU 174 and/or CU 172 can perform the LTM execution procedure 598 with the UE 102 to command the UE 102 to perform a cell change from the first cell to the second cell, similar to the procedure 398 or 498. As a result of the procedure 598, the UE 102 operating in DC with the MN 106 and SN 104 communicates 556 with the DU 174 on the second cell in accordance with the LTM configuration 2 and communicates 556 with the CU 172 via the DU 174, similar to the event 356.

The events 504, 506, 505, 507, 590, 592, 594, 594, 524, 526, 528, 529, 530, 531, 532, 534, 536, 596, 598, 556 are collectively referred to in FIG. 5A as a LTM configuration and/or activation procedure 581.

Referring next to FIG. 5B, a scenario 500B is generally similar to the scenario 500A, except that the SN 104 transmits 517, 519 the RRC reconfiguration message to the UE 102 via the MN 106 and receives 521, 523 the RRC reconfiguration complete message from the UE 102 via the MN 106. The RRC reconfiguration message 517, 519 is similar to the RRC reconfiguration message 316, 318. The RRC reconfiguration complete message 521, 523 is similar to the RRC reconfiguration message 320, 322. In some implementations, the SN 104 generates a first SN message (e.g., SN Modification Required message, SN Modification Required message, or RRC Transfer message) including the RRC reconfiguration message and transmits the first SN message to the MN 106 in the event 517. The MN 106 generates a MN RRC message including the RRC reconfiguration message and transmits 519 the MN RRC message to the UE 102. In response, the UE 102 generates a MN RRC response message including the RRC reconfiguration complete message and transmits 521 the MN RRC response message to the MN 106. In some implementations, the MN 106 generates a second SN message (e.g., SN Reconfiguration Complete message or RRC Transfer message) including the RRC reconfiguration complete message and transmits the second SN message to the SN 104 in the event 523. In some implementations, the MN RRC message and MN RRC response message can be a RRC reconfiguration message and a RRC reconfiguration complete message, respectively.

The events 504, 506, 505, 507, 590, 592, 594, 517, 519, 521, 523, 524, 526, 528, 529, 530, 531, 532, 534, 536, 596, 598, 556 are collectively referred to in FIG. 5B as a LTM configuration and/or activation procedure 582.

Referring next to FIG. 6A, in a scenario 600A, the base station 106 operates as an MN, and the base station 104 operates as an SN, similar to the scenarios 300-500B. The SN 104 includes a CU 172, an S-DU 174A and a T-DU 174B, similar to the base station 104 in the scenario 400. While the UE 102 communicates in DC with the MN 106 and SN 104, the MN 106 can perform 680 a LTM configuration and/or activation procedure with the UE 102, similar to the procedures 380 and/or 480. While the UE 102 communicates in DC with the M-DU 174A and S-DU 174B, the CU 172 can perform 681 a LTM configuration and/or activation procedure with the UE 102 via the M-DU 174A or S-DU 174B, similar to the procedure 581 or 582.

Referring next to FIG. 6B, a scenario 600B similar to the scenarios 300-500B and 600A, except that that the SN 104 transmits 617, 619 the RRC reconfiguration message to the UE 102 via the MN 106 and receives 621, 623 the RRC reconfiguration complete message from the UE 102 via the MN 106.

Referring next to FIG. 7A, in a scenario 700A, the base station 104 operates as an MN and an SN, similar to the scenarios 300-600B. The base station 104 includes a CU 172, a master DU (M-DU) 174A and a secondary DU (S-DU) 174B. The CU 172 operates with the M-DU 174A as a MN, similar to the base station 104 in the FIG. 3 or the MN 106 in FIGS. 5A-6B, and the CU 172 operates with the S-DU 174B as a SN, similar to the SN 104 in FIGS. 5A-6B.

In the scenario 700A, the UE 102 initially communicates 702 in DC with the M-DU 174A and S-DU 174B and communicates 702 with the CU 172 via the M-DU 174A and S-DU 174B. In the event 702, the UE 102 communicates with the S-DU 174B on cell 124A using a serving DU configuration and communicates with the CU 172 via the S-DU 174B using a serving CU configuration, similar to the event 302. Events 704 and 706 are similar to the events 304 and 306. In some implementations, the UE 102 can transmit 705 at least one measurement report to the M-DU 174A, similar to the event 304. The M-DU 174A in turn transmits 707 at least one DU-to-CU message including the at les tone measurement report to the CU 172, similar to the event 306. While the UE 102 communicates in DC with the M-DU 174A and S-DU 174B, the CU 172 can perform 780 a LTM configuration and/or activation procedure with the UE 102 via the M-DU 174A, similar to the procedure 380.

The events 704, 706, 705, 707, 790, 792, 794, 724, 726, 728, 729, 730, 731, 732, 734, 736, 796, 798, 756 are collectively referred to in FIG. 7A as a LTM configuration and/or activation procedure 781.

Referring next to FIG. 7B, a scenario 700B similar to the scenarios 300-600B and 700A, except that that the CU 172 transmits 717, 719 the RRC reconfiguration message to the UE 102 via the M-DU 174A and receives 721, 723 the RRC reconfiguration complete message from the UE 102 via the M-DU 174A.

The events 704, 706, 705, 707, 790, 792, 794, 717, 719, 721, 723, 724, 726, 728, 729, 730, 731, 732, 734, 736, 796, 798, 756 are collectively referred to in FIG. 7B as a LTM DU configuration and/or activation procedure 782.

Referring next to FIG. 8A, in a scenario 800A, the base station 104 operates as an MN and an SN, similar to the scenarios 300-700B. The base station 104 includes a CU 172, a master DU (M-DU) 174A, a secondary DU (S-DU) 174B and a target secondary DU (T-DU) 174C. The CU 172 operates with the M-DU 174A as a MN and operates with the S-DU 174B as a SN. While the UE 102 communicates in DC with the M-DU 174A and S-DU 174B, the CU 172 can perform 880 a LTM configuration and/or activation procedure with the UE 102 via the M-DU 174A, similar to the procedure 380. While the UE 102 communicates in DC with the M-DU 174A and S-DU 174B, the CU 172 can perform 881 a LTM configuration and/or activation procedure with the UE 102 via the S-DU 174A, similar to the procedure 581 or 582.

Referring next to FIG. 8B, a scenario 800B similar to the scenarios 300-700B and 800A, except that that the CU 172 transmits 817, 819 the RRC reconfiguration message to the UE 102 via the M-DU 174A and receives 821, 823 the RRC reconfiguration complete message from the UE 102 via the M-DU 174A.

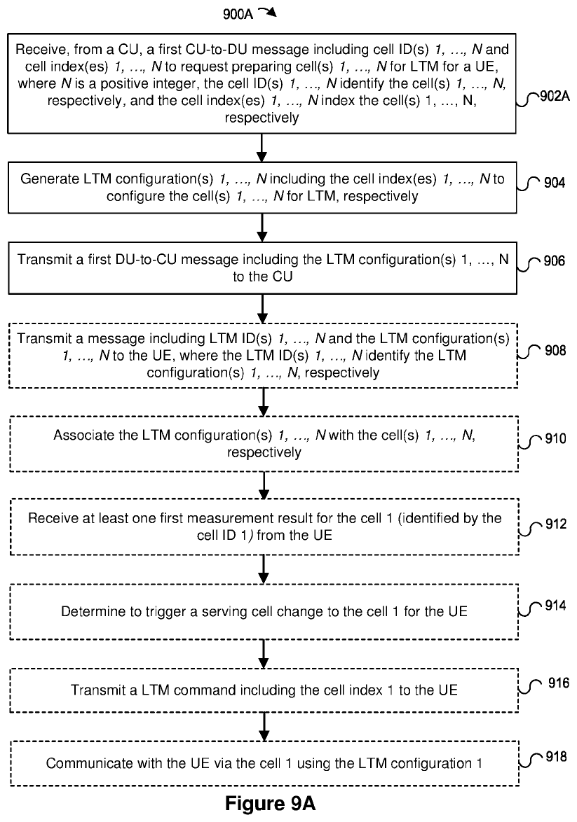

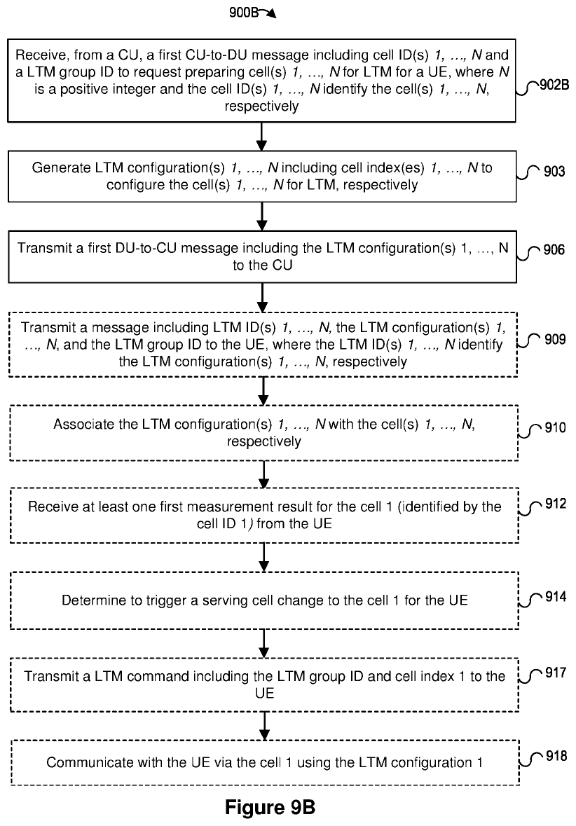

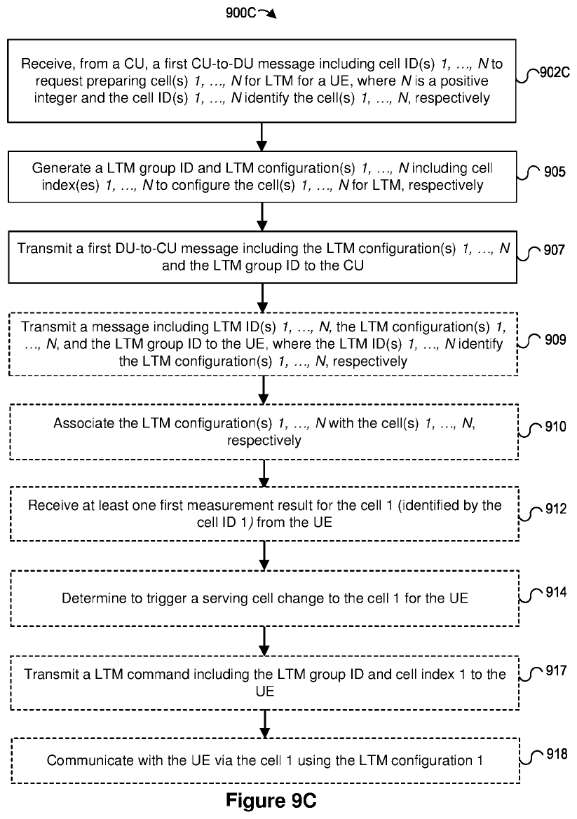

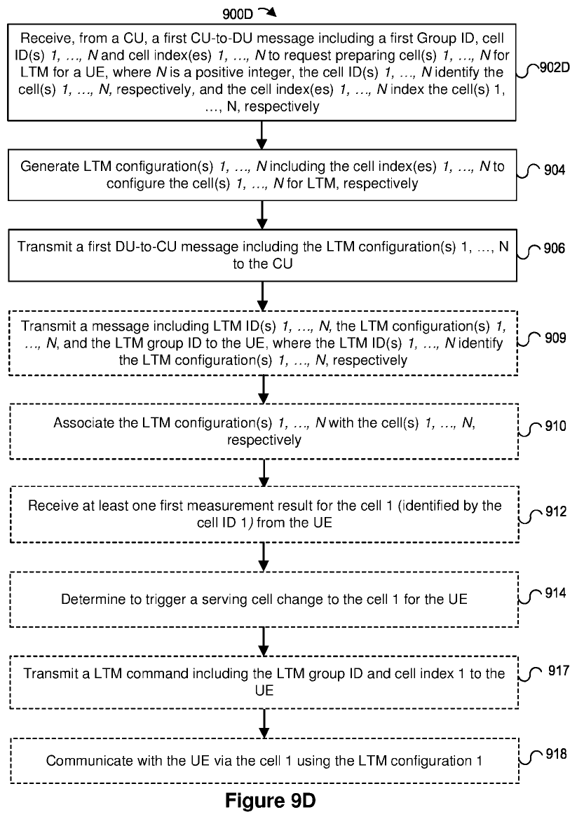

Next, several example methods, that can be implemented in a RAN node such as a DU or a CU to support configuring a configuration for LTM, are discussed next with reference to FIGS. 9A-11B. Examples and implementations described for FIGS. 3-8B can apply to FIGS. 9A-11B.

FIG. 9A illustrates an example method 900A, which can be implemented by a DU (e.g., the DU 174 of the base station 104 or 106), for configuring and triggering LTM for a UE (e.g., the UE 102).

The method 900A begins at block 902A, where the DU receives, from a CU, a first CU-to-DU message including cell ID(s) 1, . . . , N and cell index(es) 1, . . . , N to request preparing cell(s) 1, . . . , N for LTM for a UE, where N is a positive integer, the cell ID(s) 1, . . . , N identify the cell(s) 1, . . . , N, respectively, and the cell index(es) 1, . . . , N index the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 904, the DU generates LTM configuration(s) 1, . . . , N including the cell index(es) 1, . . . , N to configure the cell(s) 1, . . . , N for LTM, respectively (e.g., events 310, 390, 380, 490, 480, 580, 590, 581, 582, 680, 690, 681, 682, 780, 790, 781, 782, 880, 890, 881, 882). At block 906, the DU transmits a first DU-to-CU message including the LTM configuration(s) 1, . . . , N to the CU (e.g., events 310, 390, 380, 490, 480, 580, 590, 581, 582, 680, 690, 681, 682, 780, 790, 781, 782, 880, 890, 881, 882). At block 908, the DU transmits a message including LTM ID(s) 1, . . . , N and the LTM configuration(s) 1, . . . , N to the UE, where the LTM ID(s) 1, . . . , N identify the LTM configuration(s) 1, . . . , N, respectively (e.g., events 318, 394, 380, 480, 494, 580, 594, 581, 517, 519, 582, 680, 694, 681, 617, 619, 682, 780, 794, 781, 717, 719, 782, 880, 894, 881, 817, 819, 882). At block 910, the DU associates the LTM configuration(s) 1, . . . , N with the cell(s) 1, . . . , N, respectively. The DU can perform the association upon generating the LTM configuration(s). In some implementations, the DU associates the LTM configuration(s) 1, . . . , N with the cell index(es) 1, . . . N and/or the cell ID(s 1, . . . , N, respectively.

At block 912, the DU receives at least one first measurement result for the cell 1 (identified by the cell ID 1) from the first UE (e.g., events 324, 380, 424, 480, 580, 524, 581, 582, 680, 624, 681, 682, 780, 724, 781, 782, 880, 824, 881, 882). At block 914, the DU determines to trigger a serving cell change to the cell 1 for the UE. In some implementations, the DU makes the determination based on the at least one first measurement result. At block 916, the DU transmits a LTM command including the cell index 1 to the first UE (e.g., events 330, 380, 480, 430, 580, 530, 581, 582, 680, 630, 681, 682, 780, 730, 781, 782, 880, 830, 881, 882). In some implementations, the DU transmits the LTM command to the UE on a serving cell, in response to the determination of block 914. At block 918, the DU communicates with the UE via the cell 1 using the LTM configuration 1 (e.g., events 336, 380, 480, 436, 580, 536, 581, 582, 680, 636, 681, 682, 780, 736, 781, 782, 880, 836, 881, 882).

When the UE receives the LTM command, the UE determines or identifies the LTM configuration 1 and cell ID 1, based on the cell index 1. In some implementations, the UE determines or identifies the LTM configuration 1 based on the cell index 1 and identifies the cell ID 1 in the LTM configuration 1. The UE accesses the cell 1 identified by the cell ID 1 (e.g., events 332, 380, 432, 480, 580, 532, 581, 582, 680, 632, 681, 682, 780, 732, 781, 782, 880, 832, 881, 882). The UE communicates with the DU via the cell 1 using the LTM configuration 1 as described for block 918 (e.g., events 336, 380, 480, 436, 580, 536, 581, 582, 680, 636, 681, 682, 780, 736, 781, 782, 880, 836, 881, 882).

In some implementations, the maximum number of cells for LTM that the CU or a RAN operating the CU can configure to the UE is 7, 8, 15, 16, 31, 32, 63 or 64. For example, the number N can be less than 8, 9, 16, 17, 32, 33, 64 or 65 cells.

In some implementations, the DU is a serving DU for the UE. For example, the DU is the DU 174 in FIGS. 3, 5A and 5B, the S-DU 174A in FIGS. 4, 6A and 6B, or the S-DU 174B in FIGS. 7A, 7B, 8A and 8B. The serving DU can perform blocks 902A-918. In other implementations, the DU is a non-serving DU. For example, the DU is the T-DU 174B in FIGS. 4, 6A and 6B and T-DU 174C in FIGS. 8A and 8B. The non-serving DU can perform blocks 902A-906, 910 and/or 918. In such cases, a serving DU for the UE can execute blocks 908, 912, 914 and 916. The serving DU can receive the cell index(es) 1, . . . , N and/or the LTM configuration(s) 1, . . . , N from the CU, so that the serving DU can transmit the LTM command to the UE.

In some implementations, the cell(s) 1, . . . , N are candidate PCell(s). In other implementations, the cell(s) 1, . . . , N are candidate PSCell(s). In some implementations, the DU can include, in the first DU-to-CU message, the cell ID(s) 1, . . . , N associated with the LTM configuration(s) 1, . . . , N, respectively. In some implementations, the DU communicates with the UE via a serving cell and the DU receives the at least one first measurement result from the UE via the serving cell. In some implementations, the DU can include the LTM configuration(s) 1, . . . , P and does not include the LTM configuration(s) P+1, . . . , N in the DU-to-CU message, where 0<P<N. The DU can include, in the DU-to-CU message, the cell ID(s) 1, . . . , P associated with the LTM configuration(s) 1, . . . , P, respectively. In such cases, the DU rejects to prepare the cell(s) P+1, . . . , N for LTM.

In some implementations, the DU transmits a first measurement configuration to the UE via the CU to configure at least one first reference signal for measurement. For example, the DU transmits a CU-to-DU message including the first measurement configuration to the CU, which in turn transmits a message (e.g., RRC reconfiguration message) including the first measurement configuration to the UE. In one implementation, the first measurement configuration or the at least one first reference signal is specific for LTM. In another implementation, the first measurement configuration is a CSI measurement configuration (e.g., CSI-MeasConfig) for CSI measurement. The first measurement configuration can include or configure a first resource configuration configuring the at least one first reference signal for measurement. The first measurement configuration can include or configure a first reporting configuration configuring a reporting periodicity, an offset and/or a reporting resource (e.g., PUCCH resource) for transmitting measurement result(s) that the UE obtain from measurements on the at least one first reference signal. The UE transmits the at least one first measurement result based on the first reporting configuration. For example, the UE transmits each of the at least one first measurement result on the reporting resource in different periods based on the periodicity and/or offset.

In some implementations, the DU transmits a first measurement activation command to the UE to order the UE to start performing measurements on the at least one first reference signal. The UE starts performing at least one measurement on the at least one first reference signal upon receiving the first measurement activation command and in accordance with the first measurement configuration. The DU can start transmitting the at least one first reference signal on the cell 1 upon or before transmitting the first measurement activation command. Based on the measurement(s), the UE can obtain the at least one first measurement result. In one implementation, the UE transmits the at least one first measurement result in accordance with the first reporting configuration. In other implementations, the UE starts performing at least one measurement on the at least one first reference signal upon receiving the first measurement configuration. In such cases, the DU may not transmit a measurement activation command to order the UE to perform measurement(s) on the at least one first reference signal. Based on the measurement(s), the UE can obtain the at least one first measurement result.

In some implementations, the at least one first measurement result does not include the cell ID 1. In such cases, the DU determines or identifies the at least one first measurement result for the cell 1 or the cell ID 1, based on the first resource configuration and/or the first reporting configuration. Based on the determination or identification, the DU can determine the cell ID 1. In other implementations, the at least one first measurement result includes the cell ID 1 or the cell index 1.

In some implementations, the at least one first measurement result includes at least one of CSI, RSRP value(s), RSRQ value(s), SINR value(s) and/or an event ID. The RSRP, RSRQ and/or SINR value(s) can be L1-RSRP, L1-RSRQ, and/or L1-SINR value(s), respectively. In one implementation, the event ID indicates that the UE detects an event that signal strength and/or quality of the cell 1 is above a threshold. The threshold can be predetermined by the first DU. In another implementation, the event ID indicates that the UE detects an event that signal strength and/or quality of the cell 1 is above a first threshold and signal strength and/or quality of the serving cell is below a second threshold. The first and second thresholds predetermined by the DU. In yet another implementation, the event ID indicates that the UE detects an event that signal strength and/or quality of the cell 1 is higher than (signal strength and/or quality of the serving cell plus a threshold). The threshold can be predetermined by the DU.

In some implementations, the DU receives at least one second measurement result for the serving cell (identified by a cell ID of the serving cell) from the first UE. In some implementations, the DU transmits a second measurement configuration to the UE via the CU to configure at least one second reference signal for measurement. For example, the DU transmits a CU-to-DU message including the second measurement configuration to the CU, which in turn transmits a message (e.g., RRC reconfiguration message) including the second measurement configuration to the UE. In one implementation, the second measurement configuration or the at least one second reference signal is specific for LTM. In another implementation, the second measurement configuration is a CSI measurement configuration (e.g., CSI-MeasConfig) for CSI measurement. The second measurement configuration can include or configure a second resource configuration configuring the at least one second reference signal for measurement. The second measurement configuration can include or configure a second reporting configuration configuring a reporting periodicity, an offset and/or a reporting resource (e.g., PUCCH resource) for transmitting measurement result(s) that the UE obtain from measurements on the at least one second reference signal. The UE transmits the at least one second measurement result, based on the second reporting configuration. For example, the UE transmits each of the at least one second measurement result on the reporting resource in different periods based on the periodicity and/or offset.

In some implementations, the DU transmits a second measurement activation command to the UE to order the UE to start performing measurements on the at least one second reference signal. Alternatively, the DU orders the UE to start performing measurements on the at least one second reference signal in the first measurement activation command. The UE starts performing at least one measurement on the at least one second reference signal in accordance with the first measurement configuration, upon receiving the first or second measurement activation command. The DU can start transmitting the at least one second reference signal on the cell 1 upon or before transmitting the first or second measurement activation command. Based on the measurement(s), the UE can obtain the at least one second measurement result. In one implementation, the UE transmits the at least one second measurement result in accordance with the second reporting configuration. In other implementations, the UE starts performing at least one measurement on the at least one second reference signal upon receiving the second measurement configuration. In such cases, the DU may not transmit a measurement activation command to order the UE to perform measurement(s) on the second reference signal(s). Based on the measurement(s), the UE can obtain the at least one second measurement result.

In some implementations, the at least one second measurement result does not include the cell ID of the serving cell. In such cases, the DU determines or identifies the at least one second measurement result for the serving cell or the cell ID of the serving cell, based on the second resource configuration and/or the second reporting configuration. In other implementations, the at least one second measurement result includes the cell ID of the serving cell or a cell index of the serving cell.

In some implementations, the at least one second measurement result includes at least one of CSI, RSRP value(s), RSRQ value(s) and/or SINR value(s) for the serving cell. In some implementations, the DU determines to trigger the serving cell change to the cell 1 or transmit the LTM command, based on the at least one first measurement result and/or the at least one second measurement result. For example, if the DU determines that the at least one first measurement result (i.e., value(s)) is above a first threshold and the at least one second measurement result (i.e., value(s)) is below a second threshold, the DU transmits or determines to transmit the LTM command. The first and second thresholds can be predetermined by the DU. Otherwise, if the at least one first measurement result is below the first threshold or the at least one second measurement result is above the second threshold, the DU does not transmit or determines not to transmit the LTM command. In another example, if the DU determines that the at least one first measurement result is higher than (the at least one second measurement result plus a threshold), the DU transmits or determines to transmit the LTM command. The threshold can be predetermined by the DU. Otherwise, if the at least one first measurement result is not higher than (the at least one second measurement result plus the threshold), the DU does not transmit or determines not to transmit the LTM command.

In some implementations, the DU receives at least one third measurement result for the cell 2 (identified by the cell ID 2) from the first UE after block 918. For example, the DU receives the at least one third measurement result from the UE via the cell 1. The DU determines to trigger a serving cell change to the cell 2 for the UE based on the at least one third measurement result. In response to the determination, the DU transmits a LTM command including the cell index 2 to the UE on the cell 1 or another serving cell, similar to block 916 (e.g., events 350, 398 380, 450, 498, 480, 580, 598, 581, 582, 680, 698, 681, 682, 780, 798, 781, 782, 880, 898, 881, 882). When the UE receives the LTM command, the UE determines or identifies the LTM configuration 2 and cell ID 2, based on the cell index 2. In some implementations, the UE determines or identifies the LTM configuration 2 based on the cell index 2 and identifies the cell ID 2 in the LTM configuration 2. The UE accesses the cell 2 identified by the cell ID 2 (e.g., events 352, 398 380, 452, 498, 480, 580, 598, 581, 582, 680, 698, 681, 682, 780, 798, 781, 782, 880, 898, 881, 882). The UE communicates with the DU via the cell 2 using the LTM configuration 2 (e.g., events 356, 380, 480, 456, 580, 556, 581, 582, 680, 656, 681, 682, 780, 756, 781, 782, 880, 856, 881, 882).

In some implementations, the DU transmits a third measurement configuration to the UE via the CU to configure at least one third reference signal for measurement. For example, the DU transmits a CU-to-DU message including the third measurement configuration to the CU, which in turn transmits a message (e.g., RRC reconfiguration message) including the third measurement configuration to the UE. In one implementation, the third measurement configuration or the at least one third reference signal is specific for LTM. In another implementation, the third measurement configuration is a CSI measurement configuration (e.g., CSI-MeasConfig) for CSI measurement. The third measurement configuration can include or configure a third resource configuration configuring the at least one third reference signal for measurement. The third measurement configuration can include or configure a third reporting configuration configuring a reporting periodicity, an offset and/or a reporting resource (e.g., PUCCH resource) for transmitting measurement result(s) that the UE obtain from measurements on the at least one third reference signal. The UE transmits the at least one third measurement result based on the third reporting configuration. For example, the UE transmits each of the at least one third measurement result on the reporting resource in different periods based on the periodicity and/or offset.

In some implementations, the DU transmits a third measurement activation command to the UE to order the UE to start performing measurements on the at least one third reference signal. Alternatively, the DU orders the UE to start performing measurements on the at least one second reference signal in the first or second measurement activation command. The UE starts performing at least one measurement on the at least one third reference signal in accordance with the first measurement configuration, upon receiving the first, second or third measurement activation command. The DU can start transmitting the at least one third reference signal on the cell 2 upon or before transmitting the first, second or third measurement activation command. Based on the measurement(s), the UE can obtain the at least one third measurement result. In one implementation, the UE transmits the at least one third measurement result in accordance with the third reporting configuration. In other implementations, the UE starts performing at least one measurement on the at least one third reference signal upon receiving the third measurement configuration. In such cases, the DU may not transmit a measurement activation command to order the UE to perform measurement(s) on the at least one third reference signal. Based on the measurement(s), the UE can obtain the at least one third measurement result.

In some implementations, the at least one third measurement result does not include the cell ID 1. In such cases, the DU determines or identifies the at least one third measurement result for the cell 2, based on the third resource configuration and/or the third reporting configuration. Based on the determination or identification, the DU can determine the cell ID 2 or the cell index 2. In other implementations, the at least one third measurement result includes the cell ID 2 or the cell index 2.

In some implementations, the at least one third measurement result includes at least one of CSI, RSRP value(s), RSRQ value(s), SINR value(s) and/or an event ID. The RSRP, RSRQ and/or SINR value(s) can be L1-RSRP, L1-RSRQ, and/or L1-SINR value(s), respectively. In one implementation, the event ID indicates that the UE detects an event that signal strength and/or quality of the cell 2 is above a threshold. The threshold can be predetermined by the DU. In another implementation, the event ID indicates that the UE detects an event that signal strength and/or quality of the cell 2 is above a first threshold and signal strength and/or quality of the cell 1 is below a second threshold. The first and second thresholds predetermined by the first DU. In yet another implementation, the event ID indicates that the UE detects an event that signal strength and/or quality of the cell 2 is higher than (signal strength and/or quality of the cell 1 plus a threshold). The threshold can be predetermined by the DU.

In some implementations, the DU receives at least one additional measurement result for the cell 1 from the UE via the cell 1 after block 918, similar to receiving the at least one first measurement result. In some implementations, the DU transmits the LTM command including the cell index 2 to the UE, based on the at least one third measurement result and/or the at least one additional measurement result. For example, if the DU determines that the at least one third measurement result (i.e., value(s)) is above a first threshold and the at least one additional measurement result (i. e . . . , value(s)) is below a second threshold, the DU transmits or determines to transmit the LTM command. The first and second thresholds can be predetermined by the DU. Otherwise, if the at least one third measurement result is below the first threshold or the at least one additional measurement result is above the second threshold, the DU does not transmit or determines not to transmit the LTM command. In another example, if the DU determines that the at least one third measurement result is higher than (the at least one additional measurement result plus a threshold), the DU transmits or determines to transmit the LTM command. The threshold can be predetermined by the DU. Otherwise, if the at least one first measurement result is not higher than (the at least one additional measurement result plus the threshold), the DU does not transmit or determines not to transmit the LTM command.

While the DU performs actions of blocks 902-918 to prepare the cell 1 for a first UE (e.g., the UE described above), the DU can perform actions similar to blocks 902-918 to prepare the cell 1 for a second UE. The DU generates a first LTM configuration 1 and a second LTM configuration 1 for the first UE and the second UE, respectively. Depending on UE capabilities of the first UE and second UE and/or serving DU configurations of the first UE and second UE, the first LTM configuration 1 and the second LTM configuration 1 can be the same or different configurations. In some implementations, the DU sets the cell index 1 for the first LTM configuration 1 and the cell index 1 for the second LTM configuration 1 to the same value. In such cases, the cell index 1 can be cell-specific because the DU uses the same cell index value for LTM configurations configuring the same cell for different UEs, when preparing the cell 1 for LTM for the UEs. In other implementations, the DU sets the cell index 1 for the first LTM configuration 1 and the cell index 1 for the second LTM configuration 1 to different values. In such cases, the cell index 1 is UE-specific because the DU assigns different values to the cell index 1 when preparing the cell 1 for LTM for the first UE and the second UE.

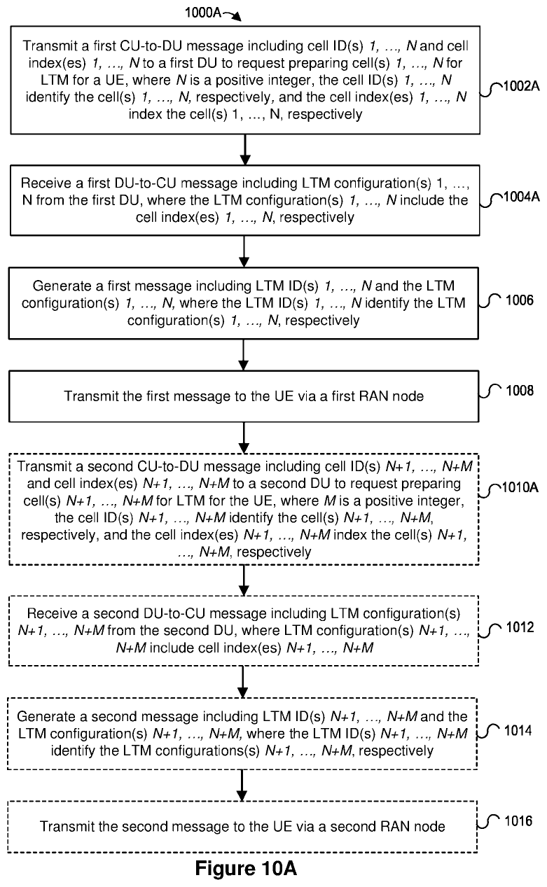

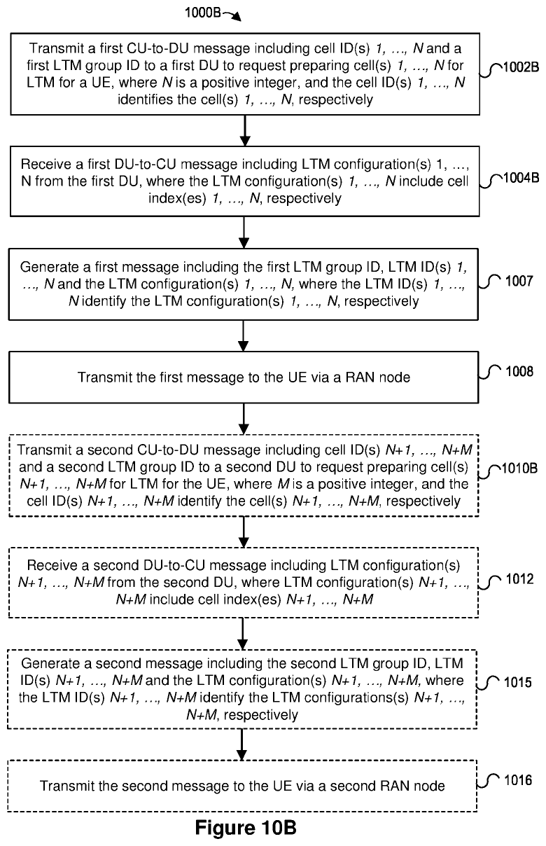

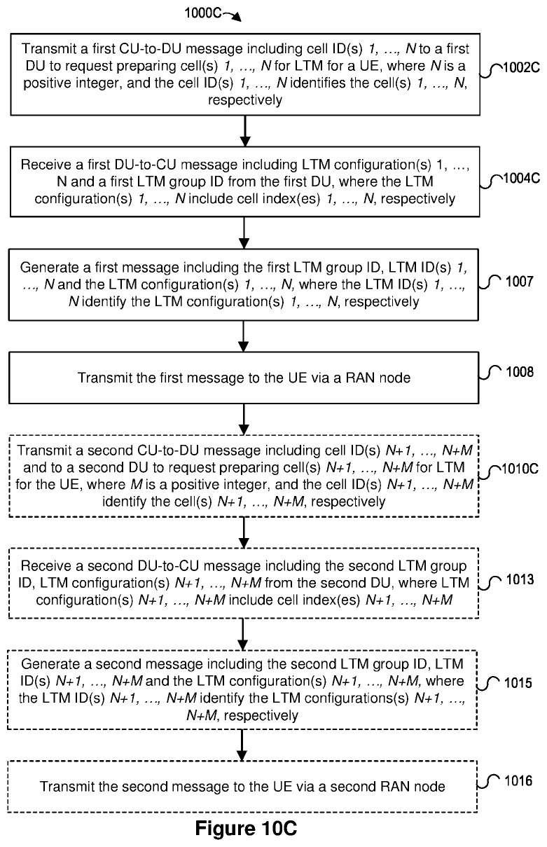

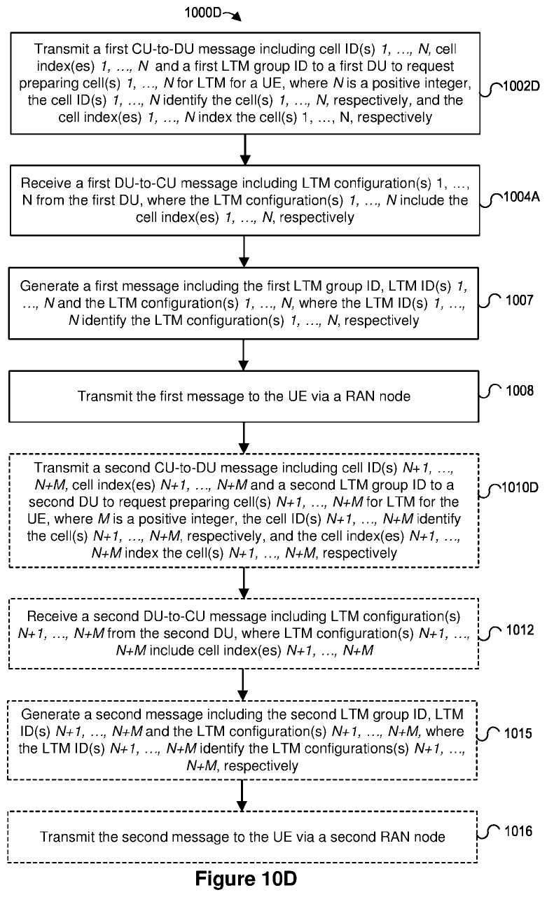

With the method 900A, the CU can coordinate cell index values used by different DUs for LTM for the UE, as described for FIG. 10A. When the UE receives a LTM command including a cell index, the UE only uses the cell index to identify or determine a corresponding LTM configuration, which simplifies the implementations for LTM in the UE.

FIG. 9B is a flow diagram of an example method 900B similar to the method 900A, except that method 900B includes blocks 902B, 903, 909, and 917 instead of blocks 902, 904, 908, and 916. At block 902B, the DU receives, from a CU, a first CU-to-DU message including cell ID(s) 1, . . . , N and a LTM group ID to request preparing cell(s) 1, . . . , N for LTM for the UE, where N is a positive integer and the cell ID(s) 1, . . . , N identify the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 903, the DU generates LTM configuration(s) 1, . . . , N including the cell index(es) 1, . . . , N to configure cell(s) 1, . . . , N for LTM, respectively (e.g., events 310, 390, 380, 490, 480, 580, 590, 581, 582, 680, 690, 681, 682, 780, 790, 781, 782, 880, 890, 881, 882). The cell index(es) 1, . . . , N index the cell(s) 1, . . . , N, respectively.

At block 909, the DU transmits a message including LTM ID(s) 1, . . . , N, the LTM configuration(s) 1, . . . , N, and the LTM group ID to the UE, where the LTM ID(s) 1, . . . , N identify the LTM configuration(s) 1, . . . , N, respectively (e.g., events 318, 394, 380, 480, 494, 580, 594, 581, 517, 519, 582, 680, 694, 681, 617, 619, 682, 780, 794, 781, 717, 719, 782, 880, 894, 881, 817, 819, 882). At block 917, the DU transmits a LTM command including the LTM group ID and cell index 1 to the UE (e.g., events 330, 380, 480, 430, 580, 530, 581, 582, 680, 630, 681, 682, 780, 730, 781, 782, 880, 830, 881, 882). In some implementations, the DU transmits the LTM command to the UE on a serving cell, in response to the determination of block 914.

When the UE receives the LTM command from the DU on a serving cell, the UE determines or identifies the LTM configuration 1 and cell ID 1, based on the LTM group ID and the cell index 1. In some implementations, the UE determines or identifies the LTM configuration 1 based on the LTM group ID and the cell index 1 and identifies the cell ID 1 in the LTM configuration 1. The UE accesses the cell 1 identified by the cell ID 1 (e.g., events 332, 380, 432, 480, 580, 532, 581, 582, 680, 632, 681, 682, 780, 732, 781, 782, 880, 832, 881, 882). The UE communicates with the DU via the cell 1 using the LTM configuration 1 as described for block 918 (e.g., events 336, 380, 480, 436, 580, 536, 581, 582, 680, 636, 681, 682, 780, 736, 781, 782, 880, 836, 881, 882).

In some implementations, the DU is a serving DU for the UE. For example, the DU is the DU 174 in FIGS. 3, 5A and 5B, the S-DU 174A in FIGS. 4, 6A and 6B, or the S-DU 174B in FIGS. 7A, 7B, 8A and 8B. The serving DU can execute blocks 902B-918. In other implementations, the DU is a non-serving DU. For example, the DU is the T-DU 174B in FIGS. 4, 6A and 6B and T-DU 174C in FIGS. 8A and 8B. The non-serving DU can execute blocks 902B-906, 910 and/or 918. In such cases, a serving DU for the UE can execute blocks 909, 912, 914 and 917. The serving DU can receive the LTM group ID, the cell index(es) 1, . . . , N and/or the LTM configuration(s) 1, . . . , N from the CU, so that the serving DU can transmit the LTM command to the UE.

In some implementations, the DU receives the at least one third measurement result for the cell 2 (identified by the cell ID 2) from the first UE after block 918 as described For FIG. 9A. The DU determines to trigger a serving cell change to the cell 2 for the UE based on the at least one third measurement result. In response to the determination, the DU transmit a LTM command including the LTM group ID and the cell index 2 to the UE on the cell 1 or another serving cell, similar to block 917. When the UE receives the LTM command, the UE determines or identifies the LTM configuration 2 and cell ID 2, based on the LTM group ID and the cell index 2. In some implementations, the UE determines or identifies the LTM configuration 2 based on the cell index 2 and identifies the cell ID 2 in the LTM configuration 2. The UE accesses the cell 2 identified by the cell ID 2 (e.g., events 332, 380, 432, 480, 580, 532, 581, 582, 680, 632, 681, 682, 780, 732, 781, 782, 880, 832, 881, 882). The UE communicates with the DU via the cell 2 using the LTM configuration 2 (e.g., events 336, 380, 480, 436, 580, 536, 581, 582, 680, 636, 681, 682, 780, 736, 781, 782, 880, 836, 881, 882).

Unlike the method 900A, the DU (e.g., a first DU) in the method 900B assigns values to the cell index(es) 1, . . . , N instead of the CU. In some implementations, the LTM group ID can be a DU ID or a cell group ID. In some implementations, the CU sets the LTM group ID to a first value. In some scenarios or implementations, an additional DU (e.g., a second DU) can perform actions for the UE with the CU, similar to blocks in the method 900B. In such cases, the CU sets a LTM group ID for the second DU to a second value other than the first value.

With the method 900B, coordination for cell index values used by different DUs for LTM for the UE is avoided, which simplifies the implementations for LTM in the DU.

FIG. 9C is a flow diagram of an example method 900C similar to the methods 900A and 900B, except that method 900C includes blocks 902C, 905, and 907 instead of blocks 902B, 904, and 906. At block 902C, the DU receives, from a CU, a first CU-to-DU message including cell ID(s) 1, . . . , N to request preparing cell(s) 1, . . . , N for LTM for a UE, where N is a positive integer and the cell ID(s) 1, . . . , N identifies the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 905, the DU generates a LTM group ID and LTM configuration(s) 1, . . . , N including cell index(es) 1, . . . , N to configure the cell(s) 1, . . . , N for LTM (e.g., events 310, 390, 380, 490, 480, 580, 590, 581, 582, 680, 690, 681, 682, 780, 790, 781, 782, 880, 890, 881, 882). The cell index(es) 1, . . . , N index the cell(s) 1, . . . , N, respectively. At block 907, the DU transmits, to the CU, a DU-to-CU message, including the LTM configuration(s) 1, . . . , N and the LTM group ID (e.g., events 310, 390, 380, 490, 480, 580, 590, 581, 582, 680, 690, 681, 682, 780, 790, 781, 782, 880, 890, 881, 882).

In some implementations, the DU is a serving DU for the UE. For example, the DU is the DU 174 in FIGS. 3, 5A and 5B, the S-DU 174A in FIGS. 4, 6A and 6B, or the S-DU 174B in FIGS. 7A, 7B, 8A and 8B. The serving DU can execute blocks 902C-918. In other implementations, the DU is a non-serving DU. For example, the DU is the T-DU 174B in FIGS. 4, 6A and 6B and T-DU 174C in FIGS. 8A and 8B. The non-serving DU can execute blocks 902C-907, 910 and/or 918. In such cases, a serving DU for the UE can execute blocks 909, 912, 914 and 917. The serving DU can receive the LTM group ID, the cell index(es) 1, . . . , N and/or the LTM configuration(s) 1, . . . , N from the CU, so that the serving DU can transmit the LTM command to the UE.

Unlike the method 900B where the CU manages (e.g., assigns) a LTM group ID, the DU manages (e.g., assigns) a LTM group ID in the method 900C. In some scenarios or implementations, an additional DU (e.g., a second DU) can perform actions for the UE with the CU, similar to blocks in the method 900C. In such cases, the LTM group ID (i.e., a first LTM group ID) configured by the first DU and the LTM group ID (i.e., a second LTM group ID) configured by the second DU are set to different values. In some implementations, the first DU and the second DU are preconfigured with the first LTM group ID (value) and the second LTM group ID (value). In other implementations, an Operation, Administration and Maintenance (OAM) node transmits a first message to configure the first LTM group ID (value) and transmits a second message to the second DU to configure the LTM group ID (value). In yet another implementation, the CU transmits a CU-to-DU message to the first DU to configure the first LTM group ID value and transmits a CU-to-DU message to the second DU to configure the second LTM group ID value. In yet another implementations, the first DU obtains the first LTM group ID (value) from a mathematic function with at least one first input value, and the second DU obtains the second LTM group ID (value) from the mathematic function with at least one second input value. At least one of the first input value(s) is different from at least one of the second input value(s). For example, the first input value is a gNB-DU ID of the first DU and the second input is a gNB-DU ID of the second DU.

With the method 900C, coordination for cell index values used by different DUs for LTM for the UE is avoided, which simplifies the implementations for LTM in the DU.

FIG. 9D is a flow diagram of an example method 900D similar to the methods 900A, 900B and 900C, except that method 900D includes blocks 902D instead of blocks 902A, 902B and 902C. At block 902D, the DU receives, from a CU, a first CU-to-DU message including a first Group ID, cell ID(s) 1, . . . , N and cell index(es) 1, . . . , N to request preparing cell(s) 1, . . . , N for LTM for a UE, where N is a positive integer, the cell ID(s) 1, . . . , N identify the cell(s) 1, . . . , N, respectively, and the cell index(es) 1, . . . , N index the cell(s) 1, . . . , N, respectively (e.g., events 308, 390, 380, 490, 480, 580, 590, 581, 582, 680, 690, 681, 682, 780, 790, 781, 782, 880, 890, 881, 882).

In some implementations, the DU is a serving DU for the UE. For example, the DU is the DU 174 in FIGS. 3, 5A and 5B, the S-DU 174A in FIGS. 4, 6A and 6B, or the S-DU 174B in FIGS. 7A, 7B, 8A and 8B. The serving DU can execute blocks 902D-918. In other implementations, the DU is a non-serving DU. For example, the DU is the T-DU 174B in FIGS. 4, 6A and 6B and T-DU 174C in FIGS. 8A and 8B. The non-serving DU can execute blocks 902D-906, 910 and/or 918. In such cases, a serving DU for the UE can execute blocks 909, 912, 914 and 917. The serving DU can receive the LTM group ID, the cell index(es) 1, . . . , N and/or the LTM configuration(s) 1, . . . , N from the CU, so that the serving DU can transmit the LTM command to the UE.

With the method 900D, coordination for cell index values used by different DUs for LTM for the UE is avoided, which simplifies the implementations for LTM in the DU.

FIG. 10A illustrates an example method 1000A, which can be implemented by a CU (e.g., the CU 172 of the base station 104 or 106), for configuring LTM for a UE (e.g., the UE 102).

The method 1000A begins at block 1002A, where the CU transmits a first CU-to-DU message including cell ID(s) 1, . . . , N and cell index(es) 1, . . . , N to a first DU to request preparing cell(s) 1, . . . , N for LTM for a UE, where N is a positive integer, the cell ID(s) 1, . . . , N identify the cell(s) 1, . . . , N, respectively, and the cell index(es) 1, . . . , N index the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 1004A, the CU receives a first DU-to-CU message including LTM configuration(s) 1, . . . , N from the first DU, where the LTM configuration(s) 1, . . . , N include the cell index(es) 1, . . . , N, respectively (e.g., events 310, 390, 380, 490, 480, 580, 590, 581, 582, 680, 690, 681, 682, 780, 790, 781, 782, 880, 890, 881, 882). At block 1006, the CU generates a first message including LTM ID(s) 1, . . . , N and the LTM configuration(s) 1, . . . , N, where the LTM ID(s) 1, . . . , N identify the LTM configuration(s) 1, . . . , N, respectively. At block 1008, the CU transmits the first message to the UE via a first RAN node (e.g., events 316, 318, 394, 380, 480, 494, 580, 594, 581, 517, 519, 582, 680, 694, 681, 617, 619, 682, 780, 794, 781, 717, 719, 782, 880, 894, 881, 817, 819, 882).

At block 1010A, the CU transmits a second CU-to-DU message including cell ID(s) N+1, . . . , N+M and cell index(es) N+1, . . . , N+M to a second DU to request preparing cell(s) N+1, . . . , N+M for LTM for the UE, where M is a positive integer, and the cell ID(s) N+1, . . . , N+M identify the cell(s) N+1, . . . , N+M, respectively (e.g., events 308, 390, 380, 490, 480, 580, 590, 581, 582, 680, 690, 681, 682, 780, 790, 781, 782, 880, 890, 881, 882). At block 1012, the CU receives a second DU-to-CU message including LTM configuration(s) N+1, . . . , N+M from the second DU, where LTM configuration(s) N+1, . . . , N+M include cell index(es) N+1, . . . , N+M (e.g., events 310, 390, 380, 490, 480, 580, 590, 581, 582, 680, 690, 681, 682, 780, 790, 781, 782, 880, 890, 881, 882). The cell index(es) N+1, . . . , N+M index the cell(s) 1, . . . , N, respectively. At block 1014, the CU generates a second message including LTM ID(s) N+1, . . . , N+M and the LTM configuration(s) N+1, . . . , N+M, where the LTM ID(s) N+1, . . . , N+M identify the LTM configurations(s) N+1, . . . , N+M, respectively. At block 1016, the CU transmits the second message to the UE via the first DU or a RAN node (e.g., the second DU, the second CU or the base station) (e.g., events 316, 318, 394, 380, 480, 494, 580, 594, 581, 517, 519, 582, 680, 694, 681, 617, 619, 682, 780, 794, 781, 717, 719, 782, 880, 894, 881, 817, 819, 882).

In some implementations, the CU and first DU in FIG. 10A can be the CU, the first DU and the second DU described for FIG. 9A, respectively. Thus, the descriptions for FIG. 9A can apply to FIG. 10A and the descriptions for FIG. 10A can apply to FIG. 9A. In some implementations, the first message and second message are RRC reconfiguration messages. In some implementations, the first RAN node is a serving DU (e.g., the first DU, the second DU or a third DU), another CU or a base station for the UE. In other implementations, the first RAN node is a serving DU (e.g., the first DU, the second DU or the third DU), another CU or a base station for the UE. In some implementations, the first RAN node and the second RAN node are the same RAN node. In other implementations, the first RAN node and the second RAN node are different RAN nodes. In some implementations, the second RAN node is a new serving RAN node for the UE and the first RAN node is an old serving RAN node for the UE.

In some implementations, the maximum number of cells for LTM for the UE is 7, 8, 15, 16, 31, 32, 63 or 64. For example, the number N can be less than 8, 9, 16, 17, 32, 33, 64 or 65 cells. In another example, the number N+M can be less than 8, 9, 16, 17, 32, 33, 64 or 65 cells.

In some implementations, the CU includes the cell ID(s) 1, . . . , N, the cell index(es) 1, . . . , N and/or the LTM configuration(s) 1, . . . , N in the second CU-to-DU message. In other implementations, the CU transmits a third CU-to-DU message including the cell ID(s) 1, . . . , N, the cell index(es) 1, . . . , N and/or the LTM configuration(s) 1, . . . , N to the second DU. Thus, when the second DU is/becomes a serving DU for the UE, the second DU communicates with the UE via a serving cell (e.g., one of the cell(s) N+1, . . . , N+M). The second DU (i.e., the serving DU) can receive at least one measurement result for the serving cell and/or the cell 1 from the UE. Based on the at least one measurement result, the second DU transmits a LTM command including the cell index 1 to the UE to order the UE to perform a serving cell change to the cell 1 from the serving cell, as described for FIG. 9A.

In some implementations, the CU transmits a fourth CU-to-DU message including the cell index(es) N+1, . . . , N+M and/or the LTM configuration(s) N+1, . . . , N+M to the first DU. Thus, when the first DU is/becomes a serving DU for the UE, the first DU communicates with the UE via a serving cell (i.e., one of the cell(s) N+1, . . . , N+M). The first DU (i.e., the serving DU) can receive at least one measurement result for the serving cell and/or cell N+1 from the UE. Based on the at least one measurement result, the first DU transmits a LTM command including the cell index N+1 to the UE to order the UE to perform a serving cell change to the cell N+1 from the serving cell.

In some implementations, the CU sets the cell indexes 1, . . . , N+M to different values. When the UE receives a LTM command including a cell index of the cell indexes 1, . . . , N+M, the UE uniquely determines or identifies a LTM configuration in accordance with the cell index (e.g., the cell index 1), where the LTM configuration (e.g., the LTM configuration 1) includes the cell index (e.g., the cell index 1). In other words, a cell index (value) for a UE is unique among multiple DUs preparing LTM for the UE. When the CU has used a cell index (value) to prepare a cell for LTM for the UE with a DU, the CU refrains from using the cell index (value) to prepare a cell for LTM for the UE with another DU.

FIG. 10B is a flow diagram of an example method 1000B similar to the method 1000A, except that method 1000B includes blocks 1002B, 1004B, 1007, 1010B and 1015 instead of blocks 1002A, 1004A, 1006, 1010A and 1014. At block 1002B, the CU transmits a first CU-to-DU message including cell ID(s) 1, . . . , N and a first LTM group ID to a first DU to request preparing cell(s) 1, . . . , N for LTM, where N is a positive integer, and the cell ID(s) 1, . . . , N identifies the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 1004B, the CU receives a first DU-to-CU message including LTM configuration(s) 1, . . . , N from the first DU, where the LTM configuration(s) 1, . . . , N include cell index(es) 1, . . . , N, respectively (e.g., events 310, 390, 380, 490, 480, 580, 590, 581, 582, 680, 690, 681, 682, 780, 790, 781, 782, 880, 890, 881, 882). The cell index(es) 1, . . . , N index the cell(s) 1, . . . , N, respectively. At block 1007, the CU generates a first message including the first LTM group ID, LTM ID(s) 1, . . . , N and the LTM configuration(s) 1, . . . , N, where the LTM ID(s) 1, . . . , N identify the LTM configuration(s) 1, . . . , N, respectively (e.g., events 308, 390, 380, 490, 480, 580, 590, 581, 582, 680, 690, 681, 682, 780, 790, 781, 782, 880, 890, 881, 882). At block 1010B, the CU transmits a second CU-to-DU message including cell ID(s) N+1, . . . , N+M and a second LTM group ID to a second DU to request preparing cell(s) N+1, . . . , N+M for LTM for the UE, where M is a positive integer, and the cell ID(s) N+1, . . . , N+M identify the cell(s) N+1, . . . , N+M, respectively (e.g., events 308, 390, 380, 490, 480, 580, 590, 581, 582, 680, 690, 681, 682, 780, 790, 781, 782, 880, 890, 881, 882). At block 1015, the CU generates a second message including the second LTM group ID, LTM ID(s) N+1, . . . , N+M and the LTM configuration(s) N+1, . . . , N+M, where the LTM ID(s) N+1, . . . , N+M identify the LTM configurations(s) N+1, . . . , N+M, respectively (e.g., events 316, 318, 394, 380, 480, 494, 580, 594, 581, 517, 519, 582, 680, 694, 681, 617, 619, 682, 780, 794, 781, 717, 719, 782, 880, 894, 881, 817, 819, 882).

In some implementations, the CU, first DU and second DU in FIG. 10B can be the CU, first DU and second DU in FIG. 9B, respectively. Thus, the descriptions for FIG. 9B can apply to FIG. 10B, and the descriptions for FIG. 10B can apply to FIG. 9B.

In some implementations, the first LTM group ID and second LTM group ID can be DU IDs. In other implementations, the first LTM group ID and second LTM group ID can be cell group IDs. In some implementations, the CU sets the first LTM group ID and the second LTM group ID to different values.

FIG. 10C is a flow diagram of an example method 1000C similar to the methods 1000A and 1000B, except that method 1000C includes blocks 1002C, 1004C, 1010C and 1013 instead of blocks 1002B, 1004B, 1010B and 1012. At block 1002C, the CU transmits a first CU-to-DU message including cell ID(s) 1, . . . , N to a first DU to request preparing cell(s) 1, . . . , N for LTM, where N is a positive integer, and the cell ID(s) 1, . . . , N identifies the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 1004C, the CU receives a first DU-to-CU message including LTM configuration(s) 1, . . . , N and a first LTM group ID from the first DU, where the LTM configuration(s) 1, . . . , N include cell index(es) 1, . . . , N, respectively (e.g., events 310, 390, 380, 490, 480, 580, 590, 581, 582, 680, 690, 681, 682, 780, 790, 781, 782, 880, 890, 881, 882). The cell index(es) 1, . . . , N index the cell(s) 1, . . . , N, respectively. At block 1010C, the CU transmits a second CU-to-DU message including cell ID(s) N+1, . . . , N+M and to a second DU to request preparing cell(s) N+1, . . . , N+M for LTM for the UE, where M is a positive integer, and the cell ID(s) N+1, . . . , N+M identify the cell(s) N+1, . . . , N+M, respectively (e.g., events 308, 390, 380, 490, 480, 580, 590, 581, 582, 680, 690, 681, 682, 780, 790, 781, 782, 880, 890, 881, 882). At block 1013, the CU receives a second DU-to-CU message including the second LTM group ID, LTM configuration(s) N+1, . . . , N+M from the second DU, where LTM configuration(s) N+1, . . . , N+M include cell index(es) N+1, . . . , N+M (e.g., events 310, 390, 380, 490, 480, 580, 590, 581, 582, 680, 690, 681, 682, 780, 790, 781, 782, 880, 890, 881, 882). The cell index(es) N+1, . . . , N+M index the cell(s) 1, . . . , N, respectively.

In some implementations, the CU and first DU and second DU in FIG. 10C can be the CU, first DU and second DU in FIG. 9C, respectively. Thus, the descriptions for FIG. 9C can apply to FIG. 10C, and the descriptions for FIG. 10C can apply to FIG. 9C.

FIG. 10D is a flow diagram of an example method 1000D similar to the methods 1000A, 1000B and 1000C, except that method 1000D includes blocks 1002D and 1010D, instead of blocks 1002A, 1002B, 1002C and blocks 1010A, 1010B, 1010C and 1010D. At block 1002D, the CU transmits a first CU-to-DU message including cell ID(s) 1, . . . , N, cell index(es) 1, . . . , N and a first LTM group ID to a first DU to request preparing cell(s) 1, . . . , N for LTM for a UE, where N is a positive integer, and the cell ID(s) 1, . . . , N identifies the cell(s) 1, . . . , N, respectively (e.g., events 308, 390, 380, 490, 480, 580, 590, 581, 582, 680, 690, 681, 682, 780, 790, 781, 782, 880, 890, 881, 882). At block 1010D, the CU transmits a second CU-to-DU message including cell ID(s) N+1, . . . , N+M, cell index(es) N+1, . . . , N+M and a second LTM group ID to a second DU to request preparing cell(s) N+1, . . . , N+M for LTM for the UE, where M is a positive integer, the cell ID(s) N+1, . . . , N+M identify the cell(s) N+1, . . . , N+M, respectively, and the cell index(es) N+1, . . . , N+M index the cell(s) N+1, . . . , N+M, respectively (e.g., events 308, 390, 380, 490, 480, 580, 590, 581, 582, 680, 690, 681, 682, 780, 790, 781, 782, 880, 890, 881, 882).

In some implementations, the CU, first DU and second DU in FIG. 10D can be the CU, first DU and second DU in FIGS. 9A, 9B and 9D, respectively. Thus, the descriptions for FIGS. 9A, 9B and 9D can apply to FIG. 10D, and the descriptions for FIG. 10D can apply to FIGS. 9A, 9B and 9D.

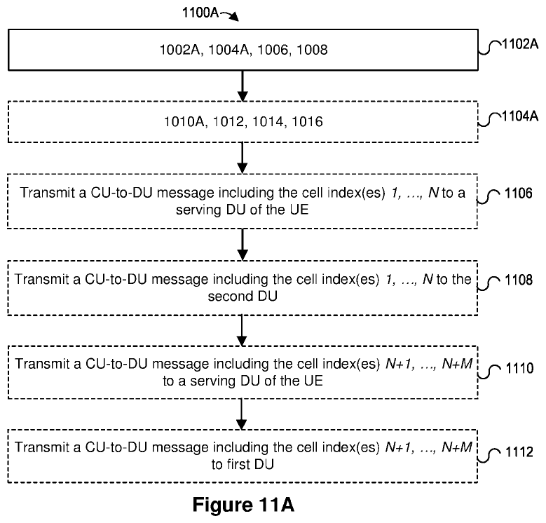

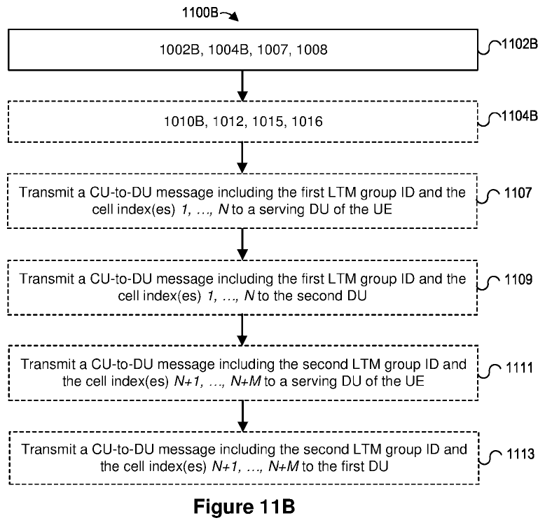

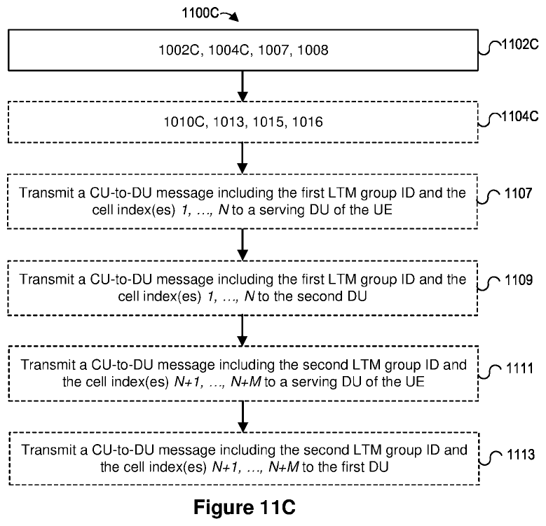

FIG. 11A illustrates an example method 1100A, which can be implemented by a CU (e.g., the CU 172 of the base station 104 or 106), for configuring LTM for a UE (e.g., the UE 102).

The method 1100A begins at block 1102A, where the CU performs blocks 1002A, 1004A, 1006 and 1008 in FIG. 10A. At block 1104A, the CU performs blocks 1010A, 1012, 1014 and 1016 in FIG. 10A. At block 1106, the CU transmits a CU-to-DU message including the cell index(es) 1, . . . , N to a serving DU of the UE (e.g., events 412, 493, 480, 680, 693, 880, 893). At block 1108, the CU transmits a CU-to-DU message including the cell index(es) 1, . . . , N to the second DU (e.g., events 412, 493, 480, 680, 693, 880, 893). At block 1110, the CU transmits a CU-to-DU message including the cell index(es) N+1, . . . , N+M to a serving DU of the UE (e.g., events 412, 493, 480, 680, 693, 880, 893). The serving DU in block 1110 can be the same as or different from the serving DU in block 1106. At block 1112, the CU transmits a CU-to-DU message including the cell index(es) N+1, . . . , N+M to first DU (e.g., events 412, 493, 480, 680, 693, 880, 893).

With the method 1100A, a CU can transmit, to one or more DUs, one or more cell indexes for one or more other DUs for a UE. When one of the DU(s) is or becomes a serving DU, the serving DU can transmit a LTM command including one of the cell index(es) to the UE to order the UE to perform a serving cell change to a cell identified by the cell index included in the LTM command.

The descriptions for FIG. 10A can apply to FIG. 11A. If the first DU is the serving DU of block 1106, block 1106 can be omitted. If the serving DU of block 1106 is the second DU, block 1108 is omitted. In such cases, the CU-to-DU message of block 1106 can be the second CU-to-DU message in block 1010A or different from the second CU-to-DU message in block 1010A. If the serving DU of block 1110 is the first DU, block 1112 can be omitted. In such cases, the CU-to-DU message of block 1110 can be the first CU-to-DU message in block 1010A or different from the first CU-to-DU message in block 1010A. If the serving DU of block 1110 is the second DU, block 1110 can be omitted.

In some implementations, the “cell index(es)” in the blocks can be replaced by “LTM ID(s)”.

FIG. 11B is a flow diagram of an example method 1100B similar to the method 1100A. The method 1100B begins at block 1102B, where the CU performs blocks 1002B, 1004B, 1007 and 1008 in FIG. 10B. At block 1104B, the CU performs blocks 1010B, 1012, 1015 and 1016 in FIG. 10B. At block 1107, the CU transmits a CU-to-DU message including the first LTM group ID and the cell index(es) 1, . . . , N to a serving DU of the UE (e.g., events 412, 493, 480, 680, 693, 880, 893). At block 1109, the CU transmits a CU-to-DU message including the first LTM group ID and the cell index(es) 1, . . . , N to the second DU (e.g., events 412, 493, 480, 680, 693, 880, 893). At block 1111, the CU transmits a CU-to-DU message including the second LTM group ID and the cell index(es) N+1, . . . , N+M to a serving DU of the UE (e.g., events 412, 493, 480, 680, 693, 880, 893). The serving DU in block 1111 can be the same as or different from the serving DU in block 1106. At block 1113, the CU transmits a CU-to-DU message including to the second LTM group ID and the cell index(es) N+1, . . . , N+M to first DU (e.g., events 412, 493, 480, 693, 893).

With the method 1100B, a CU can transmit, to one or more DUs, one or more LTM group IDs and one or more cell indexes for other of the DU(s) for a UE. Each of the LTM group ID(s) is associated with a particular DU of the other DU(s). When one of the DU(s) is or becomes a serving DU, the serving DU can transmit a LTM command including one of the cell index(es) to the UE to order the UE to perform a serving cell change to a cell identified by the LTM group ID and the cell index included in the LTM command.

The descriptions for FIG. 10B can apply to FIG. 11B. If the first DU is the serving DU of block 1107, block 1107 can be omitted. If the serving DU of block 1107 is the second DU, block 1109 is omitted. In such cases, the CU-to-DU message of block 1107 can be the second CU-to-DU message in block 1010B or different from the second CU-to-DU message in block 1010B. If the serving DU of block 1111 is the first DU, block 1113 can be omitted. In such cases, the CU-to-DU message of block 1111 can be the first CU-to-DU message in block 1010B or different from the first CU-to-DU message in block 1010B. If the serving DU of block 1111 is the second DU, block 1111 can be omitted.

FIG. 11C is a flow diagram of an example method 1100C similar to the method 1100B, except that the method 1100C includes blocks 1102C and 1104C instead of blocks 1102B and block 1104B. At block 1102C, the CU performs blocks 1002C, 1004C, 1007 and 1008 in FIG. 10C. At block 1104C, the CU performs blocks 1010C, 1013, 1015 and 1016 in FIG. 10C. The descriptions for FIG. 10C can apply to FIG. 11C.

FIG. 11D is a flow diagram of an example method 1100D similar to the method 1100B, except that the method 1100D includes blocks 1102D and 1104D instead of blocks 1102B and block 1104B. At block 1102D, the CU performs blocks 1002D, 1004A, 1007 and 1008 in FIG. 10D. At block 1104D, the CU performs blocks 1010D, 1012, 1015 and 1016 in FIG. 10D. The descriptions for FIG. 10D can apply to FIG. 11D.

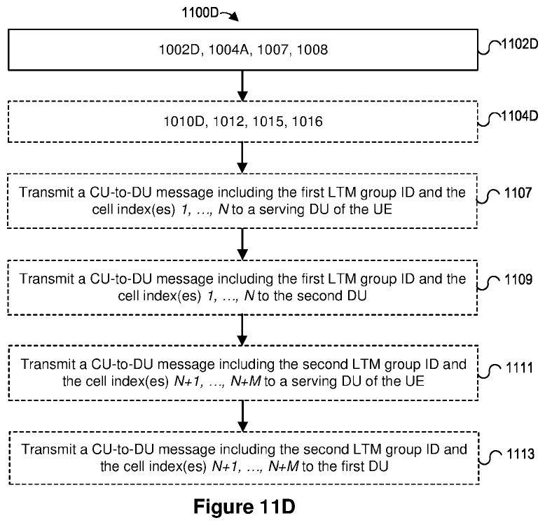

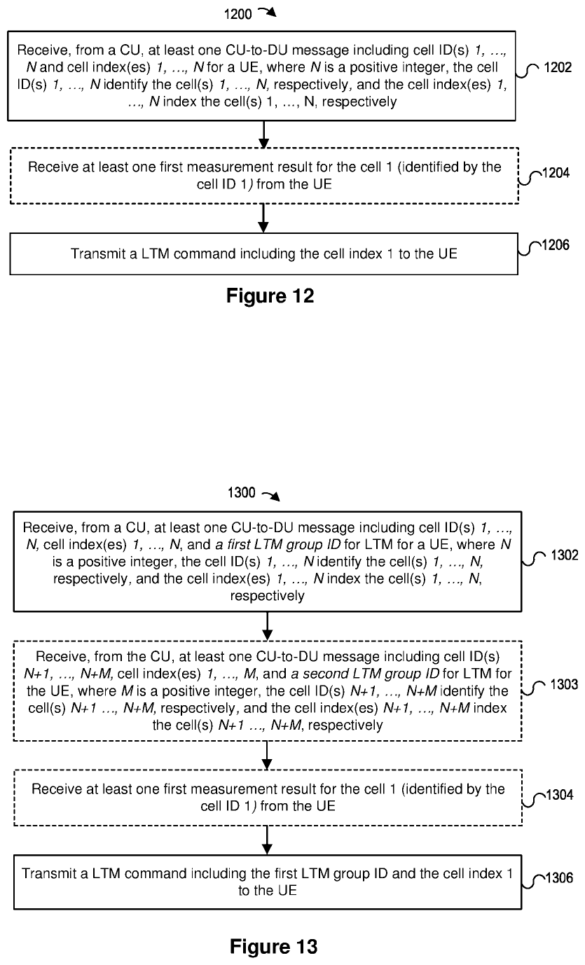

FIG. 12 illustrates an example method 1200, which can be implemented by a DU (e.g., the DU 174 of the base station 104 or 106), for configuring and triggering LTM for a UE (e.g., the UE 102).

The method 1200 begins at block 1202, where the DU receives, from a CU, at least one CU-to-DU message including cell ID(s) 1, . . . , N and cell index(es) 1, . . . , N for a UE, where N is a positive integer, the cell ID(s) 1, . . . , N identify the cell(s) 1, . . . , N, respectively, and the cell index(es) 1, . . . , N index the cell(s) 1, . . . , N, respectively (e.g., events 412, 493, 480, 680, 693, 880, 893). At block 1204, the DU receives at least one first measurement result for the cell 1 (identified by the cell ID 1) from the UE (e.g., events 324, 380, 424, 480, 580, 524, 581, 582, 680, 624, 681, 682, 780, 724, 781, 782, 880, 824, 881, 882). At block 1206, the DU transmits a LTM command including the cell index 1 to the UE (e.g., events 330, 380, 480, 430, 580, 530, 581, 582, 680, 630, 681, 682, 780, 730, 781, 782, 880, 830, 881, 882).

In some implementations, the DU can be the DU described in FIG. 9A. In some implementations, the DU can be the serving DU, first DU or second DU described in FIG. 11A. The descriptions for FIGS. 9A and 11A can apply to FIG. 12. In some implementations, the at least one CU-to-DU message includes UE Context Modification Request message(s).

In some implementations, the DU transmit a DU-to-CU message in response to teach of the at least one CU-to-DU message. For example, the DU-to-CU message is a UE Context Modification Response message. In some implementations, the at least one CU-to-DU message includes LTM configuration(s) 1, . . . , N configuring the cell(s) 1, . . . , N, respectively.

In some implementations, the at least one CU-to-DU message includes LTM ID(s) 1, . . . , N identifying the LTM configuration(s) 1, . . . , N instead of the LTM cell index(es) 1 , . . . , N indexing the cell ID(s) 1, . . . , N. In such cases, the DU includes the LTM ID 1 in the LTM command instead of the cell index 1.

FIG. 13 illustrates an example method 1300, which can be implemented by a DU (e.g., the DU 174 of the base station 104 or 106), for configuring and triggering LTM for a UE (e.g., the UE 102).

The method 1300 begins at block 1302, where the DU receives, from a CU, at least one CU-to-DU message including a first LTM group ID, cell ID(s) 1, . . . , N and cell index(es) 1, . . . , N for a UE, where N is a positive integer, the cell ID(s) 1, . . . , N identify the cell(s) 1, . . . , N, respectively, and the cell index(es) 1, . . . , N index the cell(s) 1, . . . , N, respectively (e.g., events 412, 493, 480, 680, 693, 880, 893). At block 1303, the DU receives, from a CU, at least one CU-to-DU message including cell ID(s) N+1, . . . , N+M, cell index(es) 1, . . . , M, and a second LTM group ID for LTM for the UE, where M is a positive integer, the cell ID(s) N+1, . . . , N+M identify the cell(s) N+1 . . . , N+M, respectively, and the cell index(es) N+1, . . . , N+M index the cell(s) N+1 . . . , N+M, respectively

At block 1304, the DU receives at least one first measurement result for the cell 1 (identified by the cell ID 1) from the UE (e.g., events 324, 380, 424, 480, 580, 524, 581, 582, 680, 624, 681, 682, 780, 724, 781, 782, 880, 824, 881, 882). At block 1306, the DU transmits a LTM command including the first LTM group ID and the cell index 1 to the UE (e.g., events 330, 380, 480, 430, 580, 530, 581, 582, 680, 630, 681, 682, 780, 730, 781, 782, 880, 830, 881, 882).

In some implementations, the DU can be the DU described in FIGS. 9B-9D. In some implementations, the DU can be the serving DU, first DU or second DU described in FIGS. 11B-11D. The descriptions for FIGS. 9B-9D and 11B-11D can apply to FIG. 13.

In some implementations, the at least one first CU-to-DU message includes LTM ID(s) 1, . . . , N identifying the LTM configuration(s) 1, . . . , N instead of the LTM cell index(es) 1, . . . , N indexing the cell ID(s) 1, . . . , N. In such cases, the DU includes the LTM ID 1 in the LTM command instead of the cell index 1. In some implementations, the at least one second CU-to-DU message includes LTM ID(s) N+1, . . . , N+M identifying the LTM configuration(s) N+1, . . . , N+M instead of the LTM cell index(es) N+1, . . . , N+M indexing the cell ID(s) 1, . . . , N.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, the “LTM command” can be replaced by “serving cell change command”, “Layer 1/Layer 2 switching command”, “lower layer switching command” or “lower layer serving cell change command”. In some implementations, “some” means “one or more”. In some implementations, “at least one” means “one or more”. In some implementations, the “DU configuration” can be replaced by “cell group configuration”. In some implementations, the “cell index” can be replaced with “candidate cell index”, “serving cell index”, “LTM cell index”, “special cell (SpCell) index”, “PCell index” or “PSCell index”. In some implementations, the “cell ID” can be replaced with a name such as “candidate cell ID”, “serving cell ID”, “SpCell ID”, “LTM cell ID”, “PCell ID” or “PSCell ID”. In some implementations, the “cell ID” in a CU-to-DU message and the “cell ID” can be replaced with different names listed above.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The term “or” as used herein is to be interpreted as an inclusive or meaning any one or any combination, unless expressly indicated otherwise, mutually exclusive, or indicated otherwise by context. Therefore, herein, the expression “A or B” means “A, B, or both A and B.”

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method implemented in a central unit (CU) of a distributed base station, the method comprising:
transmitting, to a distributed unit (DU) of the distributed base station, a CU-to-DU message related to a lower layer triggered mobility (LTM) of a user equipment (UE) connected to the distributed base station, the CU-to-DU message including (i) a cell identifier (ID) of a candidate cell, and (ii) an LTM ID identifying the LTM configuration;
receiving, from the DU in response to the CU-to-DU message, a DU-to-CU message including (i) the LTM configuration for the candidate cell and (ii) the cell ID; and
transmitting, to the UE via the DU, the LTM configuration and an LTM ID.

2. The method of claim 1, wherein the candidate cell is associated with the DU.

3. The method of claim 2, wherein:
the CU-to-DU message includes a UE Context Modification Request message; and
the DU-to-CU message includes a UE Context Modification Response message.

4. The method of claim 1, wherein:
the DU is a first DU, and
the candidate cell is associated with a second DU of the distributed base station.

5. The method of claim 4, wherein:
the CU-to-DU message includes a UE Context Setup Request message; and
the DU-to-CU message includes a UE Context Setup Response message.

6. The method of claim 1, wherein the CU-to-DU message further includes:
a serving cell index.

7. The method of claim 1, further comprising:
transmitting, to the UE via the DU, an LTM ID.

8. The method of claim 7, wherein:
the LTM configuration and the LTM ID are included in a radio resource control (RRC) reconfiguration message.

9. The method of claim 1, further comprising:
receiving, from the DU in response to the CU-to-DU message, reference LTM configuration.

10. The method of claim 1, wherein:
the reference LTM configuration includes a CellGroupConfig information element (IE).

11. A method implemented in a distributed unit (DU) of a distributed base station, the method comprising:
receiving, from a central unit (CU) of the distributed base station, a CU-to-DU message related to a lower layer triggered mobility (LTM) of a user equipment (UE) connected to the distributed base station, the CU-to-DU message including (i) a cell identifier (ID) of a candidate cell associated with the DU and (ii) an LTM ID identifying the LTM configuration;
transmitting, from the DU in response to the CU-to-DU message, a DU-to-CU message including (i) the LTM configuration for the candidate cell and (ii) the cell ID;
receiving, from the CU, the LTM configuration for the UE; and
transmitting the LTM configuration to the UE.

12. The method of claim 11, wherein:
the CU-to-DU message includes a UE Context Modification Request message; and
the DU-to-CU message includes a UE Context Modification Response message.

13. The method of claim 11, wherein:
the CU-to-DU message includes a UE Context Setup Request message; and
the DU-to-CU message includes a UE Context Setup Response message.

14. The method of claim 11, wherein the DU-to-CU message includes the reference LTM configuration including a CellGroupConfig information element (IE).

15. A central unit (CU) of a distributed base station, the CN comprising processing hardware and configured to:
transmit, to a distributed unit (DU) of the distributed base station, a CU-to-DU message related to a lower layer triggered mobility (LTM) of a user equipment (UE) connected to the distributed base station, the CU-to-DU message including (i) a cell identifier ID of a candidate cell, and (ii) an LTM ID identifying the LTM configuration;
receive, from the DU in response to the CU-to-DU message, a DU-to-CU message including (i) the LTM configuration for the candidate cell and (ii) the cell ID; and
transmit, to the UE via the DU, the LTM configuration and an LTM ID.

16. The CU of claim 15, wherein:
the CU-to-DU message includes a UE Context Modification Request message; and
the DU-to-CU message includes a UE Context Modification Response message.

17. The CU of claim 15, wherein:
the DU is a first DU, and
the candidate cell is associated with a second DU of the distributed base station.

18. The CU of claim 17, wherein:
the CU-to-DU message includes a UE Context Setup Request message; and
the DU-to-CU message includes a UE Context Setup Response message.

19. The CU of claim 15, further configured to:
transmit, to the UE via the DU, an LTM ID.

20. The CU of claim 19, wherein:
the LTM configuration and the LTM ID are included in a radio resource control (RRC) reconfiguration message.
